(19) United States
(12) Patent Application Publication
(10) Pub. No.: US 2025/0191799 A1
(43) Pub. Date: Jun. 12, 2025

(54) NUCLEAR WASTE MANAGEMENT SYSTEM

(71) Applicant: Henry Crichlow, Norman, OK (US)

(72) Inventor: Henry Crichlow, Norman, OK (US)

(21) Appl. No.: 18/805,491

(22) Filed: Aug. 14, 2024

Related U.S. Application Data
(63) Continuation-in-part of application No. 18/108,001, filed on Feb. 9, 2023.
(63) Continuation-in-part of application No. 18/235,277, filed on Aug. 17, 2023.
(63) Continuation-in-part of application No. 18/753,639, filed on Jun. 25, 2024.

(51) Int. Cl. G21F 9/30; B22D 19/00; G21F 5/008

(52) U.S. Cl. CPC G21F 9/302; B22D 19/00; G21F 5/008

(57) ABSTRACT

Nuclear waste, such as, but not limited to, spent nuclear fuel (SNF) assemblies (or portions thereof), are placed within diecast molds, and then gravity fed molding occurs within those loaded diecast molds and around and in the emplaced SNF assemblies (or portions thereof) that are located within those diecast molds, using molten alloy(s) for filling the diecast molds, to form solid metal castings upon sufficient cooling after the gravity fed operations. The molten alloy(s) may contain a copper alloy. The molten alloy(s) may also contain neutron absorbers. After the casting is formed, the casting is not separated from its diecast mold, as the diecasting mold and it's casting now form an integral unit. The integral units may be converted into waste capsules. The waste capsules may be landed in deeply located horizontal wellbores. The deeply located horizontal wellbores may be at least partially located within deeply located geologic formations.

### PRIORITY NOTICE

The present patent application, as a continuation-in-part (CIP) patent application, claims priority under 35 U.S.C. § 120 to earlier filed and copending U.S. nonprovisional patent application Ser. No. 18/753,639 filed on Jun. 25, 2024, by the same inventor as the present patent application; wherein the disclosure of U.S. nonprovisional patent application Ser. No. 18/753,639 is incorporated herein by reference in its entirety.

The present patent application, as a continuation-in-part (CIP) patent application, claims priority under 35 U.S.C. § 120 to earlier filed and copending U.S. nonprovisional patent application Ser. No. 18/235,277 filed on Aug. 17, 2023, by the same inventor as the present patent application; wherein the disclosure of U.S. nonprovisional patent application Ser. No. 18/235,277 is incorporated herein by reference in its entirety.

The present patent application, as a continuation-in-part (CIP) patent application, claims priority under 35 U.S.C. § 120 to earlier filed and copending U.S. nonprovisional patent application Ser. No. 18/108,001 filed on Feb. 9, 2023, by the same inventor as the present patent application; wherein the disclosure of U.S. nonprovisional patent application Ser. No. 18/108,001 is incorporated herein by reference in its entirety.

### CROSS REFERENCE TO RELATED U.S. PATENTS

The disclosures and teachings of U.S. Pat. Nos. 5,851,214, 6,238,138, 10427191, 10518302, 10807132, and 11289234, all by the same inventor as the present patent application, are all incorporated by reference as if fully set forth herein.

### TECHNICAL FIELD OF THE INVENTION

The present invention relates in general to containment, preparation, storage, and/or disposal of radioactive materials, such as, but not limited to, nuclear waste; and, more specifically, to the containment, preparation, storage, and/or disposal of modified spent nuclear fuel (SNF) assemblies, portions thereof, and/or other radioactive waste forms, into generally cylindrical solid metal disposal castings and/or capsules, wherein such generally cylindrical solid metal disposal castings and/or capsules may then be emplaced within deeply located geological formations of predetermined characteristics (such as, but not limited to predetermined rock properties) in which geological repositories may be implemented as human-made deep horizontal (lateral) wellbores in the deeply located geological formations.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

Today (circa 2024), there is a massive quantity of nuclear waste accumulating across the world, including across the United States (U.S.). There are two significant sources of a majority of nuclear waste. The first source is high-level waste (HLW) from generating electric power in nuclear-fired power plants and a second is from military nuclear operations. All sources of radioactive (nuclear) waste must be addressed, controlled, and disposed of safely. This patent application addresses at least one of these sources of waste and how to dispose of that nuclear (radioactive) waste safely which includes disposing in a timely manner. This patent application is directed to the disposal of at least spent nuclear fuel (SNF) materials such that the SNF may be disposed of safely, securely, economically, and timely. SNF may be a subcategory of HLW.

The novel approach illustrated in this patent application involves the integration of two distinctly different technologies. First, high-level nuclear waste (HLW) management of SNF assemblies; and second, gravity die-casting technology and operations. These two approaches are combined to provide novel means and methods of forming and protecting HLW (SNF) capsules for ultimate disposal in deep geological repositories.

Gravity die casting may entail pouring under gravity molten metal(s) (and/or alloy(s)) into a specially shaped three-dimensional (3D) mold, cast, and/or die. The selected poured/injected metal may be heated separately until it melts.

The viscosity of molten copper decreases (becomes more liquid like) with increasing temperature, reflecting its fluidity at higher temperatures. At its melting point of 1,083 degrees Celsius (° C.), copper has a viscosity of approximately 4.4 centipoises (cP). As the temperature rises to 1,200° C., the viscosity drops to about 3.7 cP, and further decreases to around 2.9 cP at 1,400° C. This reduction in viscosity with temperature is typical for molten metals, facilitating processes such as casting and alloying by enhancing the flow characteristics of the liquid metal.

The molten liquid may then be rapidly poured into a mold, cast, and/or die cavity; and, then the melted metal takes the mold's shape once it has sufficiently cooled down to resolidify.

A gravity die-casting process may comprise at least some steps, such as, but not limited to, mold (die) preparation, pouring the melt and, finally, cleanup of the cast item. The gravity die casting process may allow for high automation, mass-production, relatively low-costs, high-quality resolidified metallic components with high precision and high repeatability. These features may provide benefits in the disposal of HLW (SNF) products (materials).

Embodiments of the present invention may be based, at least in part, on the realization that considerable advantages can be gained if a copper (or similar alloy) is used for embedding and enclosing the spent nuclear fuel (SNF) rods to form a composite mass ingot (casting) in which the SNF and the alloy form a solid matrix.

One advantage is that resistance to chemical corrosion is vastly increased by the fact that the coherent mass of copper (or the like alloy) infused ingot (casting), formed from the copper (or the like alloy) infused SNF combination, is more resistant to corrosion than a hollow copper container in which the SNF assemblies are placed and enclosed. This is due, on the one hand, to copper (or the like alloy) in itself being more resistant to corrosion and, on the other hand, to the protection afforded by having a coherent mass of an essentially single material that is impenetrable and impermeable to fluids.

Another advantage is that the interior of this solid matrix of copper and SNF can be made substantially (mostly) free from cavities (voids), which is hardly possibly if merely using a hollow container in which SNF assemblies are placed within, and subsequently welding a lid onto that container.

A further advantage is that the solid composite matrix of copper and SNF effectively becomes a dense monolithic system, a single entity without any joint, or any transition area of a different material composition existing between them. Therefore, there are no weak points in the composite matrix system. In this application, the intra-SNF embedding of the copper alloy is done with a gravity-fed injection process rather than a very complex, costly, high temperature, high pressure, long duration hot isostatic pressing (HIP) process.

This gravity-fed process as taught herein, has hitherto fore not been disclosed for the encapsulation of SNF assembly devices under these conditions.

To date, no efforts have been made to modify or transform the physical SNF assembly before disposal in the manners taught herein. Current processes use the physical SNF assembly, unchanged, in the same form as it exits its cooling pond. Most efforts have been made to cloak, cover, enclose, or protect the SNF externally. Whereas, the technology provided herein in this current patent application is a substantial departure from the current and prior art and is directed towards an effective means of protection, minimizing corrosion, and minimizing radionuclide migration when the SNF assembly (or other HLW) is disposed of (in a deep geological repository) as taught herein.

Current and prior art disposal of SNF as HLW in vertical wellbores involves the placement of the nuclear waste (e.g., SNF) within capsules (containers), wherein the capsules containing the nuclear waste (SNF) are then usually placed in a bottom one-third section of a vertical wellbore. Published data show that compressive and tensile stresses acting on these vertically-disposed capsules can exceed 5,000 psi (pounds per square inch) or more depending on the depth and quantity of capsules strung together, which could contribute to failure and/or breach of such prior art capsule systems and in turn could result in unintended radionuclide migration.

Then, in the current and prior art SNF disposal systems, wellbore sealing plugs have been placed above the emplaced capsules. Above these sealing plugs are various backfill materials that are designed to swell and fill the remaining portions of the vertical wellbore. However, in practice, some structural/physical changes may occur in and at the near wellbore region between the drilled-out wellbore and the native rock formation due to the drilling process. Fissures, microfractures, and permeability changes may occur at the interface between the wellbore and into the proximate (adjacent) surrounding native rock, sometimes called “near-wellbore damage” in the oil drilling industry. Furthermore, based on observations of the erosion of bentonite mud accretions that accumulate on the surfaces of drilling mud pits in the open, possible erosion of the bentonite backfill due to fluid migration may occur. Published bentonite backfill testing analyses have overlooked this potential for physical erosion due to migrating fluids underground. These changes contribute to and may allow fluid bypass, migration, and movement of waste material, such as, but not limited to, radionuclides, over time out of the emplaced capsules and into the surrounding native rock-which is not a desired outcome.

Nuclear waste disposal in horizontal wellbores has been illustrated in some previous U.S. utility patents such as, U.S. Pat. Nos. 5,851,214, 6,238,138, 10,427,191, 10,518,302, 10,807,132, and 11,289,234, all by the same inventor as the present (current) patent application. The disclosures and teachings of U.S. Pat. Nos. 5,851,214, 6,238,138, 10,427,191, 10,518,302, 10,807,132, and 11,289,234, are all incorporated by reference as if fully set forth herein. This patent application may place encapsulated nuclear (radioactive) waste materials (in a casting or the like form that may then be put into a capsule form) into lateral or horizontal wellbores drilled into deep geological formations.

Current and prior art spent nuclear fuel (SNF) assemblies are generally shown in FIG. 1A, in FIG. 1B, and in FIG. 1C. FIG. 1A is prior art and shows a Canadian model CANDU for a nuclear fuel assembly 101. FIG. 1B is prior art and shows a Russian nuclear fuel assembly 103. FIG. 1C is prior art and shows a group or bundle of U.S. nuclear fuel assemblies 105, with a plurality of single SNF assembly 106 being part of that bundle 105.

In prior art technology and operations, prior approaches to treating SNF assemblies are taught, at least some of which are depicted in FIG. 2A, in FIG. 2B, in FIG. 2C, and in FIG. 2D.

FIG. 2A is prior art and shows a SKB spent fuel (SNF) canister 201 and cradle 203 assembly used in Finland and in Sweden. The prior art SNF waste disposal approach taught in Finland (and Sweden) utilizes a set of SNF assemblies 205 that are emplaced in a structural cast iron honeycomb cradle 203 (scaffold 203) supporting structure. The cradle 203 with its held set of SNF assemblies 205 is capped with a cover (lid) 207. Then this composite structure (e.g., the cradle 203 with its held set of SNF assemblies 205 and the cover 207) are enclosed in a very thick-walled and corrosion-resistant heavy copper cylindrical canister 201. Canister 201 is then closed with a final cover (lid) 209. Then the massive copper cylindrical canister 201 along with its contents (of the cradle 203 that is holding the SNF assemblies 205), is then disposed of in vertical shafts implemented by drilling a “shallow” borehole in a floor of a tunnel or mine repository. Note, this type of prior art disposal system may have a serious problem and/or defect in that this type of prior art disposal system may be affected by the migration of surface waters, resulting in radioactive contaminated surface waters, as has been demonstrated by the detection of surface-generated chlorine-36 at sub-surface locations indicating the surface waters have reached the disposal depth. Eventually, over thousands of years the iron and copper protection may deteriorate and allow radionuclide migration away from the location. See e.g., FIG. 2A.

FIG. 2B is prior art and shows a Canadian spent fuel (SNF) canister 211 assembly for disposal in near-surface repositories. This prior art approach for SNF disposal, published in Canada, bundles the individual SNF assemblies 101 into a generally cylindrical bundle of SNF assemblies 101, wherein that bundle then gets emplaced inside a structural metal cylindrical canister 213 and then this structural metal cylindrical canister 213 (with the bundle of SNF assemblies 101) gets enclosed completely inside a large protective (massive) copper canister 211 with end caps (plugs) 215 which are friction welded to the original copper cylinder canister 211 member. This Canadian prior art solution has similar problems as indicated above in the discussion of FIG. 2A, namely, over extended time periods, having copper degradation from migrating (surface) waters and radionuclide migration. See e.g., FIG. 2B.

FIG. 2C is prior art and shows U.S. (proposed/planned) operations where spent fuel (SNF) assemblies 106 disposal is made in shallow mines or tunnel systems for in near-surface repositories like Yucca Mt in Nevada. This prior art approach, published in the U.S., emplaces groups of SNF assemblies 106 as integral waste packages on a rail-type system inside a near-surface (e.g., 300 meters [m] below terrestrial surface) tunnel 221 that is unrealistically and dangerously placed above the local water table. The tunnel 221 is surrounded along its length by a tunnel wall 223. The nuclear waste capsule packages are then expected to be protected by a set of titanium drip shields 225 which are supposed to be installed sometime in the future, after complete waste emplacement. It is hoped that these titanium “umbrellas” 225 can unrealistically protect the emplaced waste 106 from vertically migrating groundwater for 10,000 years. See e.g., FIG. 2C.

Today (2024) and in the recent past, the treatment and processing of SNF assemblies have been reported by at least three major groups or organizations, as indicated earlier (i.e., the Finnish, Canadian, and U.S. prior art methods for dealing with SNF discussed above). See e.g., FIG. 2A to FIG. 2C.

FIG. 2D of this present patent application is a prior art representation (reproduction) of a FIG. 1 from U.S. Pat. No. 4,209,420; further, the reference numerals shown in FIG. 2D (of the present patent application) are the reference numerals from U.S. Pat. No. 4,209,420. FIG. 2D of this present patent application shows a prior art operation where spent fuel (SNF) assemblies are embedded in a solid composite matrix by a process called “hot isostatic pressing” (HIP). The process involves placing the waste material, mixed with glass or ceramic, into a sealed container. This container is then subjected over a prolonged period of time to high temperatures and high pressures in a specialized HIP furnace. This system essentially behaves like a high temperature closed high pressure cooker in common use. The hot isostatic pressing (HIP) process for nuclear waste encapsulation typically requires several hours or more to complete. The exact duration can vary depending on the specific materials and waste form being processed, but it generally ranges from two (2) to twenty-four (24) hours per cycle. This time frame includes the heating period to reach the desired temperature, the holding period at high temperature and pressure to ensure complete densification, and the cooling period. The precise parameters must be carefully controlled. The combination of heat and isostatic pressure causes the material to densify, eliminating voids and creating a solid, monolithic structure. This dense form minimizes the potential for radioactive leakage and enhances the long-term stability and safety of the waste form, making it suitable for secure, deep geological disposal.

Despite some possible or theoretical benefits, the HIP process faces several operational and other challenges that hinder its successful implementation. At least some of the key problems are: an excessively complex process; high financial costs to implement; difficult to scale-up; waste material compatibility issues; problems with monitoring and controlling the HIP process; regulatory and/or licensing issues; problems with public acceptance; problems with waste form stability and/or performance; a portion thereof; combinations thereof; and/or the like. With respect to the HIP process being excessively complex and having too high of financial costs, the HIP process requires unique and specialized equipment capable of withstanding the required extremely high pressures and high temperatures. Such equipment is financially expensive to purchase, commission, operate, and maintain. Further the complexity of the HIP process increases such financial costs, making it less economically viable compared to other waste management methods. Scaling up the HIP process from laboratory or pilot-scale to full industrial scale is beyond challenging. Ensuring uniform extremely high pressure and temperature distribution in large volumes of waste material is difficult, which can lead to inconsistencies in the final product. Handling and processing large quantities of radioactive waste in a HIP system is technically demanding and requires robust safety measures. Further, not all waste materials are suitable for HIP processing. Some waste materials may react adversely under the very high pressure and temperature conditions, leading to undesirable chemical reactions and/or phase changes. The development of suitable encapsulation materials that can effectively immobilize a wide range of radionuclides is still an ongoing challenge. Monitoring and controlling the HIP process is difficult due to its harsh operational environment. Ensuring that the process parameters are consistently maintained within the required very high pressure and temperature ranges is critical to producing a high-quality end product. Real-time monitoring of the encapsulated waste material during the HIP process is challenging, leading to potential uncertainties in the final end product quality. The U.S. legal regulatory framework for the disposal of nuclear waste is stringent, and untested technologies like HIP must undergo rigorous testing and validation to meet such regulatory requirements. Gaining regulatory approval for the HIP process, if possible, will be very time-consuming and very financially expensive, further delaying its implementation. The time and effort required to gain regulatory approval for the HIP process have greatly slowed its implementation. Public perception and acceptance of untested nuclear waste disposal technologies can be a significant barrier to adoption. Concerns about the safety and long-term reliability of the HIP process may lead to resistance from the public and stakeholders alike. Communicating any benefits of the HIP process to the public effectively would be crucial but challenging. Ensuring the long-term stability and performance of the end product waste forms produced by the HIP process is critical. This includes resistance to radiation damage, thermal cycling, and potential leaching of radionuclides.

Comprehensive testing and modeling are required to demonstrate the durability of HIP-processed waste forms over geological timescales, which is a complex and resource-intensive task. Currently, there is uncertainty as to if the HIP process end product waste forms can meet such long-term requirements. The high financial and time costs associated with the HIP process, including scaling it up, its equipment, its operation, and its mandatory regulatory compliance, makes it less competitive compared to other waste management methods. Such issues have limited widespread adoption of the HIP process as applied to SNF. Other waste management and disposal methods, such as, vitrification and dry cask storage, have been more readily adopted due to at least some reliability and to lower costs as compared to the HIP process. In summary, while the HIP process might offer potential advantages for the encapsulation and disposal of spent nuclear fuel assemblies, it faces significant operational, technical, economic, and regulatory challenges. These challenges have prevented its successful and widespread implementation to date.

At least some embodiments of the present invention do not utilize a hot isostatic pressing (HIP) process.

These current FIG. 2A to FIG. 2C prior art approaches for SNF disposal tend to provide protection at what may be considered a “macro-level.” At the “macro level,” the basis for corrosion protection and/or mitigation of degradation of the SNF material is done wholly on the exterior surfaces of the containers (capsules) that house the SNF materials. In macro-level operations, no attempt is made for materials to protectively enter the innermost interstices of the SNF assembly matrix that make up the complex inner structure of a typical SNF assembly. In reality, there is considerable free space, porosity, or voids 301 between and around the collective internal structural elements (such as, fuel rods 303, control rods 305) that make up an SNF assembly, see e.g., FIG. 3A and FIG. 3B. FIG. 3A and FIG. 3B are prior art and show a single SNF assembly 106. These internal intricate void spaces 301, of a typical SNF assembly, may be easily computed empirically by a liquid displacement process on a given finished SNF assembly (or an equivalent method). In prior art disposal systems, the outer corrosion protective material is placed as a solid, a sheet, laminated, or other means outside of and covering over exteriors of the SNF assembly—but protective materials never enter the inner void spaces 301 of the SNF assembly (such as, but not limited to, SNF assembly 106).

Whereas and in complete contrast, the current novel patent application teaches methods, processes, steps, devices, apparatus, devices, and/or the like, in which protective material(s), such as, but not limited to, copper and/or copper alloy(s), may be meltingly added, under gravity, in liquid (molten) form, into a mold (cast and/or die) in which at least one complete (or partial) SNF assembly resides, such that this molten, liquid, and protective material(s) may enter and fill the void spaces 301 within the SNF assembly, and may do so using only gravity with no high pressure forcing injection.

In addition, in some embodiments, a selected (predetermined) neutron absorbent material may be added to the molten (liquid) metal (protective material) and this combined fluid may be inserted/poured, under gravity, into the die (cavity) holding the SNF assembly (or portion thereof) residing within the mold (cast and/or die). In some embodiments, the neutron absorbent materials may comprise boron carbide (B₄C).

Boron carbide (B₄C) contains a high concentration of boron, which has a strong affinity for absorbing thermal neutrons. When boron absorbs neutrons, it undergoes a nuclear reaction that produces alpha particles and lithium-7. This reaction helps reduce the neutron population and control the overall reactivity of the nuclear system. In Russia (2023) and in other countries, boron materials, like boron carbide (B₄C), and boron powder have been infused in plastics and successfully utilized in making neutron-absorbing composites for industrial uses.

Neutron absorbent materials like boron carbide B₄C are available in extremely fine powder form and may be mixed with the molten (liquid) metal (copper). This neutron absorbent has an extremely high melting point of 4,262 degrees Fahrenheit (° F.), which is much higher than the melting point of copper (which may be 1,984 degrees Fahrenheit [° F.] and/or around 2,000° F. depending upon the given copper alloy and operating pressure, plus or minus 100° F.).

Gravity die casting and high-pressure die casting are two prevalent manufacturing methods that involve pouring or injecting molten metal into molds to form parts, respectively. In gravity die casting, the molten metal fills the mold under the influence of gravity, typically using molds made of steel or cast iron. This method produces parts with a good surface finish and solid mechanical properties, suitable for medium-complexity components and medium to low production volumes. The process benefits from lower tooling costs and lower porosity levels due to a slower filling process, though it has longer cycle times because of the natural cooling and re-solidification of the metal.

The typical cycle time for a gravity die casting process can vary depending on the complexity and size of the part being cast, the type of alloy used, and the efficiency of the casting setup. For smaller and less complex parts, the cycle time can be closer to one (1) to two (2) minutes, while larger or more complex parts may require three (3) to five (5) minutes or more. On average, the cycle time for gravity die casting ranges from one (1) to five (5) minutes per casting, but shorter or longer cycle times may be possible. In some embodiments, the gravity die casting cycle time of metal output components may comprise the following steps: (a) mold preparation (cleaning, if necessary); (b) pouring (molten metal is poured into the mold cavity); (c) re-solidification (allowing the metal to cool and re-solidify within the mold); (d) mold opening and casting removal (opening the mold and removing the re-solidified casting); and (e) cooling and trimming (allowing the casting to cool further and trimming off any excess material or sprues).

Note, longer cycle times (e.g., five [5] minutes or more) are generally not a problem with respect to forming composite matrixes of copper and SNF assemblies as taught herein as gravity die casting may be scaled up to meet disposal needs of existing and new SNF.

In contrast, high-pressure die casting involves injecting molten metal into precision molds at high pressures, necessitating the use of durable hardened steel molds that can withstand the high pressures (and the high temperatures), as well as the complex equipment and machinery for generating, controlling, monitoring, and managing those high pressures. This high-pressure process requires more complicated machinery and control processes. This high-pressure technique yields parts (castings) with excellent surface finishes and intricate details, making it ideal for complex parts and high-volume production. High-pressure die casting features shorter cycle times due to rapid cooling and re-solidification, but it incurs higher tooling, machinery, and control costs (both in terms of initial setup and with respect to continuous needs for increased calibration and maintenance) and can result in higher levels of porosity (because of the comparably faster cycle times). Despite these drawbacks, the ability to produce detailed, high-quality parts quickly makes high-pressure die casting a preferred method for automotive engine components, electronics housings, and various consumer goods.

But since the die cast nuclear waste castings may be classified as non-precision castings that do not require stringent physical checks and tolerances due to the nature of field operations with respect to disposal within deep horizontal wellbores, gravity die casting may be desirable over high pressure injection die casting in this patent application for manufacturing the composite spent nuclear fuel (SNF) assembly castings. Gravity die casting is suitable because it generates castings of sufficient external tolerances (for easy disposal in deeply located geologic repositories), with the desired internal monolithic characteristics (e.g., that minimize radionucleotide migration), and can do so at sufficient productions rates, all without the increased costs and increased complexity associated with the more expensive and more complex high pressure die casting methodology.

In this patent application, the term gravity inject, gravity feed, gravity pour, or the like, may be used interchangeably to specify a non-high pressure means of putting (forcing) the alloy melt into the die-mold (cavity). That is, gravity alone (and local atmospheric pressure) may be the only motive forces to force or introduce the alloy melt into the die-mold (cavity).

In this patent application, a gravity fed molten metal (copper) feed process may fill all (or substantially [mostly] all) the void spaces 301 with the gravity-fed molten alloy (with or without neutron absorbent material), which permeates the SNF assembly body completely (including its void spaces 301); and that gravity fed molten metal may then be in full contact with all parts of the SNF assembly including in its void spaces 301. In some embodiments, this process may allow for the neutron absorbing process to be active internally within and throughout the body of the SNF assembly including in its void spaces 301. The introduced melt alloy may also form a circumferential cylindrical enclosure (shroud) outside of and surrounding the SNF assembly. This solid circumferential cylinder (shroud) represents the volume external to the SNF assembly, and it also fills the mold cavity up to and inside the space internal to the mold's inside walls (interior surfaces). The resolidified finished body of copper, i.e., the casting, now resembles an “ingot” with a complete SNF assembly (or divided portions thereof) therein. This gravity die-cast molding process for treating SNF assemblies is a significant departure and improvement from prior art forms and allows for an increased level of extreme long-term casting protection (e.g., over thousands of years), a requisite long-term feature for safe HLW nuclear disposal processes. This gravity feed die casting approach may provide SNF internal neutron absorbing capacity that is completely lacking in the prior art systems. This solid casting approach may be able to withstand significantly higher external pressures as compared to prior art SNF disposal methods. This casting approach is able to withstand significant high external pressures that may occur in some wellbores; whereas, prior art capsule (container) systems may have problems with. Further, with this casting approach, because the internal void spaces 301 of the SNF assembly are now all of solid metal (with or without neutron absorbers), there is no place for water to intrude into the SNF assembly, become contaminated, and then distribute that contamination externally as the contaminated water finds its way out of a SNF assembly; and thus, handling, transportation, and/or general movement of the resulting casting is much safer as compared to SNF assemblies under the prior art methods that are merely residing with capsules (containers).

Some technical problems to be solved by embodiments of the present invention are to overcome the defects of the prior art and to provide a SNF encapsulating process and method using gravity pouring die cast molding with metal alloys. With regard to this method, by gravity pouring die cast molding, the end product (casting [ingot]) is compact interiorly, with minimal, if any, pores formed, and the best quality and performance of the product may be guaranteed throughout the composite SNF assembly unit, which now forms part of a solid heterogeneous body.

The present invention provides a gravity die cast process method for molding using a metal alloy. In the molding process method, a gravity die-casting type machine may be used as the processing device, and accessory systems and devices may be used as the devices for preparing and delivering the melted alloy, which is poured into the mold wherein the SNF assembly (or portion thereof) resides.

In one aspect, the present process provides for modification of the gravity die mold to allow for improvements of the gravity process and to allow for a more efficient nuclear waste management and disposal.

There is a need for different and better methods of SNF encapsulation and disposal as compared to the prior art. See e.g., FIG. 2A to FIG. 2D for prior art approaches.

Based on the prior art's inherent shortcomings, there is a critical need for an effective, mechanically uncomplicated, safe, long-lasting, robust, rapidly implemented, repeatable, reliable, and economical method for disposing of SNF assemblies in castings (with its mold still attached). There is a need for effective casting design and management. The new processes, methods, and/or the like taught herein precludes the need for all the expensive, time-consuming, and dangerous operations currently being used or contemplated to provide operational waste capsules.

An approach is needed that minimizes and/or foregoes the complex, sometimes unrealistic, and sometimes dangerous operational steps of the prior art. To solve the above-described problems, the present invention provides devices, apparatus, systems, methods, and/or the like for providing a novel casting system for encapsulating nuclear waste, such as, but not limited to, HLW and/or SNF assemblies that have been and are continuing to accumulate on the surface.

The novel approaches taught as part of this patent application may provide devices, apparatus, systems, methods, steps, and/or the like wherein the HLW and/or SNF assemblies waste disposal operations may prepare the SNF for a more effective type of encapsulation prior to disposal in the underground disposal repository in deep (geologic/rock) formations.

It is to these ends that the present invention has been developed to dispose of HLW and/or SNF assemblies materials in underground deeply located human-made repository systems that can be effectively sealed off from the ecosphere by geological means and at great depths below the Earth's surface.

There is a need in the art for apparatus, systems, methods, steps, and/or the like that encapsulate SNF assemblies (or portions thereof), with molten (liquid) metal(s) and/or alloy(s) (such as, but not limited to, copper and/or copper alloy(s)), that may also penetrate substantially into all of the void spaces 301 within the SNF assemblies (or portions thereof) resulting in an output of a heterogenous casting comprising both the poured metal(s)/alloy(s) and the SNF materials, and now with no internal void spaces. In some embodiments, the poured molten (liquid) metal(s) and/or alloy(s) may comprise neutron absorbing material(s). It is to these ends that the present invention has been developed.

### BRIEF SUMMARY OF THE INVENTION

To minimize the limitations in the prior art and to minimize other limitations that will be apparent upon reading and understanding the present patent specification, various embodiments of the present invention may describe devices, apparatus, systems, processes, methods, steps, means, and/or the like for mechanical and/or physical modifications of nuclear waste forms, such as, but not limited to, spent nuclear fuel (SNF) assemblies (or portions thereof) for subsequent disposal within deeply located geologic repositories.

At least some embodiments of the present invention may describe devices, apparatus, systems, processes, methods, steps, means, and/or the like for processing and/or (long-term) disposing of nuclear (radioactive) waste. In some embodiments, nuclear waste, such as, but not limited to, spent nuclear fuel (SNF) assemblies or portions thereof (or other HLW), may be placed within diecast molds, and then gravity diecast molding may occur within the diecast molds and around the SNF assemblies or portions thereof (or other HLW) that are emplaced within those diecast molds, with gravity poured molten alloy(s), to form solid metal castings upon sufficient cooling, after the gravity pouring process has stopped. In some embodiments, the diecast mold behaves as a solid fixed and structural envelope to its casting, that may be removable from the diecast apparatus (e.g., from mold supports), but wherein that diecast mold may not be removable from its casting, such that after each gravity pour cycle the given diecast mold along with its internally embedded casting form and function as a single integral encapsulated unit (composite unit). Each such integral encapsulated unit (composite unit) may comprise a die (mold) and its casting (fixedly) retained within that die (mold), wherein that casting may further comprise the SNF assembly or portion thereof that is positionally fixed within that casting by resolidified alloy(s) from the molten gravity fed diecasting process. In some embodiments, the molten alloy(s) may contain a copper alloy. In some embodiments, the molten alloy(s) may also contain neutron absorbers. In some embodiments, the integral encapsulated units (composite units) may be converted into waste capsules. In some embodiments, the integral encapsulated units (composite units) and/or the waste capsules (with the integral encapsulated units [composite units]) may be landed (placed and/or inserted) in deeply located horizontal wellbores. In some embodiments, the deeply located horizontal wellbores may be at least partially located within deeply located geologic formations.

In some embodiments, devices, apparatus, systems, methods, steps, and/or the like may place at least one SNF assembly (or portion thereof) within a mold (cast and/or die); may then seal and/or close that mold (cast and/or die); and then introduce (pour) into that closed and sealed mold (cast and/or die), that is housing the SNF assembly (or portion thereof), molten (liquid) metal(s) and/or alloy(s) (such as, but not limited to, copper and/or copper alloy(s)), that by virtue of the gravity force; and that liquid (fluid) nature of the molten metal(s) and/or alloy(s) may also penetrate substantially into all of the void spaces within the SNF assembly (or portion thereof) resulting in an output of a heterogenous metal solid casting comprising both the gravity poured metal(s)/alloy(s) in a resolidified state and the SNF materials (also in a solid state), and that now has no internal void spaces in the SNF materials (or in the casting). In some embodiments, the introduced molten (liquid) metal(s) and/or alloy(s) may comprise neutron absorbing material(s).

In some embodiments, this gravity die casting (GDC) process (method) may involve (comprise) introducing molten metal alloys into a die cavity under gravity force. In some embodiments, at least some steps involved in this gravity pouring of metal alloys method (process) may be as follows: (1) die (mold) building and/or preparation; (2) die (mold) loading with the SNF; (3) die (mold) closing; (4) shot sleeve filling (maintaining); (5) gravity introduction (pouring); (6) cooling; (7) die (mold) opening; (8) removal of the diecast mold with its internally located and retained casting (ingot) as a single integral encapsulated unit from other diecasting apparatus (such as, but not limited to, mold supports); (9) trimming and finishing of the removed integral encapsulated unit (composite unit); (10) inspection of the removed integral encapsulated unit (composite unit); (11) post-treatment of the removed integral encapsulated unit (composite unit), if any such post-treatment; (12) quality control of the removed integral encapsulated unit (composite unit); portions thereof; combinations thereof; and/or the like.

In some embodiments, the SNF assembly may inserted into the die (mold) before gravity filling with the molten alloy; whereas, in other embodiments, the die (mold) may be at least partially gravity filled with the molten alloy before inserting the SNF assembly into the die (mold) and then the die (mold) may be completely filled with the molten alloy(s) after the SNF has been inserted into the partially filled die (mold).

In some embodiments, with respect to the die (mold) preparation step, the die (mold) may be constructed of steel or similar material of sufficient mechanical properties to provide for the safe disposal of the nuclear waste material in deep wellbores. The (steel) die (mold) which is removable (from the diecasting apparatus [e.g., its supports]), becomes a permanent integral outer container of the composite SNF casting and its copper alloy material and is a major mechanical, structural, and/or load bearing member (feature) of the integral encapsulated unit and/or of the waste capsule (since a given waste capsule may be made from a given integral encapsulated unit [composite unit]). For clarity the integral encapsulated unit may be the die (mold) with its casting retained and located within that die (mold). The casting may be the SNF assembly entirely covered by the re-solidified alloy(s). The waste capsule may be made from the integral encapsulated unit.

In some embodiments, with respect to the die (mold) loading step, at least one SNF assembly (or portion thereof) may be loaded into the die (mold) cavity before the die (mold) is closed (sealed).

In some embodiments, with respect to the shot sleeve filling (maintaining) step, the shot sleeve, which acts as a reservoir for the molten metal(s) and/or alloy(s), may be at least partially (sufficiently) filled with the desired and/or predetermined molten (liquid) metal(s) and/or alloy(s) such that at least one complete casting (ingot) may be carried out. In some embodiments, the metal(s) and/or alloy(s) may typically be melted in a furnace before being transferred to the shot sleeve. In some embodiments, use of a shot sleeve may be optional, skipped, and/or omitted.

In some embodiments, with respect to the gravity introduction step (gravity pouring step), the shot sleeve may be manipulated to pour the molten metal(s) and/or alloy(s) into the die cavity through a sprue and runner (or the like) system. The gravitational force (local atmospheric pressure), high temperature, and molten (liquid/fluid) nature ensures rapid and complete filling of the cavity as well as into the void spaces within the SNF that is located within that cavity (mold [die]).

In some embodiments, with respect to the cooling step, after the gravity pouring, the formerly molten metal(s) and/or alloy(s) of the casting (ingot) start to resolidify as it cools below its melting point.

In some embodiments, once the metal(s) and/or alloy(s) of the casting (ingot) have sufficiently resolidified (and/or attained a required [predetermined] strength and/or rigidity [e.g., to be self-supporting]), the die (mold) and its internally located and retained solidified contents (i.e., the casting [ingot]) which all together form the integral encapsulated unit are removed from the other diecasting apparatus (e.g., the apparatus that had formerly held the die [mold] during the molten alloy filling).

In some embodiments, with respect to the removal step, the newly formed (and sufficiently cooled) integral encapsulated unit may be removed from the gravity fed system, from the other diecasting apparatus (e.g., the apparatus that hold the die [mold] during the molten alloy filling).

In some embodiments, with respect to the inspection step, the integral encapsulated unit may be inspected for any defects, dimensional accuracy, and/or adherence to (predetermined) quality standards.

In some embodiments, with respect to the post-treatment step, additional treatments may be (optionally) performed as needed and/or as desired, such as, but not limited to, heat treatment, surface finishing (e.g., shot blasting, polishing, coating), and machining, to achieve the desired properties and final product specifications. For example, and without limiting the scope of the present invention, a finished integral encapsulated unit should have an exterior surface that is generally smooth and free of exterior surface defects that may increase friction and/or be more likely to get caught as the integral encapsulated unit is placed within a waste capsule and/or as the integral encapsulated unit moves within a given wellbore.

In some embodiments, with respect to the quality control step, the finished integral encapsulated unit may undergo a rigorous quality control inspection to ensure it meets any required standards for handling on the (terrestrial) surface before being inserted into a given wellbore.

It's worth noting that the specific steps and/or details of the herein taught gravity pouring of metal alloys method for use in disposing of radioactive waste, may vary depending on the: complexity of the SNF assembly (or portion thereof); complexity of the intended outputted integral encapsulated unit; the chosen and/or selected metal(s) and/or alloy(s) for gravity pouring; the chosen and/or selected neutron absorbing material(s) to be mixed into the molten metal(s) and/or alloy(s) and/or used within the die (mold), if any; the gravity die-cast equipment used; portions thereof; combinations thereof; and/or the like.

In some embodiments, a method for encapsulating SNF assemblies (or portions thereof) may comprise one or more of the following steps: (1) mounting a removable steel die (mold) onto its mounting/supports, loading at least one SNF assembly (or portion thereof) into the mounted die (mold); (2) melting metal(s) and/or alloy(s) with a heating furnace (and/or other sufficiently hot heating means) and putting the molten (liquid) metal(s) and/or alloy(s) in a (heated) holding reservoir (e.g., shot sleeve) (wherein the metal(s) and/or alloy(s) may be copper and/or a copper alloy); (3) adding (and mixing) a neutron-absorbing material (such as, but not limited to, boron carbide [B₄C]) as needed and/or as desired to the molten (liquid) metal(s) and/or alloy(s) (e.g., within the holding reservoir); (4) introducing (pouring), under gravity, the melted molten metal(s) and/or alloy(s) (and neutron-absorbing material, if any) into the die (mold) of the die-casting machine, that also has the at least one SNF assembly (or portion thereof) located entirely within the die (mold); (5) gravity fed molding using the closed die (mold) to form a casting (ingot) which may encase the at least one SNF assembly (or portion thereof), wherein that casting (ingot) may also itself be encased within the removable die (mold), such that the output is an integral encapsulated unit that both looks and behaves like a solid cylindrical composite unit. So, the integral encapsulated unit may comprise the removable die (mold), the at least one SNF assembly (or portion thereof) that is positionally fixed within that die (mold), as well as, the re-solidified alloy(s) materials. After the integral encapsulated unit has sufficiently cooled, that integral encapsulated unit is removed from the die cast apparatus (e.g., supports) for intended disposal within a deeply located geologic waste repository.

In some embodiments, in the step (2), the step (4), and/or in the step (5) in the immediately preceding paragraph, the gravity die-casting apparatus may be a suitably configured die-casting machine with a die-casting temperature of at least 2,100 degrees Fahrenheit (° F.) to 2,282° F. Copper alloys may be formulated to have lower melting points compared to pure copper. By alloying copper with other metals and/or elements, the melting point of the resulting copper alloy may be significantly reduced for use in this process.

By implementing the above technical solution, the following beneficial practical effects may be accomplished. First, with regard to the gravity pouring process method for molding of a given SNF assembly (or portion thereof) of the present invention, the molded outputted product, i.e., the casting (or ingot) may be uniformly compact interiorly, with the best interior structure, and desired mechanical properties of the molded (modified) SNF product may be guaranteed. Second, with regard to the gravity pouring process method for molding of a given SNF assembly (or portion thereof) of the present invention, the molded outputted product, i.e., the casting (ingot) may be substantially (mostly) free of internal void spaces within the SNF assembly (or portion thereof) and as such the casting (or ingot) may be configured to withstand (i.e., without significant collapsing, deforming, and/or imploding) high exterior pressures and/or loads being placed upon the casting (ingot), such as, those that may be found within some wellbores. Third, with regard to the gravity fed pouring process method for molding of a given SNF assembly (or portion thereof) of the present invention, the molded outputted product, i.e., the casting (ingot) may be configured for significant neutron absorbing characteristics due to the presence of neutron absorbing material(s) being located within the former void spaces of the SNF assembly (or portions thereof), as well as, the presence of neutron absorbing material(s) being located around the exterior of the SNF assembly (or portions thereof) that is located within that casting (ingot). Fourth, with regard to the gravity pouring process for molding (die casting) of a given SNF assembly (or portion thereof) of the present invention, compared with the traditional (prior art) encapsulation methods, the new outputted castings (ingots) may be in a state or substantially close to being in a state to function and/or operate as an end-product that is configured to be inserted into a wellbore system for final disposal (e.g., because the casting may be retained within its strong outer steel die [mold]).

Fifth, with regard to the gravity fed pouring mold process method for die-cast molding of molten alloys of the present invention, the gravity die-cast outputted end product, i.e., the integral encapsulated unit may compromise: the external steel container that was the die (mold) itself and its inner contents of the at least one SNF assembly (or portion thereof), along with the resolidified alloy(s) materials.

Sixth, with regard to the gravity fed pouring mold process method for die-cast molding of molten alloys of the present invention, the gravity die-cast outputted end product, i.e., the integral encapsulated unit, may be easily and/or readily handled, moved around, and/or transported; and easily and/or readily sequestered into available capsule transport and container systems without much reimagining and repurposing of current equipment.

At least some embodiments of the present invention may describe devices, apparatus, systems, methods, processes, steps, and/or the like for the modification and management of HLW nuclear waste, such as but not limited to SNF assemblies, which may then be sequestered (inserted) into deeply located geological repositories for final disposal (below water tables and entirely isolated from the ecosphere).

Additionally, at least some embodiments of the present invention may focus on satisfying a need to prepare the SNF assemblies (or portions thereof) for deep geological disposal in a manner that is safe, relatively cost-effective, timely (quick), and that allows for maximal disposal of radioactive waste materials.

At least some embodiments of the present invention may focus on mechanically and/or chemically modifying the SNF assemblies (or portions thereof) (e.g., via the aforementioned gravity fed die casting process); and then implementing the modified waste form (i.e., the integral encapsulated unit) as the waste disposal capsule (e.g., by adding couplings to the terminal ends of the integral encapsulated unit). This modified waste form may be mechanically derived from existing SNF assemblies (or portions thereof) by utilizing gravity fed molten metal(s) and/or alloy(s) into and around a given SNF assembly (or portion thereof), that is disposed inside pre-designed removable molds (that stay in place around their castings), which allow for creating a fully formed solid SNF “casting” that is devoid of void spaces, and wherein the casting remains within its steel die (mold) to become the integral encapsulated unit, and it's the integral encapsulated unit that is waste disposal form.

At least some embodiments of the present invention differ from the prior art SNF management methods by one or more of the following: (1) a mechanical solidification operation on intact SNF assemblies (or a portion of a given SNF assembly); (2) producing waste castings (ingots) and integral encapsulated units that are (substantially [mostly]) free of void spaces; (3) producing waste castings (ingots) and/or the integral encapsulated units that are configured to withstand significant (high) external pressures and/or loads because the waste castings (ingots) and/or integral encapsulated units are (substantially [mostly]) free of void spaces; (4) producing waste castings (ingots) and/or integral encapsulated units with significant neutron absorbing capabilities due at least in part to the waste castings (ingots) comprising neutron absorbing material(s) located within the former void spaces of the SNF assemblies (or portions thereof); (5) a molding process wherein in this process, the (SNF) waste is shaped and sized into (cylindrical) (structural) member that may be specifically configured to fit within existing (certified) waste capsules or wherein the integral encapsulated units may act a waste capsule itself; (6) a molding process that is gravity fed as opposed to being high pressure injected; (7) a die cast process wherein the diecast mold (along with its solidified contents) is removable and may become a structural element containing the solidified alloy and SNF composite system therein, i.e., the integral encapsulated unit; and (8) encapsulation and disposal of integral encapsulated units, which may then be emplaced within the deeply located horizontal (lateral) wellbores that may themselves located within deeply located geologic formations.

In some embodiments, it may be a requirement of at least one embodiment of the present invention that the disclosed and taught devices, apparatus, systems, methods, steps, and/or the like are capable of protecting the environment (ecosphere) from the deleterious effects of high nuclear waste disposal and waste migration away from the final disposal location.

It is an objective of the present invention to provide rapid processing and disposing of large volumes (e.g., on the order of thousands of metric tons) of waste (such as, but not limited to, HLW, SNF, portions thereof, combinations thereof, and/or the like) in relatively short periods of time as compared against prior art systems.

It is another objective of the present invention to provide processing and disposing of large volumes of waste (such as, but not limited to, HLW, SNF, portions thereof, combinations thereof, and/or the like) in a manner that is safe, timely, effective, cost effective, robust, repeatable, scalable, reliable, portions thereof, combinations thereof, and/or the like as compared against prior art systems.

It is another objective of the present invention to provide processing and disposing of large volumes of waste (such as, but not limited to, HLW, SNF, portions thereof, combinations thereof, and/or the like) in a manner that may be scalable to thousands of cycles per die (mold) and/or gravity die casting machine (press).

It is another objective of the present invention to modify SNF assemblies (or portions thereof) by introducing gravity fed molten (liquid) metal(s) and/or alloy(s) into the void spaces of the SNF assemblies (or portions thereof) and around the exteriors of the SNF assemblies (or portions thereof) to form waste castings (or waste ingots).

It is another objective of the present invention to generate waste castings (or waste ingots) that are (substantially [mostly]) free of internal void spaces within the SNF assemblies (or portions thereof) that are within the waste castings (or waste ingots).

It is another objective of the present invention to generate waste castings (or waste ingots) that are configured to have significant neutron absorbing capabilities by at least having neutron absorbing material(s) placed within the former void spaces of the SNF assemblies (or portions thereof) that are within the waste castings (or waste ingots).

It is another objective of the present invention to generate waste castings (or waste ingots) that are configured to withstand high (significant) external pressures, stresses, and/or loads by filling the former void spaces of the SNF assemblies (or portions thereof) that are within the waste castings (or waste ingots) with the resolidified metal(s) and/or alloy(s) from the high temperature molten (liquid) gravity fed die casting process.

It is another objective of the present invention to generate composite waste castings (or waste ingots), i.e., the integral encapsulated units, from a gravity fed die cast process in which the die (mold) is removable (along with its solidified contents) and replaceable and becomes the integral encapsulated unit of the solidified alloy and the SNF composite material contained therein.

It is another objective of the present invention to provide processing and disposal of waste, such as SNF assemblies, using multiple gravity die-casting injection processing systems in parallel, and/or in an assembly line fashion.

It is another objective of the present invention to dispose of waste (such as, but not limited to, HLW, SNF, castings (ingots), portions thereof, combinations thereof, and/or the like) within deeply located horizontal wellbores (note such a horizontal wellbore may be referred to as a SuperLAT™); wherein at least a portion of the given horizontal wellbore may be located within a given deeply located geologic formation.

It is another objective of the present invention to dispose of waste, in different or multiple waste forms, within deeply located horizontal wellbores.

It is another objective of the present invention to provide novel means of modifying SNF assemblies to allow for disposal efficiently, timely, economically, and safely for final placement into cylindrical wellbore repositories.

It is another objective of the present invention to provide novel means of modifying SNF assemblies to minimize the effects of corrosion of the SNF material while in the disposal repository by completely protecting the parts of the SNF assembly both internally and externally by the corrosion-protective solidified alloy (metal).

It is another objective of the present invention to provide prepared waste material to be easily disposed of using the geometry of (existing) cylindrical wellbores without unnecessary experimentation and modifications.

It is another objective of the present invention to significantly reduce costs of SNF assembly disposal by modifying available economic means of processing the waste into novel forms for disposal that may be at least partially to mostly automated.

It is another objective of the present invention to provide underground waste storage in deep-closed geological systems, zones, and/or formations (rocks).

It is another objective of the present invention to implement deep geological disposal devices, apparatus, systems, methods, steps, and/or the like for the long-term disposal of HLW/LLW and/or derivatives, such as, but not limited to, spent nuclear fuel (SNF) assemblies and/or castings (ingots) into waste capsules and for disposal of solid wastes such as transuranic products or transuranic waste which is now disposed of in shallow near surface salt mines.

It is another objective of the present invention to allow the processing and disposal of large volumes (e.g., on the order of thousands of metric tons) of multiple waste forms waste (e.g., HLW in horizontal wellbores or SuperLAT™ systems) for disposal underground.

It is another objective of the present invention to provide a casting (with HLW located therein, such as, but not limited to, a SNF assembly or portion thereof) that is not to be physical separated nor detached from its surrounding and structural die (mold) after the diecasting process is completed.

It is yet another objective of the present invention to generate a given integral encapsulated unit (composite unit) from a gravity fed diecasting process, wherein the given integral encapsulated unit (composite unit) comprises a die (mold) along with its internally retained casting (wherein that casting comprises HLW and resolidified supporting alloy(s) material), wherein the given integral encapsulated unit (composite unit) is readily convertible into a waste capsule, and wherein the waste capsule is easily movable within a system of wellbores.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale to enhance their clarity and improve understanding of these various elements and embodiments of the invention. Furthermore, elements known to be common and/or well-understood to those in the industry are not necessarily depicted to provide a clearer view of the various embodiments of the invention(s). Some common items may be left off the drawings for clarity and ease of viewing. For example, and without limiting the scope of the present invention, in some instances, specific devices or apparatuses may not be shown in a given view. Still, it may be obvious to a person of ordinary skill in the relevant arts (technical fields) from the description that these items may be present and/or used in the given embodiment.

FIG. 1A is prior art and is a perspective view showing a Canadian model CANDU for a nuclear fuel assembly.

FIG. 1B is prior art and is a perspective view showing a (Russian) nuclear fuel assembly.

FIG. 1C is prior art and is a perspective view showing a U.S. nuclear fuel assembly.

FIG. 2A is prior art and is a perspective view showing a SKB spent fuel (SNF) canister and cradle assembly used in Finland and/or in Sweden.

FIG. 2B is prior art and is a perspective view showing a Canadian spent fuel (SNF) canister assembly for disposal in near-surface repositories.

FIG. 2C is prior art and is a front view showing U.S. (proposed/planned) operations where spent fuel (SNF) assemblies disposal is made in shallow mines or tunnel systems for disposal in near-surface repositories like Yucca Mt in Nevada.

FIG. 2D is prior art and shows a capsule for containment of spent nuclear fuel inserted in a pressure furnace for joining together a cover and a hollow cylinder by “hot isostatic pressing” (HIP); note, FIG. 2D of this present patent application is a prior art representation of a FIG. 1 from U.S. Pat. No. 4,209,420.

FIG. 3A is prior art and is a perspective view showing a generalized schematic of one type of SNF assembly showing at least some of its fuel rods and control rods (and with void spaces therebetween).

FIG. 3B is prior art and is a perspective view showing an inner schematic perspective view cross-section of a generic SNF fuel assembly, showing fuel rods and control rods and also showing free void spaces present in the SNF fuel assembly (e.g., around and in between the fuel rods and the control rods).

FIG. 4A depicts a two-dimensional (2D) schematic cross-sectional view and associated features of a gravity fed diecast system that may be used for generating (producing and/or outputting) the specialized the integral encapsulated units, wherein the given the integral encapsulated unit may comprise at least one SNF assembly or portion thereof within that given integral encapsulated unit.

FIG. 4B shows a 2D schematic of an embodiment wherein a given mold's volume may be initially only partially filled with a molten material, before a SNF assembly (or portion thereof) may be inserted into that same mold; then fully loading (inserting) the SNF assembly (or portion thereof) into that partially filled volume of the molten material, within that same given mold; and then completing filling of volume of that mold with the molten material until at least all of the fully inserted the SNF assembly (or portion thereof) is entirely and completely covered with the molten material.

FIG. 5A depicts a schematic lengthwise cross-section of a completed waste integral encapsulated unit (composite unit) after the gravity fed diecasting formation process and illustrating the SNF assembly (or portion thereof) located entirely within that completed waste integral encapsulated unit (composite unit).

FIG. 5B depicts a representational transverse width cross-section through a completed waste integral encapsulated unit (composite unit) after the diecasting formation process, showing the re-solidified metal(s) and/or alloy(s) surrounding and completely enclosing the SNF assembly (or portion thereof).

FIG. 5C is a partial exterior perspective view showing exterior surfaces of a portion of a completed integral encapsulated unit (composite unit) after the diecasting formation process.

FIG. 6A depicts an exploded perspective view of a waste capsule that was formed from a given integral encapsulated unit.

FIG. 6B depicts a schematic lengthwise cross-sectional view and cutaway view of the integral encapsulated unit that is convertible into a waste capsule, wherein the waste capsule may be configured for emplacement within a given deep wellbore disposal system (e.g., a SuperLAT™ system).

FIG. 6C depicts a schematic lengthwise external view of a waste capsule that was formed from a given integral encapsulated unit, wherein the waste capsule may be configured for emplacement within a given deep wellbore disposal system (e.g., a SuperLAT™ system).

FIG. 6D depicts an exploded (dissembled) perspective view of a given disposal waste capsule that is made from (formed from and/or converted from) at least two different integral encapsulated units.

FIG. 7 shows a section (portion), in cross-section, through a deep wellbore system (e.g., a SuperLAT™ system) that is configured to receive disposal waste capsules (with waste castings located inside of the disposal waste capsules) within the wellbore(s).

FIG. 8A shows a flowchart of at least some steps in a method of processing HLW waste, using gravity fed diecasting, waste capsules, and wellbore(s) located in deep geologic formation(s).

FIG. 8B shows a flowchart of at least some steps in a method of processing HLW waste, using gravity fed diecasting, waste capsules, and wellbore(s) located in deep geologic formation(s).

FIG. 8C shows a flowchart of at least some steps in a method of processing HLW waste, using gravity fed diecasting, waste capsules, and wellbore(s) located in deep geologic formation(s).

FIG. 9 depicts a waste disposal repository system (e.g., a SuperLAT™ system) in which waste capsules (of integral encapsulated units) are sequestered in horizontal wellbore(s), wherein the horizontal wellbore(s) are located within deeply located geological formation(s).

FIG. 10 illustrates an example of a type of (relatively) small surface plaque (or the like) generally made of concrete (or the like) with a (brass or the like) inscription plate, that may identify presence of a deeply located nuclear waste repository located below that plaque.

### REFERENCE NUMERAL SCHEDULE

101 (Canadian CANDU) nuclear fuel assembly 101
103 (Russian) nuclear fuel assembly 103
105 (U.S.) group (bundle) of nuclear fuel assemblies 105
106 nuclear fuel assembly 106
201 thick-walled and corrosion-resistant heavy copper cylindrical canister 201
203 cradle (scaffold) 203
205 SNF assembly 205
207 cover (lid) 207
209 final cover (lid) 209
211 thick-walled and corrosion-resistant heavy copper cylindrical canister 211
213 structural metal cylindrical canister 213
215 end cap (end plug) 215
221 tunnel 221
223 tunnel wall 223
225 titanium drip shield 225
227 tunnel floor 227
301 void space 301
303 fuel rod 303
305 control rod 305
307 base (support structure) 307
400 gravity fed diecasting system for use on SNF assemblies 400
406 feed port 406
408 melt furnace and/or alloy reservoir 408
409 alloy(s) in melt (liquid) form 409
409a partial fill volume (fill line) of molten material 409a
410 flowline (inlet line) 410
411 endcap 411
412 SNF assembly (or portion thereof) 412
413 (removable) die-cast mold 413
414 B₄C sleeve 414
415 alloy (mixture) 415
416 base (for mold) 416
417 support (for mold) 417
418 gas vent 418
419 system controller 419
420 gas source 420
421 gas line 421
425 heating means 425
427 (robotic) handler 427
429 cooling bath 429
433 volume (within die [mold]) 433
435 neutron absorber material 435
436 vent hood 436
437 direction of HLW insertion 437
500 integral encapsulated unit (composite unit) 500
501 exterior surface (of integral encapsuled unit) 501
503 minimum thickness 503
512 modified SNF assembly (or portion thereof) 512
521 separator 521
599 common central axis 599
600 disposal waste capsule 600
603a attachment-means 603a
603b complementary attachment-means 603b
604 coupling 604
605 attachment-means 605
611 removable protective cap 611
621 separator-plate 621
700 waste disposal system using deeply located wellbore(s) 700
701 string (of connect waste capsules) 701
703 wellbore 703
705 deeply located geologic formation 705
800 method of processing SNF assemblies (or portions thereof) for disposal 800
801 step of collecting and/or selecting SNF assemblies (or portions thereof) 801
803 step of determining free (void) volume of SNF assembly (or portion thereof) 803
805 step of selecting/determining metal(s) and/or alloy(s) 805
807 step of determining volume (amount) of metal(s) and/or alloy(s) 807
809 step of performing fissile criticality analysis (FCA) 809
811 step of melting metal(s) and/or alloy(s) 811
813 step of building die mold 813
814 step of collecting/transferring melted materials to reservoir 814
815 step of selecting & determining neutron absorber(s) & amounts 815
816 step of adding neutron absorber(s) 816
817 step of preheating of SNF assembly (or portion thereof) and/or of mold 817
819 step of lining (inserting) a borated (neutron absorbing) sleeve into a mold 819
821 step of injecting (inert) gas into mold 821
823 step of inserting SNF assembly (or portion thereof) into mold 823
825 step of gravity pouring melted materials into loaded mold 825
826 step of cooling and/or removing composite unit 826
827 step of looping operations 827
828 step of preparing (converting) composite units into waste capsules 828
829 step of inserting waste capsules into wellbore within deep geological formation 829
830 step of building (constructing) wellbore(s) system(s) 830
831 step of sealing (closing) (loaded) wellbore(s) system(s) 831
832 step of surface marking of disposal site 832
833 step of activating and/or using vent hood 833
834 step of partial fill of mold with molten material(s) before HLW insertion into mold 834
835 step of inserting HLW (e.g., SNF) into mold partially filled with molten material(s) 835
900 waste disposal system using deeply located horizontal wellbore(s) 900
901 horizontal (lateral) wellbore(s) 901
903 vertical wellbore(s) 903
905 terrestrial (Earth) surface 905
907 drilling rig 907
911 nuclear power generation reactor plant 911
913 infrastructure building or structure 913
915 plug 915
1001 surface plaque 1001
1003 nominal dimensions (of surface plaque) 1003
1005 inscription plate 1005
1007 trees (tree line) 1007

### DETAILED DESCRIPTION OF THE INVENTION

In this patent application, the term “HLW” refers to high-level nuclear waste, which is radioactive. In this patent application, the term “SNF” refers to spent nuclear fuel and is a type of (a subcategory of) HLW. In this patent application, the terms “HLW” and “SNF” may be used interchangeably.

In this patent application, the terms “wellbore” and “borehole” may be used interchangeably. Note, unless “wellbore” is prefaced with “vertical,” “horizontal,” or “lateral,” then use of “wellbore” alone may refer to a vertical wellbore, a horizontal wellbore, a lateral wellbore, and/or a combination of such wellbore types.

In this patent application, the terms “capsule,” “waste capsule,” “disposal waste capsule,” “waste-capsule,” and/or “disposal-waste-capsule” may be used interchangeably with the same meaning referring to a capsule that is configured to house, hold, and/or retain waste therein, such as, but not limited to, nuclear waste, radioactive waste, HLW, SNF, SNF assemblies, castings, ingots, integral encapsulated units (composite units), a portion thereof, combinations thereof, and/or the like.

In this patent application, the terms “die-cavity,” “die cavity,” and/or “cavity,” may be used interchangeably to refer to the three-dimensional (3D) volume (space) in which the SNF assembly (or portion thereof) (or other waste to be disposed of) may reside within during the gravity fed die casting formation operations; whereas, the terms “die” and/or “mold” may be used interchangeably to refer to the overall structure that may be configured to receive the SNF assembly (or portion thereof) (or other waste to be disposed of) during the gravity fed die casting formation operations, wherein the die (mold) may be the structure that surrounds the cavity.

In this patent application, the terms “gravity fed,” “gravity injection,” “gravity introduction,” and/or “gravity pour,” may be used interchangeably to refer to the introduction (feeding and/or pouring) of a hot liquid melt alloy (or metal) into a die-cavity under the effects of gravity (and/or at local atmospheric pressure), but without application of high pressure.

In this patent application, the terms “tube,” “cylinder,” and “pipe” may be used interchangeably to refer to cylindrical elements (sections and/or portions) implemented in the design, installation, and/or construction processes of lining and/or forming wellbores.

In this patent application, the terms “ingot” and/or “casting” may be used interchangeably to refer to the solid three-dimensional (3D) outputs, of generally cylindrical elements (members), formed by the gravity fed die casting process taught herein from a given die (mold), wherein such a casting (and/or ingot) may entirely contain (house) a given SNF assembly (or portion thereof) (or other HLW). And in this particular patent application, the given casting, once formed, may not be physically separated from its die (mold); the die (mold) and its formed casting together form an integral encapsulated unit (composite unit).

In the following discussion that addresses a number of embodiments and applications of the present invention, reference is made to the accompanying drawings that form a part thereof, where depictions are made, by way of illustration, of specific embodiments in which the invention may be practiced. It is to be understood that other embodiments may be utilized, and changes may be made without departing from the scope of the invention.

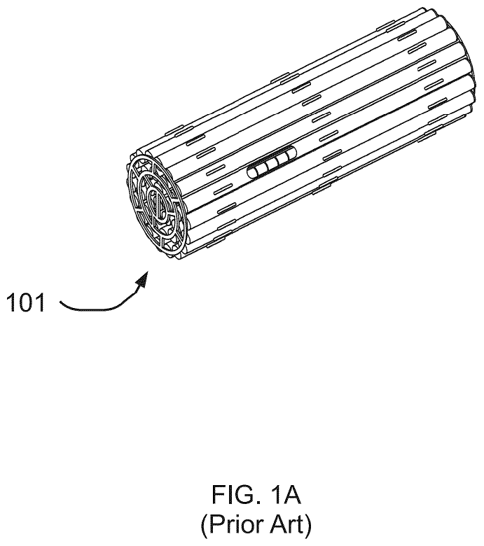

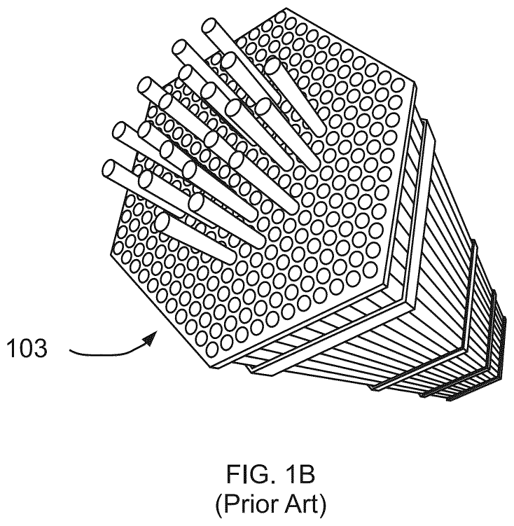

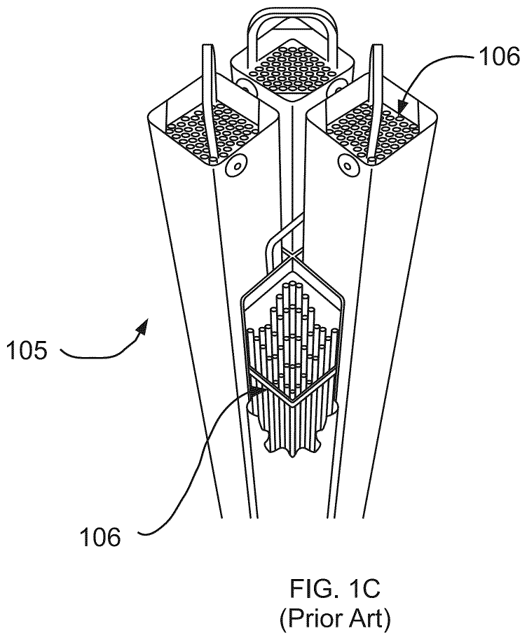

FIG. 1A is prior art and shows a Canadian model CANDU for a nuclear fuel assembly 101.

FIG. 1B is prior art and shows a Russian nuclear fuel assembly 103.

FIG. 1C is prior art and shows a group or bundle of U.S. nuclear fuel assemblies 105, with a plurality of single SNF assembly 106 being part of that bundle 105.

FIG. 1A, FIG. 1B, and/or FIG. 1C may collectively illustrate types of prior art preexisting and current nuclear fuel assemblies 101, 103, 105, and 106, at least used in Canada, Russia, and the U.S., respectively. These nuclear fuel assemblies 101, 103, 105, and 106, vary in size and shape in actual practice and have been specifically designed to optimize performance during power generation. Some nominal dimensions of these types of nuclear fuel rod assemblies 101, 103, 105, and 106, may be as follows: (a) square or rectilinear fuel rod assemblies 106 are usually between four (4) meters (m) to five (5) meters in length and about fourteen (14) centimeters (cm) to twenty-two (22) cm in cross-section; and (b) nominal dimensions of the circular/cylindrical fuel rod assemblies 101 are about fifty (50) cm long and about ten (10) cm in cross-section. In any event, as these nuclear fuel assemblies 101, 103, 105, and 106, are prior art and existing, the precise dimensions and geometries are known.

Note, if the given nuclear fuel assembly of FIG. 1A, FIG. 1B, and/or of FIG. 1C is “spent,” then such a nuclear fuel assembly may be of a particular type of spent nuclear fuel (SNF) assembly.

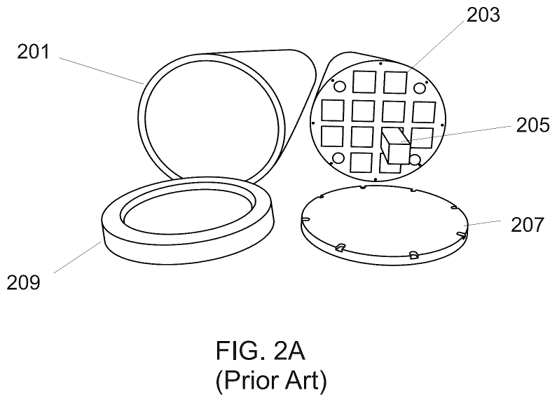

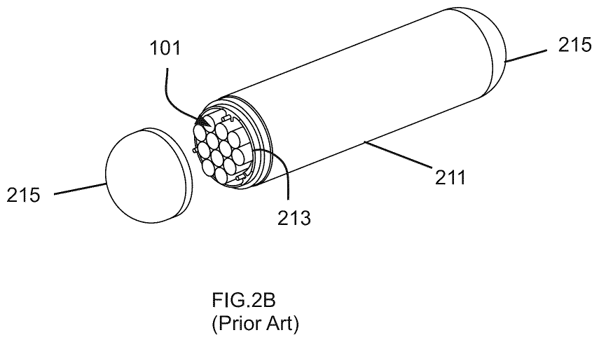

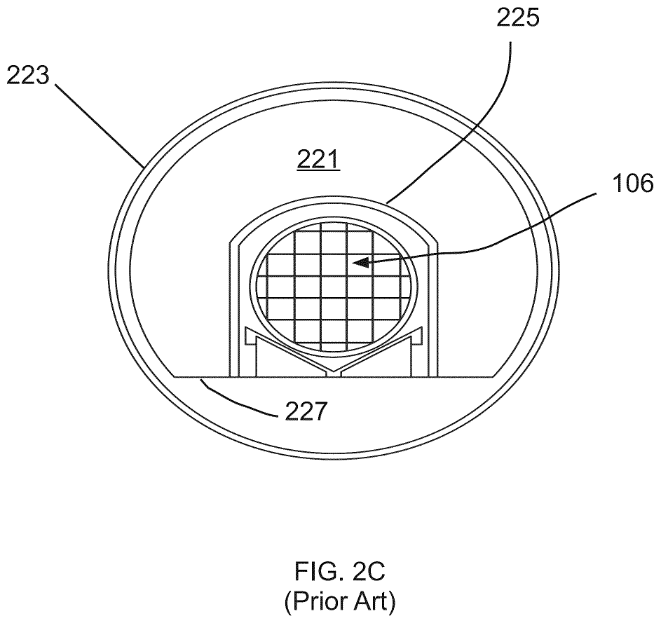

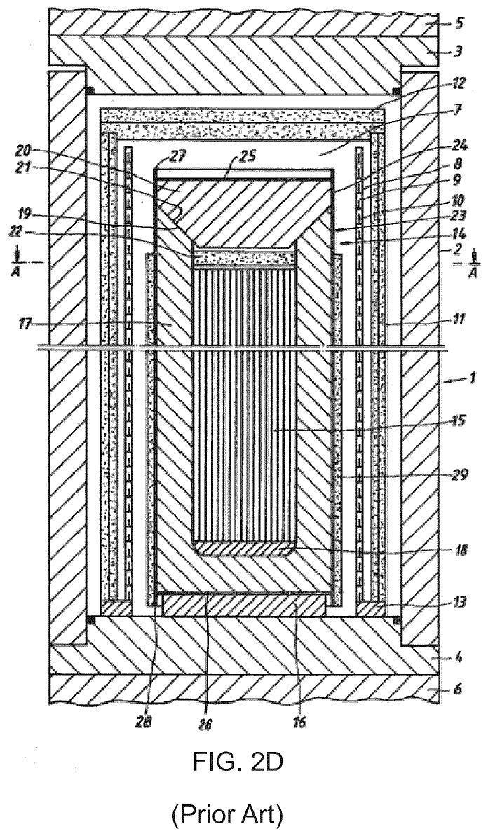

In prior art technology and operations, prior approaches to treating SNF assemblies are taught, at least some of which are depicted in FIG. 2A, in FIG. 2B, and in FIG. 2C.

FIG. 2A is prior art and shows a SKB spent fuel (SNF) canister 201 and cradle 203 assembly used in Finland and in Sweden. The prior art SNF waste disposal approach taught in Finland (and Sweden) utilizes a set of SNF assemblies 205 that are emplaced in a structural cast iron honeycomb cradle 203 (scaffold 203) supporting structure. The cradle 203 with its held set of SNF assemblies 205 are capped with a cover (lid) 207. Then this composite structure (e.g., the cradle 203 with its held set of SNF assemblies 205 and the cover 207) are enclosed in a very thick-walled and corrosion-resistant heavy copper cylindrical canister 201. Canister 201 (along with its holdings) is then closed with a final cover (lid) 209. Then the massive copper cylindrical canister 201 along with its contents (e.g., of the cradle 203 that is holding the SNF assemblies 205), is then disposed of in vertical shafts implemented by drilling a “shallow” borehole in a floor of a tunnel or mine repository. See e.g., FIG. 2A.

FIG. 2A illustrates a prior art process for handling and packaging of SNF assemblies 205. FIG. 2A illustrates the “SKB” process practiced in Finland and/or in Sweden in which the SNF assemblies 205 that have been removed from cooling ponds (e.g., at nuclear power generation plants or from other [surface] storage systems) are stored first in a cast iron honeycomb structure 203 (cradle 203). The SNF assemblies 205 and the cast iron cradle 203 are then enclosed inside a massive, flanged copper cylinder 201, forming a disposal capsule 201. This disposal capsule 201 is more than three (3) feet in diameter and with walls of at least two (2) inches in thickness. A full capsule 201 system may weigh more than 24,460 pounds (lbs.) when loaded with SNF assemblies 205. This prior art capsule 201 disposal system is then sequestered in small disposal holes drilled vertically in the floor of a disposal tunnel of a near-surface repository. Loading of these filled capsules 201 underground requires a complex of rails, trucks, transports, and heavy equipment insertion devices that must operate within confined areas excavated in more than thirty-one (31) miles of in near surface tunnels. This prior art approach is essentially establishing a small village underground.

FIG. 2B is prior art and shows a Canadian spent fuel (SNF) canister 211 assembly for disposal in near-surface repositories. This prior art approach for SNF disposal, published in Canada, bundles the individual SNF assemblies 101 into a generally cylindrical bundle of SNF assemblies 101, wherein the bundle then gets emplaced inside a structural metal cylindrical canister 213 and then this structural metal cylindrical canister 213 (with the bundle of SNF 101 assemblies) gets enclosed completely inside a protective massive copper canister 211 with end caps 215 which are friction welded to the original copper cylinder canister 211 member. See e.g., FIG. 2B.

FIG. 2B illustrates a prior art process for handling and packaging of SNF assemblies 101. FIG. 2B illustrates the SNF assemblies 101 capsule 211 disposal process currently practiced in Canada in which the SNF assemblies 101 that have been removed from cooling ponds (at the nuclear power generation plants or from other [surface] storage systems) are stored in a metal container 213 with a copper cap(s) 215 thus forming a disposal capsule 211. The Canadian capsule 211 system is about 2.5 meters (m) long, 0.4 m to 0.6 m in diameter, and with a copper wall thickness of three (3) millimeters (mm). A filled disposal capsule 211 may weigh about 2.8 metric ton (mt) and is buried and stored in a near surface waste repository in which a small “grave-like burial cavity” is excavated transversely in a floor of a near surface disposal tunnel.

FIG. 2C is prior art and shows U.S. (proposed and/or planned) operations where spent fuel (SNF) assemblies 106 disposal is made in shallow mines or tunnel systems for disposal in near-surface repositories like Yucca Mt in Nevada. This prior art approach, published in the U.S., teaches the emplacement of groups 105 of SNF assemblies 106 as integral waste packages on a rail-type system inside a near-surface (e.g., 300 meters [m] below terrestrial surface) tunnel 221 that is unrealistically and dangerously placed above the local water table. The tunnel 221 is surrounded along its length by a tunnel wall 223. The nuclear waste capsule packages are then expected to be protected by a set of titanium drip shields 225 which are supposed to be installed sometime in the future, after complete waste emplacement. It is hoped that these titanium “umbrellas” 225 can unrealistically protect the emplaced waste 105/106 from vertically migrating groundwater for 10,000 years. Tunnel floor 227 is a floor of such a tunnel. Interaction with the local water table should cause undesired and dangerous regular migration of radionucleotides away from and out of the intended repository. See e.g., FIG. 2C.

FIG. 2D of this present patent application is a prior art representation of a FIG. 1 from U.S. Pat. No. 4,209,420. FIG. 2D of this present patent application shows a prior art operation where spent fuel (SNF) assemblies are embedded in a solid composite matrix by a process called “hot isostatic pressing” (HIP). The process involves placing the waste material, mixed with glass or ceramic, into a sealed container. This container is then subjected over a prolonged period of time to high temperatures and high pressures in a specialized HIP furnace. This system essentially behaves like a high temperature closed high pressure cooker in common use. The hot isostatic pressing (HIP) process for nuclear waste encapsulation typically requires several hours or more to complete. The exact duration can vary depending on the specific materials and waste form being processed, but it generally ranges from two (2) to twenty-four (24) hours per cycle. This time frame includes the heating period to reach the desired temperature, the holding period at high temperature and pressure to ensure complete densification, and the cooling period. The precise parameters are carefully controlled. The combination of heat and isostatic pressure causes the material to densify, eliminating voids and creating a solid, monolithic structure. This dense form minimizes the potential for radioactive leakage and enhances the long-term stability and safety of the waste form, making it suitable for secure, deep geological disposal.

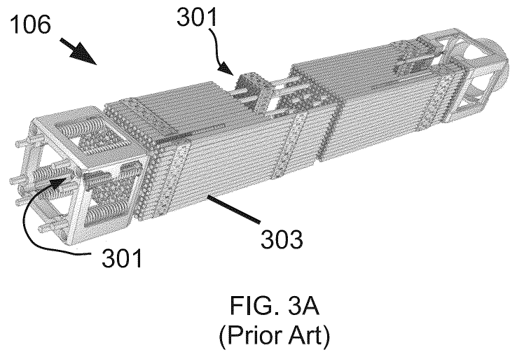

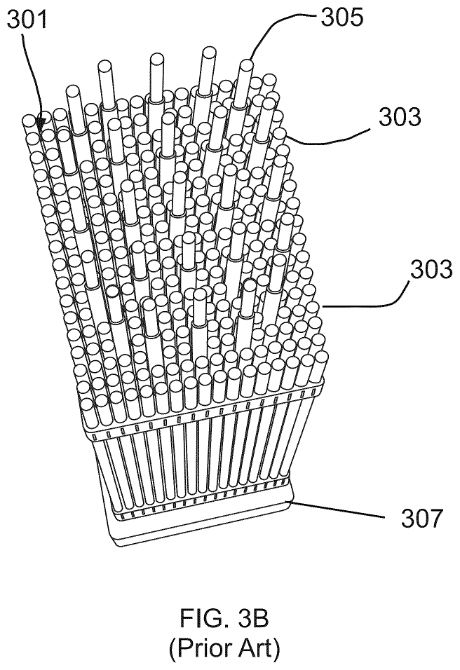

FIG. 3A is prior art and depicts an isometric (perspective) generalized schematic of one type of SNF assembly 106 showing at least some of its fuel rods 303, control rods 305 (see FIG. 3B for use of reference numeral 305), and with void spaces 301 (internal void spaces 301) therebetween. FIG. 3A shows an isometric rendering of a generic United States (U.S.) SNF assembly 106. This FIG. 3A illustration shows the geometry and construction of the fuel rods 303 and the control rods 305 and the structural elements of the SNF assembly 106.

FIG. 3B is prior art and shows an inner schematic perspective view cross-section of a generic SNF fuel assembly 106, showing its fuel rods 303, control rods 305, and with void spaces 301 present in the assembly. FIG. 3B illustrates an isometric (perspective) graphic of a partial typical U.S. SNF assembly 106. FIG. 3B shows the fuel rods 303 and the moderator or control rods 305 on a SNF base 307. The spatial geometry of the SNF assembly 106 illustrates the distribution of solid cylindrical elements and available void spaces 301 within the body or matrix of these SNF 106 assemblies. There is considerable free space, porosity, or voids 301 between and around the collective internal structural elements (such as, fuel rods 303, control rods 305) that make up an SNF assembly 106. This internal intricate void space 301, of a typical SNF assembly 106 (or of any presently known SNF assembly), may be easily and readily determined by a number of well-known techniques. For example, and without limiting the scope of the present invention, this internal intricate void space 301, of a typical SNF assembly 106 (or of any presently known SNF assembly), may be easily and readily determined from digital 3D modeling software used to model a given SNF assembly 106. For example, and without limiting the scope of the present invention, this internal intricate void space 301, of a typical SNF assembly 106 (or of any presently known SNF assembly), may be easily computed empirically by a liquid displacement process on a given finished SNF assembly 106.

This availability feature of void spaces 301 may be exploited in the novel gravity fed diecasting process taught herein, in which these internal voids 301 are filled with melted (molten) metal(s) and/or alloys 409 during the gravity fed diecasting process, to provide a novel protected disposal casting (integral encapsulated unit [composite unit] 500) that includes a given SNF assembly (or portion thereof) 106 and the molten composition 409 as a single solid heterogenous matrix, with the void space 301 at least substantially (mostly) filled with the metallic alloys 409, even down to the microscopic level. In some embodiments of the present invention, this internal intricate void space 301, of a typical SNF assembly 106 (or of any presently known SNF assembly), may be intended to be at least substantially (mostly) filled with at least molten liquid material 409 during a gravity fed diecast molding operating around an entirety of a given SNF assembly or a portion of that given SNF assembly.

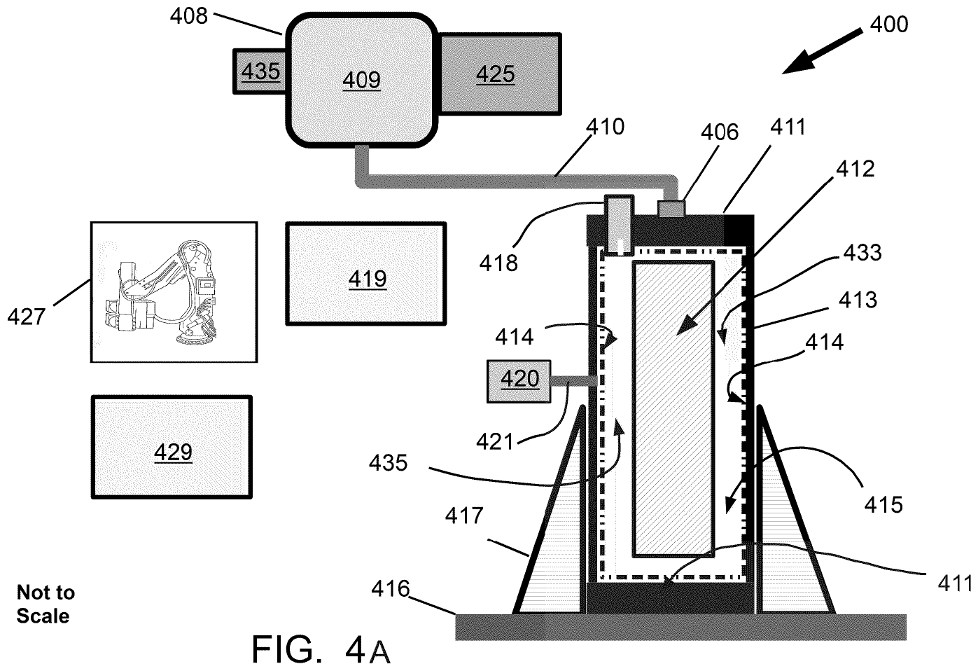

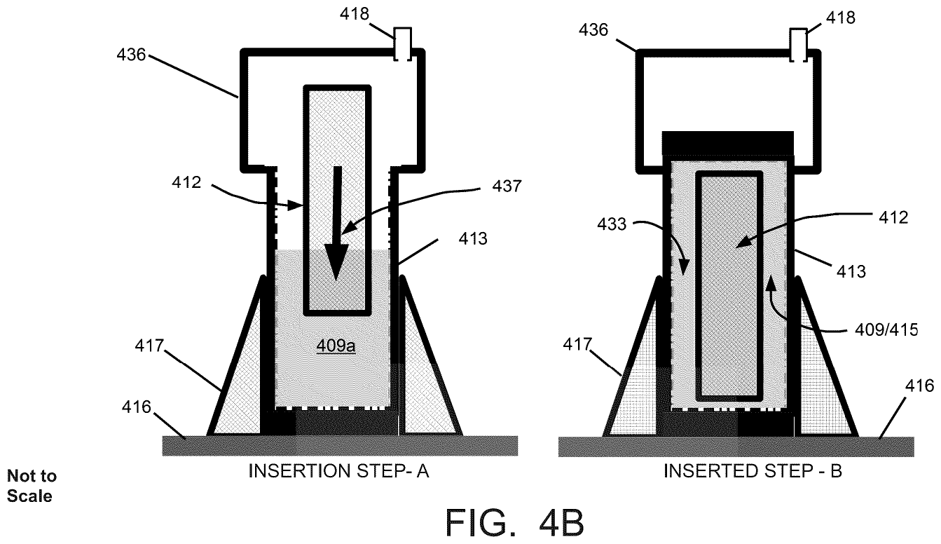

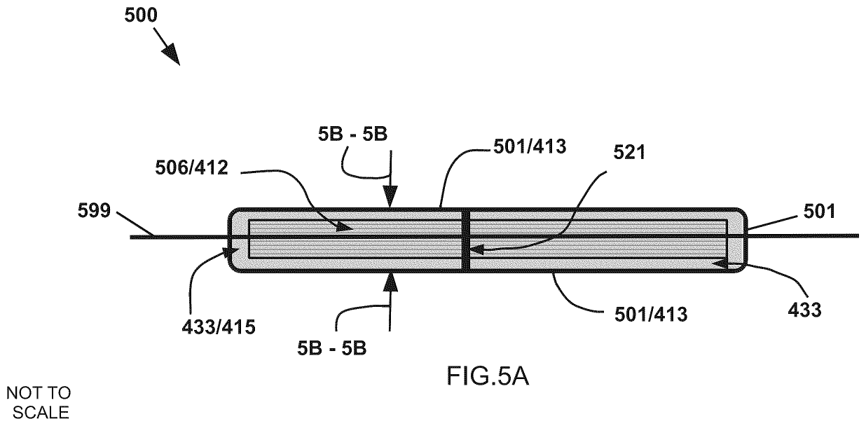

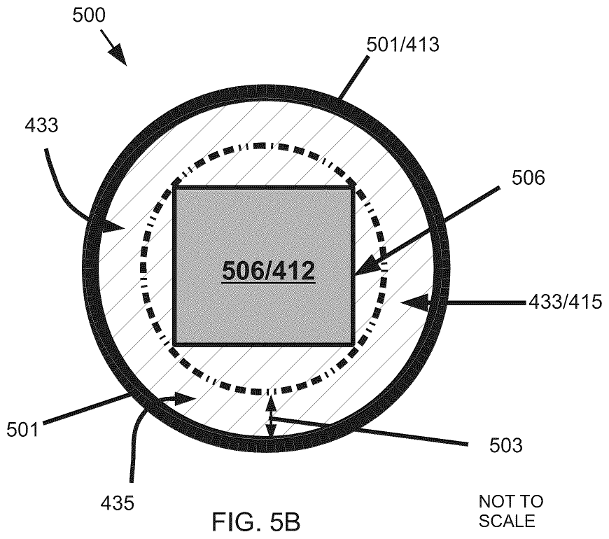

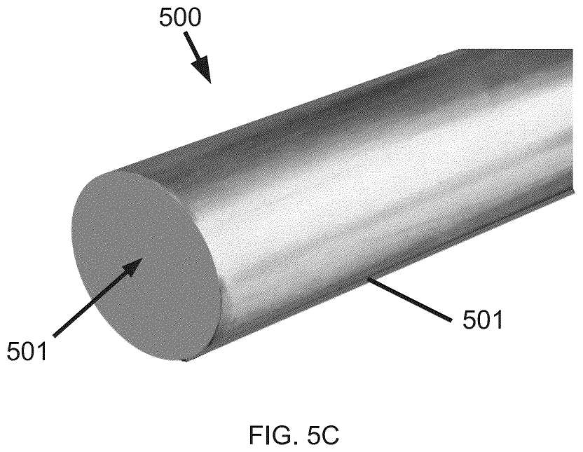

FIG. 4A may be a schematic view showing an embodiment of a gravity fed diecast molding system 400 for generating (producing and/or outputting) integral encapsulated units 500, wherein a given integral encapsulated unit 500 may comprise a die (mold) 413 containing at least one SNF assembly (or portion thereof) 412 located and positionally fixed within that given die (mold) 413; and wherein disposed between the SNF assembly (or portion thereof) 412 and the die (mold) 413 is re-solidified alloy material (mixture) 415. Note, a given integral encapsulated unit 500 (or a portion thereof) is shown in FIG. 5A, in FIG. 5B, and/or in FIG. 5C. FIG. 4A depicts a two-dimensional (2D) schematic view of a gravity diecast system 400 used for generating (producing and/or outputting) composite integral encapsulated units 500. FIG. 4A shows a cross-section of a closed (cylindrical) die (mold) 413 along with possible contents of that die (mold) 413. In some embodiments, when die (mold) 413 has been closed with a given SNF assembly (or portion thereof) 412 located entirely inside of that closed die (mold) 413, then that given SNF assembly (or portion thereof) 412 may be entirely disposed within that closed die (mold) 413 as shown in FIG. 4A. In some embodiments, closed die (mold) 413 may entirely surround a given (and predetermined) volume 433 within that closed die (mold) 413. In some embodiments, volume 433 within the closed die 413 may be configured to entirely house (hold [retain]) a given SNF assembly (or portion thereof) 412. In some embodiments, any void spaces within the internal volume 433 of mold 413, such as, but not limited to, void space 301 and/or any space between interior surfaces of die (mold) 413 and exterior surfaces of the housed SNF assembly (or portion thereof) 412, may be configured to be at least substantially (mostly) filled with liquid (molten) medium 409 during gravity fed operations with die (mold) 413 closed. It should be noted that after the gravity die-cast operations are complete, in which the melt 409 is gravity poured into the removable mold 413 (and around the SNF assembly (or portion thereof) 412 located therein), the composite unit of removable mold 413, of re-solidified alloy mixture 415, and of SNF assembly (or portion thereof) 412, may now form the integral encapsulated unit 500.

In some embodiments, SNF assembly (or portion thereof) 412 may be one or more of: nuclear fuel assembly 106, group (bundle) of SNF assemblies 105, SNF assembly 101, SNF assembly 103, SNF assembly 205, base 307, spent nuclear fuel assembly, fuel rod, fuel pellet, control rod, a portion thereof, combinations thereof, and/or the like. In some embodiments, SNF assembly (or portion thereof) 412 may be selected from one or more of: nuclear fuel assembly 106, group (bundle) of SNF assemblies 105, SNF assembly 101, SNF assembly 103, SNF assembly 205, base 307, spent nuclear fuel assembly, fuel rod, fuel pellet, control rod, a portion thereof, combinations thereof, and/or the like.

Continuing discussing FIG. 4A, in some embodiments, a given gravity fed diecast molding system 400 may comprise a (removable) die (mold) 413. In some embodiments, a given gravity fed diecast molding system 400 may comprise at least one of: a die (mold) 413, a feed port 406, an alloy reservoir 408, alloy(s) in melt (liquid) form 409, a flowline 410, endcap(s) 411, a SNF assembly (or portion thereof) 412, a (neutron shielding) sleeve 414, alloy material (mixture) 415, a base 416, a support 417, a gas vent 418, a controller 419, a gas source 420, a gas line 421, a heating means 425, a handler 427, a cooling bath 429, combinations thereof, and/or the like. However, in some embodiments, system 400 may omit one or more of these items.

Continuing discussing FIG. 4A, in some embodiments, diecast mold 413 may be configured such that at least one spent nuclear fuel assembly or portion thereof 412 fits entirely within the diecast mold 413 (when closed or open). In some embodiments, diecast mold 413 may be configured to entirely and completely enclose the at least one spent nuclear fuel assembly or portion thereof 412 when the diecast mold 413 is closed. In some embodiments, die (mold) 413 (diecast mold 413) may be formed from a hollow cylinder of steel and two endcaps 411 for sealing over the otherwise open opposing terminal ends of that hollow cylinder. In some embodiments, a fixed (non-variable) length of a given die (mold) 413 may be constructed to as to fit within that die (mold) 413 a given SNF assembly (or a portion thereof) 412 of a particular fixed (non-variable) length. A diameter of the hollow cylinder may be configured to fit a diameter of a SNF assembly (or a portion thereof) 412 within that hollow cylinder and to have a minimum thickness 503 between an inside of the hollow cylinder and an exterior of SNF assembly (or a portion thereof) 412 (see e.g., FIG. 5B for minimum thickness 503). In some embodiments, die (mold) 413 may comprise two opposing endcaps 411. In some embodiments, a given endcap 411 may be of a circular disk (disc) shape that is at least substantially (mostly) to entirely solid. In some embodiments, the solidity of a top endcap 411 may be breached only by feed port 406 and/or by vent 418 (but otherwise may be solid); whereas, a bottom endcap 411 may be entirely solid. In embodiments, each endcap 411 may be configured to attach to and to seal the otherwise open end of the hollow cylinder. In some embodiments, attachment between the endcap 411 and the hollow cylinder may be by welding, friction fit, press fit, mechanical fasteners (such as, but not limited to, rivets, bolts, screws, and/or the like), glues, adhesives, epoxies, any attachment means/method employed to attach to metal parts to each other, combinations thereof, and/or the like. In some embodiments, a bottom endcap 411 may be attached to the hollow cylinder before any molten material(s) 409 is flowed into the die (mold) 413 and/or before the SNF assembly (or portion thereof) 412 is inserted into the die (mold) 413. In some embodiments, diecast mold 413 may be at least mostly made from at least one metal or at least one alloy; wherein in some embodiments, the at least one alloy may be a steel. In some embodiments, the endcaps 411 (of diecast mold 413) and the hollow cylinder (of diecast mold 413) may all be made out of the same material(s) of construction, such as, but not limited to, steel. In some embodiments, the steel material of construction of die (mold) 413, its hollow cylinder, and/or of its endcaps 411 may be borated steel for a purpose of absorbing neutrons. In some embodiments, die (mold) 413 and/or endcap(s) 411 may be constructed at least mostly from high-strength (tubular and/or sheet) steel used in oil wells or similar industries. Such steel has up to 125,000 pounds per square inch (psi) (or about 860 mega Pascals [MPa]) tensile strength and up to 139,000 psi (958 MPa) yield strength; and is thus fully capable of being a strong, effective die-mold system in a gravity pour system where the casting is designed not to be removed from the die (mold).

Continuing discussing FIG. 4A, in some embodiments, die (mold) 413 may comprise a borated sleeve 414 and/or a sleeve 414 that is configured to absorb neutrons and/or shield against neutron emissions. In some embodiments, sleeve 414 may be hollow cylinder of borated material, that is configured to fit inside of the hollow cylinder of die (mold) 413. In some embodiments, the cylinder of sleeve 414 and of the hollow cylinder of die (mold) 413 may be concentric with respect to each other. In some embodiments, sleeve 414 may comprise boron carbide (B₄C). In some embodiments, with respect to die (mold) 413 (or to integral encapsulated unit 500), sleeve 414 may be located closer to an interior surface of die (mold) 413 than to SNF assembly (or portion thereof) 412. In some embodiments, sleeve 414 may be configured to absorb neutron emissions.

Continuing discussing FIG. 4A, in some embodiments, reference numeral “409” may be associated with interchangeable terminology of “molten composition,” “molten materials,” “molten metal(s),” “molten alloy(s),” “molten copper,” “molten copper alloy(s),” “melt,” portions thereof, combinations thereof, and/or the like. Further, “molten” may be replaced and/or interchanged with “melted” in this context. Further still, while molten composition 409 may be molten and/or melted, molten composition 409 may behave like a fluid and/or a liquid; and once composition 409 has sufficiently cooled, then composition 409 may no longer by molten, melted, liquid, and/or fluid and may instead be solid (resolidified) and/or behave as a solid—and may then be associated with reference numeral “415” once resolidified. In some embodiments, medium 409 may comprise at least one: metal, alloy, neutron absorber, portions thereof, combinations thereof, and/or the like. In some embodiments, the metal and/or the alloy of medium 409 may be at least partially or at least substantially (mostly) of copper. In some embodiments, liquid (molten) medium 409 may or may not include the neutron absorber(s). In some embodiments, gravity fed diecasting system 400 and/or gravity fed components and/or apparatus may additionally comprise (a predetermined volume of) composition 409. In some embodiments, reference numeral “415” may be molten material(s) 409 that are within volume 433 of die (mold) 413. Depending upon the state (status) of the gravity diecasting operations, alloy(s) mixture 415 may be liquid to resolidified. See e.g., FIG. 4A for molten composition 409 and 415.

Continuing discussing FIG. 4A, in some embodiments, gravity fed components and/or apparatus may be configured to gravity feed a liquid (and/or molten) medium 409 into the interior volume 433 within (closed) die (mold) 413 from a melt furnace and/or reservoir 408. In some embodiments, gravity force may provide the motive means for feeding (pouring) liquid (and/or molten) medium 409 from melt furnace and/or reservoir 408 and into (closed) die (mold) 413. In some embodiments, during active gravity feeding (pouring) operations, when die (mold) 413 may be closed (and holding a SNF assembly [or portion thereof] 412), the operatively connected gravity fed components and/or apparatus may introduce (feed [pour]) liquid (molten) medium 409 from melt furnace and/or reservoir 408 and into (closed) die (mold) 413, to (substantially [mostly]) fill all aforementioned void spaces within volume 433 (including SNF assembly [or portion thereof] 412 void spaces 301) and producing integral encapsulated unit 500 once that introduced medium 409 has cooled sufficiently to resolidify (and/or to become self-supporting). At the end of the gravity feeding and re-solidification process, the SNF assembly (or portion thereof) 412 and the resolidified melt material 415 may form a single composite mass, that is heterogenous, and that may be referred to as a casting (or ingot).

Continuing discussing FIG. 4A, in some embodiments, gravity fed components and/or apparatus may comprise a melt furnace and/or an alloy reservoir 408. In some embodiments, gravity fed components and/or apparatus may comprise melt furnace and/or an alloy reservoir 408, flowline (inlet line) 410. In some embodiments, gravity fed components and/or apparatus may comprise melt furnace and/or an alloy reservoir 408, flowline 410, and feed port 406. In some embodiments, gravity fed components and/or apparatus may comprise melt furnace and/or an alloy reservoir 408 and controller 419. In some embodiments, gravity fed components and/or apparatus may comprise melt furnace melt furnace and/or an alloy reservoir 408, flowline 410, feed port 406, controller 419, portions thereof, combinations thereof, and/or the like.

Continuing discussing FIG. 4A, in some embodiments, melt furnace and/or an alloy reservoir 408 may be a vessel (container) that is configured to house and/or heat alloy(s) materials 409 and maintain alloy(s) materials 409 in a substantially (mostly) molten (liquid) or the like format. In some embodiments, heating means 425 may be in operative communication with melt furnace and/or an alloy reservoir 408, alloy(s) materials 409, and/or flowline 410. In some embodiments, heating means 425 may be configured to heat melt furnace and/or an alloy reservoir 408, alloy(s) materials 409, and/or flowline 410. In some embodiments, heating means 425 may be configured to maintain alloy(s) materials 409 in a substantially (mostly) molten (liquid) or the like format. In some embodiments, heating means 425 may use conductive heat transfer means, convective heat transfer means, and/or radiation as a heat transfer means. In some embodiments, heating means 425 may use resistive heating element(s), magnetic induction, and/or IR (infrared) emission.

Continuing discussing FIG. 4A, in some embodiments, melt furnace and/or an alloy reservoir 408 may be a container that is configured to house, hold, and/or retain a predetermined volume of molten composition 409 and/or to maintain a predetermined volume of molten composition 409 in a molten, melted, and/or liquid state. In some embodiments, the predetermined volume of reservoir 408 may be of a volume sufficient to fill volume 433 of die (mold) 413. In some embodiments, melt furnace and/or an alloy reservoir 408 may be configured to house (hold) medium 409, with or without neutron absorber(s) additives. In some embodiments, reservoir 408 may be operatively connected to a heating means 425 for heating reservoir 408 to maintain molten composition 409 in its molten, melted, and/or liquid state. In some embodiments, melt furnace and/or an alloy reservoir 408 may be operatively fitted with one or more heaters 425. In some embodiments, heating means or heaters 425 may be one or more of: electric resistive heaters, inductive heaters, combustion-based heaters, laser-based heaters, plasma-based heaters, a portion thereof, combinations thereof, and/or the like. In some embodiments, during gravity fed operations of system 400 and/or of gravity fed components, melt medium 409 may be maintained in a molten, liquid, and/or fluid state within melt furnace and/or reservoir 408. In some embodiments, melt furnace and/or an alloy reservoir 408 may be heated to melt and/or liquify medium 409 within melt furnace and/or an alloy reservoir 408. In some embodiments, at least some liquid (molten) medium 409 may flow from reservoir 408 and into closed die (mold) 413 via at least one: flowline 410, feed port 406, portions thereof, combinations thereof, and/or the like. See e.g., FIG. 4A.

Continuing discussing FIG. 4A, in some embodiments, melt furnace and/or an alloy reservoir 408 may be operatively and physically connected (linked) to die (mold) 413 and/or to volume 433 via a flowline 410 and/or via a feed port 406. In some embodiments, flowline 410 and/or feed port 406 may be disposed between reservoir 408 and die (mold) 413. In some embodiments, flowline 410 and/or feed port 406 may run from reservoir 408 to die (mold) 413. In some embodiments, flowline 410 and/or feed port 406 may be configured to permit melt 409 from reservoir 408 to be gravity fed into volume 433 of die (mold) 413. In some embodiments, flowline 410 and/or feed port 406 may be piping, pipes, conduit, spruces, defined fluid pathways, a portion thereof, combinations thereof, and/or the like that are configured to transport melt 409 from reservoir 408 and into volume 433 of die (mold) 413. In some embodiments, flowline 410 may be a completely or partially enclosed fluid path, as in a pipe or conduit from melt furnace and/or an alloy reservoir 408 to feed port 406 (and/or to die (mold) 413); and flowline 410 is configured to facilitate movement of at least some liquid (molten) medium 409. In some embodiments, feed port feed port 406 may be a completely enclosed fluid path, as in a pipe or conduit for facilitating movement of liquid (molten) medium 409 and leading into (closed) die (mold) 413 (and/or into volume 433). In some embodiments, flowline 410 and/or feed port 406 may be heated to help melt 409 be (and/or stay) in a molten state. In some embodiments, flowline 410 and/or feed port 406 may be insulated to reduce heat loss and/or premature cooling. In some embodiments, reservoir 408 may comprise flowline 410. See e.g., FIG. 4A.

Continuing discussing FIG. 4A, in some embodiments, flowline 410 may be a means for facilitating movement (flow) of alloy material 409 (which may be in a melted and/or liquid format) from melt furnace and/or an alloy reservoir 408 and into volume 433 of die (mold) 413. In some embodiments, flowline 410 may be configured to permit and/or to facilitate transport (flow) of alloy material 409 (which may be in a melted and/or liquid format) from melt furnace and/or an alloy reservoir 408 and into volume 433 of die (mold) 413. In some embodiments, flowline 410 may be a sluice, piping, a pipe, a conduit, a spruce, a defined fluid pathway, a portion thereof, combinations thereof, and/or the like. In some embodiments, flowline 410 may be entirely covered or only partially covered. In some embodiments, flowline 410 may disposed between melt furnace and/or an alloy reservoir 408 and die (mold) 413. In some embodiments, flowline 410 may be operatively connected to both melt furnace and/or an alloy reservoir 408 and to die (mold) 413.

Continuing discussing FIG. 4A, in some embodiments, feed port 406 may be a port and/or a valve (gate) that permits alloy material 409 (which may be in a melted and/or liquid format) to enter (flow) into volume 433 of die (mold) 413. In some embodiments, feed port 406 may be configured to permit and/or to facilitate alloy material 409 (which may be in a melted and/or liquid format) to enter (flow) into volume 433 of die (mold) 413. In some embodiments, flowline 410 may be a port, a valve, a gate, and/or the like. In some embodiments, flowline 410 may disposed between flowline 410 and die (mold) 413; or in some embodiments, feed port 406 may be considered a distal terminal end of flowline 410 that is closest to die (mold) 413 (and furthest from melt furnace and/or an alloy reservoir 408). In some embodiments, feed port 406 may be operatively connected to both flowline 410 and to die (mold) 413.

Continuing discussing FIG. 4A, in some embodiments, controller 419 may be a controller that is configured to control system 400 or a portion thereof. In some embodiments, controller 419 may be configured to operate, control, manage, monitor, open, close, start, stop, run, speed up, slow down, pause, heat, cool, and/or the like at least one of: die (mold) 413, melt furnace and/or alloy reservoir 408, flowline 410, feed port 406, heating means 425, handler 427, cooling bath 429, outlet port (vent) 418, gas source 420, gas line 421, combinations thereof, and/or the like. In some embodiments, controller 419 may be operatively connected to at least one of: system 400, die (mold) 413, melt furnace and/or alloy reservoir 408, flowline 410, feed port 406, heating means 425, handler 427, cooling bath 429, outlet port (vent) 418, gas source 420, gas line 421, a valve, a gate, a control valve, a solenoid valve, hydraulics, pressure regulator, material handler, a sensor, a thermocouple, a thermometer, a pressure indicator, portions thereof, combinations thereof, and/or the like. In some embodiments, any such hydraulics or the like may be opening and/or closing die (mold) 413 and/or for removing integral encapsulated unit 500 from support(s) 417; but, not for feeding molten materials 409 into die (mold) 413, since that is done via gravity feed. In some embodiments, the operative connection (between controller 419 and an element being controlled) may be wired and/or wireless. In some embodiments, established controller 419 may comprise at least one of: a computer, computer memory, computer storage, a screen and/or a display, a PLC (programmable logic controller), a sensor, input/output (I/O) means, an antenna, a receiver, a transmitter, a radio, a monitor, a meter, a gauge, a level sensor, an optical sensor, a PIR sensor, a motion sensor, a pressure sensor, an acoustic sensor, an accelerometer, a button, a switch, a membrane switch, a dial, a slide, a lever, non-transitorily stored control software, portions thereof, combinations thereof, and/or the like.

Continuing discussing FIG. 4A, in some embodiments, at least some of gravity fed components and/or apparatus may be located vertically above die (mold) 413. In some embodiments, at least most of melt furnace and/or reservoir 408 may be located at a level vertically above a top level of die (mold) 413. In some embodiments, the melt reservoir 408 may be vertically elevated, with respect to die (mold) 413, to provide a higher (greater [larger]) hydraulic head and/or increased flow rate of the melt 409 into volume 433 of die (mold) 413.

Continuing discussing FIG. 4A, in some embodiments, die (mold) 413 may comprise a vent 418 and/or a means to be locally open to the atmosphere when so desired. In some embodiments, vent 418 may be located in an upper and/or a top portion (region) of die (mold) 413. In some embodiments, when vent 418 may be open, a vacuum (and/or negative pressure) may be prevented from setting up within reservoir 408, which in turn may facilitate the gravity fed flow of melt 409 out from reservoir 408 and into volume 433 of die (mold) 413. In some embodiments, when vent 418 may be open, at least some gasses within volume 433 of die (mold) 413 may be vented out from volume 433 of die (mold) 413. In some embodiments, gravity diecasting system 400 and/or die (mold) 413 may comprise an outlet port 418. In some embodiments, outlet port 418 may be configured to bleed off excess gas and/or liquid (molten) medium 409 from closed die (mold) 413. In some embodiments, outlet port 418 may be pressure activated and/or high liquid level activated. In some embodiments, outlet port 418 may be operatively and/or physically connected to die (mold) 413.

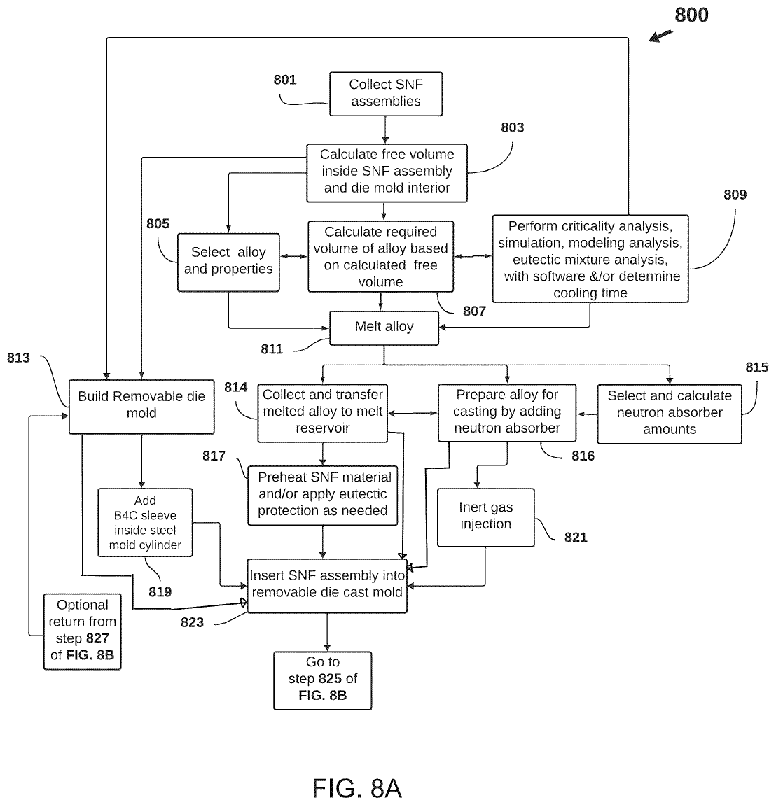

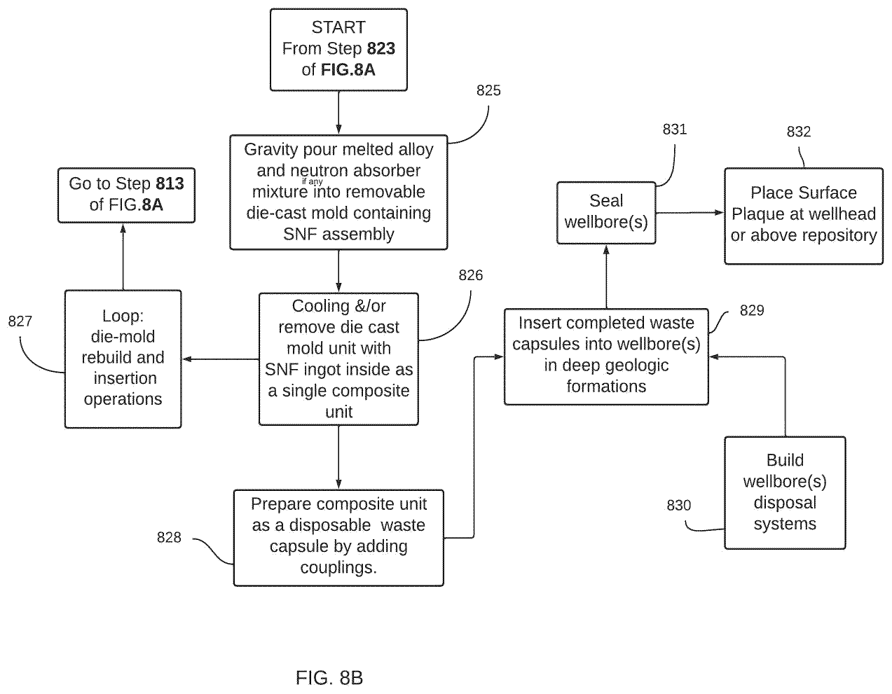

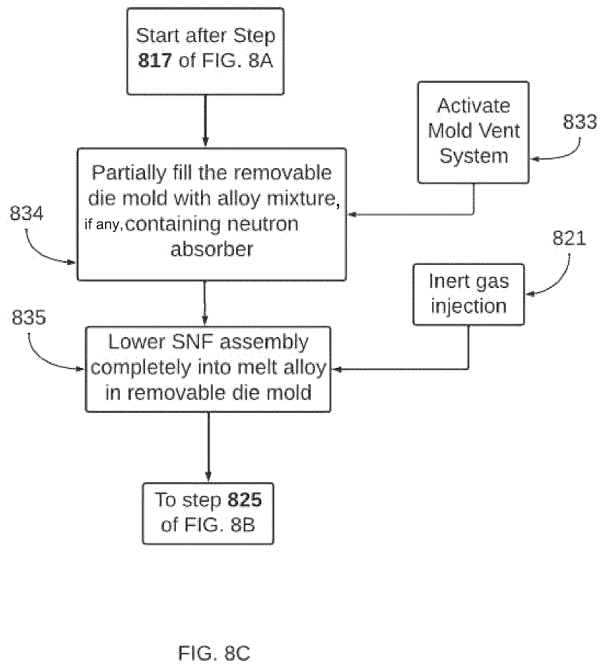

Continuing discussing FIG. 4A, in some embodiments, a gas within gas source 420 (e.g., gas cylinder(s)) may be an inert gas with respect to medium liquid (and/or molten) medium 409. In some embodiments, a gas within gas source 420 may be nitrogen, argon, portions thereof, combinations thereof, and/or the like. In some embodiments, gas line 421 may fluidly link a given gas source 420 to (an interior of) mold 413. In some embodiments, gas line 421 may be a tube, tubing, a pipe, piping, a portion thereof, combinations thereof, and/or the like (that is completely enclosed along its length). In some embodiments, gas line 421 may provide a fluid (gas) pathway from gas source 420 to (an interior of) mold 413. In some embodiments, gas source 420 and/or gas line 421 may enable and/or support a step 821 of method 800 (see e.g., FIG. 8A and its below discussion).

Continuing discussing FIG. 4A, in some embodiments, gas line 421 may be a connector tube for the transfer of an inert gas, purge gas, and/or exhaust gas, wherein the inert gas may be used in the initial stage of the loading process of the die (mold) 413. In some embodiments, gas source 420 may be a gas reservoir (cylinder) to hold the inert gas which may be purged from the die (mold) 413 during gravity feeding operations. Inert gases may be used in gravity die-casting operations to minimize oxidation and improve the casting quality. At least one primary purpose of using inert gases may be to create a protective atmosphere within the die (mold) 413 during the gravity fed die casting process. Typically, an inert gas such as, but not limited to, nitrogen and/or argon is introduced into the volume 433 of die (mold) 413 prior to the gravity feeding of molten material(s) 409. In some embodiments, this inert gas may help in several ways, such as, but not limited to: (1) oxidation prevention (mitigation [minimization]); (2); heat removal; (3) porosity reduction; (4) surface finish enhancement; portions thereof; combinations thereof; and/or the like. With respect to oxidation prevention (mitigation [minimization]), inert gases may create (form) a barrier between the molten metal 409 and the surrounding air, minimizing or preventing oxidation of the alloy(s) mixture 415. Oxidation can degrade the quality of the casting within integral encapsulated unit 500 and affect mechanical properties of the casting. With respect to heat removal, inert gases aid in a quicker cooling and re-solidification of the molten material 409 into resolidified alloy(s) mixture 415, reducing cycle times and improving productivity. The inert gas helps in extracting heat from the die (mold) 413, promoting re-solidification and maintaining dimensional accuracy. Use of the inert gas into volume 433 of die (mold) 413 may be done before, during, and after the gravity feeding process (operation). With respect to porosity reduction, the use of inert gases can help reduce the formation of gas porosity within the castings. By displacing air and/or other gases from volume 433 of die (mold) 413, inert gases minimize the likelihood of gas entrapment in the molten material 409 (and the resolidified alloy(s) mixture 415), resulting in improved structural integrity of the resulting castings. A specific choice of inert gas and its application may vary depending on particulars of the given gravity fed die casting process, the type of metal(s) (alloy(s)) being cast, and other well-known factors in the relevant art of metal/alloy diecasting. However, the general objective is to create a controlled environment within volume 433 of die (mold) 413 to enhance the quality from resulting casting and/or to reduce defects within the resulting casting.

However, in some embodiments, some or all of the beneficial features of the use of inert gases with respect to a given die (mold) 413, may not be necessary in various applications of embodiments taught in this patent application since the end product, i.e., integral encapsulated unit 500, may not be consumer nor industrial items of specific required look, feel, and/or quality, but rather items that are destined for deep underground burial encapsulated in a deep horizontal wellbore (and/or human-made cavern). That is, some embodiments, of gravity fed diecasting system 400 and/or of methods utilizing gravity fed diecasting system 400 may not use such inert gases.

Continuing discussing FIG. 4A, in some embodiments, handler 427 may be configured for (automatically) loading a given SNF assembly (or portion thereof) 412 into an open die (mold) 413; unloading and/or extracting a newly formed integral encapsulated unit 500 from support(s) 417; moving a newly unloaded and/or extracted integral encapsulated unit 500 from support(s) 417 and to cooling bath 429; moving a now cooled integral encapsulated unit 500 from out of cooling bath 429; portions thereof; combinations thereof; and/or the like. In some embodiments, handler 427 may be at least one robotic handler. In some embodiments, handler 427 may be at least one robot. In some embodiments, handler 427 may be at least one robotic arm. In some embodiments, handler 427 may be remotely operated by a human, a computer, a controller (e.g., controller 419), and/or an AI (artificial intelligence) operator; and/or handler 427 may be programmed to operate autonomously. In some embodiments, distal terminal end(s) of robotic handler 427 may comprise at least one of: a suction means for picking up and/or holding SNF assembly (or portion thereof) 412 and/or integral encapsulated unit 500; physical manipulator(s) (e.g., claw, hand, grabber, and/or the like) for picking up and/or holding SNF assembly (or portion thereof) 412 and/or integral encapsulated unit 500; portions thereof; combinations thereof; and/or the like. In some embodiments, handler 427 may be configured to move die (mold) 413 in and/or out of support(s) 417.

In some embodiments, (robotic) handler 427 may be a component of an ejection (unloading and/or extraction) means. In some embodiments, the ejection means may be configured for unloading, ejecting, and/or extracting a newly formed integral encapsulated unit 500 from support(s) 417. In some embodiments, the ejection means may comprise (robotic) handler 427 and/or the like. Prior art teachings of industrial machines for moving, transporting, and/or handling heavy objects, like integral encapsulated unit 500, are incorporated by reference herein.

Continuing discussing FIG. 4A, in some embodiments, cooling bath 429 may be configured to cool and/or quench integral encapsulated unit 500. In some embodiments, cooling bath 429 may be configured to more quickly lower temperatures of integral encapsulated unit 500 once integral encapsulated unit 500 is removed from at least part of the die cast system (e.g., from support(s) 417). In some embodiments, cooling bath 429 may be at least partially filled with a cooling medium, such as, but limited to, a predetermined liquid and/or a predetermined fluid. In some embodiments, cooling bath 429 may be at least partially filled with water, oil, additives, portions thereof, combinations thereof, and/or the like.

Continuing discussing FIG. 4A, in some embodiments, gravity fed diecasting system 400 may additionally comprise (a predetermined volume of) neutron absorber material 435. In this patent application, a typical neutron absorber (such as, neutron absorber material 435) may be boron carbide (B₄C) which can be utilized as a powder and/or as fine particles. This powder (particles) is commercially available in sizes down to particles of five (5) microns (plus or minus 2 microns)—which is (significantly) smaller than the void spaces 301. This boron carbide (B₄C) neutron absorber powder may be blended with the melted alloy 409 since its melting point (2,445 degrees Celsius [° C.]) is much higher than the contemplated melt alloy copper 409 (which may be around 1,084 degrees Celsius [C] or so). In some embodiments, boron carbide (B₄C) when combined with the melt alloy 409 may form a continuous mix, that when introduced into volume 433 of the die (mold) 413, may provide neutron absorbing ability to the resolidified alloy(s) mixture 415 of a given integral encapsulated unit 500. Boron carbide (B₄C) acts as a neutron absorber, reducing the neutron flux and minimizing the risk of criticality, which refers to an uncontrolled nuclear chain reaction. In some embodiments, inclusion of one or more neutron absorber(s) into the melt alloy 409 may be important for increased and/or better safe handling and storage of spent nuclear fuel (SNF) and/or other radioactive waste materials. See e.g., FIG. 4A for neutron absorber material 435.

Continuing discussing FIG. 4A, in some embodiments, gravity fed diecasting system 400 may comprise support(s) 417. In some embodiments, support 417 may be a structural member. In some embodiments, support 417 may be an engineered structural member. In some embodiments, a given die (mold) 413 and/or a given integral encapsulated unit 500 may be (removably) supported by support(s) 417. In some embodiments, the support(s) 417 may be configured to support the diecast mold 413 and/or the at least one integral encapsulated unit 500. In some embodiments, the diecast mold 413 and/or the at least one integral encapsulated unit 500 are removable from the supports support(s) 417. In some embodiments, the support(s) 417 may be configured for (physically) supporting the integral encapsulated unit 500 before it (i.e., the integral encapsulated unit 500) is removed from the support(s) 417. In some embodiments, support(s) 417 may be configured to physically and/or structurally support at least one of: die (mold) 413; die (mold) 413 when houses a given SNF assembly (or portion thereof) 412; when die (mold) 413 may hold molten material 409 (and/or alloy(s) material 415); when die (mold) 413 may house a given casting (ingot); integral encapsulated unit 500; a portion thereof; combinations thereof; and/or the like. In some embodiments, support(s) 417 may be removably operatively connected to an exterior of die (mold) 413. In some embodiments, support(s) 417 may be removably attached to an exterior of die (mold) 413. In some embodiments, support(s) 417 may be to keep die (mold) 413 in a particular configuration (e.g., vertically upright) during gravity fed operations. In some embodiments, support(s) 417 may not be permanently attached to the exterior of die (mold) 413 (nor to integral encapsulated unit 500).

Continuing discussing FIG. 4A, in some embodiments, gravity fed diecasting system 400 may comprise base 416. In some embodiments, base 416 may be a structural member. In some embodiments, base 416 may be an engineered structural member. In some embodiments, support(s) 417 may rest on top of base 416. In some embodiments, support(s) 417 may be attached to base 416. In some embodiments, die (mold) 413 may removably rest on top of base 416. In some embodiments, base 416 may be configured to physically and/or structurally support a load (weight) at least one of: support(s) 417; die (mold) 413; die (mold) 413 when houses a given SNF assembly (or portion thereof) 412; when die (mold) 413 may hold molten material 409 (and/or alloy(s) material 415); when die (mold) 413 may house a given casting (ingot); integral encapsulated unit 500; a portion thereof; combinations thereof; and/or the like.

In some embodiments, gravity fed diecast molding system 400 may additionally comprise radiation shielding components, parts, and/or structures.

FIG. 4B may be a schematic view showing two main steps of an embodiment of a gravity fed diecast molding system 400 for generating (producing and/or outputting) integral encapsulated units 500, wherein a given integral encapsulated unit 500 may comprise a die (mold) 413 containing at least one SNF assembly (or portion thereof) 412 located and positionally fixed within that given die (mold) 413; and wherein disposed between the SNF assembly (or portion thereof) 412 and the die (mold) 413 is re-solidified alloy material (mixture) 415. Further, FIG. 4B shows an embodiment wherein the given die (mold) 413 volume 433 may be initially only partially filled with the molten material(s) 409, indicated by reference numeral 409a in FIG. 4B, before the SNF assembly (or portion thereof) 412 is inserted into that same die (mold) 413; then fully loading (inserting) the SNF assembly (or portion thereof) 412 into that partially filled volume 409a, within that given die (mold) 413; and then completing filling of the molten material(s) 409 into volume 433 until at least all of the fully inserted the SNF assembly (or portion thereof) 412 is entirely covered with the molten material(s) 409 (see e.g., step-B in FIG. 4B). In FIG. 4B reference numeral 437 indicates a direction of inserting (loading) the SNF assembly (or portion thereof) 412 into that partially filled volume 409a of the molten material(s) 409, within that given die (mold) 413. Additionally, FIG. 4B shows use of a vent hood 436, in some embodiments, that may be removably attached to a top (upper) portion of die (mold) 413 to capture and/or treat off gassing, vapors, smoke, airborne particulate matter, volatile organic compounds (VOCs), volatile inorganic compounds, splashing, combinations thereof, and/or the like that may result from: only partially filling volume 433 with the molten material(s) 409, before insertion of the SNF assembly (or portion thereof) 412; and/or from inserting the SNF assembly (or portion thereof) 412 into the partially filled volume 409a of molten material(s) 409 in die (mold) 413. In some embodiments, vent hood 436 may be configured to capture, retain, filter, and/or treat off gassing, vapors, smoke, airborne particulate matter, volatile organic compounds (VOCs), volatile inorganic compounds, splashing, combinations thereof, and/or the like. In some embodiments, vent hood 436 may be operatively connected to vent 418.

FIG. 5A is a lengthwise cross-sectional diagram through a given integral encapsulated unit 500 that was output from gravity diecasting system 400 (see also, FIG. 8A and FIG. 8B of method 800 that may comprise steps of making a given integral encapsulated unit 500). Also note, SNF assembly (or a portion thereof) 412 in FIG. 5A (and in FIG. 5B) is now shown with a reference numeral of “512” instead of “412” to emphasize that once integral encapsulated unit 500 is formed, that SNF assembly (or a portion thereof) 412 has been modified such that its prior (formerly) free void spaces 301 are now no longer free void spaces 301 but are now instead occupied by the resolidified metal(s) and/or alloy(s) 415 (which may or may not include neutron absorber(s) 435). In some embodiments, a given integral encapsulated unit 500 may comprise: at least one closed die (mold) 413; at least one SNF (or portion thereof) 412 (located within the die [mold] 413) (which may be modified SNF assembly (or portion thereof) 512); and resolidified alloy(s) material(s) 415 (located within the die [mold] 413 and around the SNF (or portion thereof) 412 and filling in any former void spaces within volume 433 of that die [mold] 413). Exterior surface 501 is an exterior surface of integral encapsulated unit 500 (which is also an exterior of removed die [mold] 413). In some embodiments, FIG. 5A shows at least substantially (mostly) all of volume 433 within integral encapsulated unit 500 is of the resolidified metal(s) and/or alloy(s) 415, aside from where SNF assembly (or a portion thereof) 412 is occupying volume 433. This FIG. 5A cross-section shows the integral encapsulated unit 500 and the relationship between the resolidified alloy (metal) 415, which surrounds the modified SNF assembly (or portion thereof) 512. In some embodiments, the resolidified alloy (metal) 415 forms a solid metal protective “cocoon” around that modified SNF assembly (or portion thereof) 512. Recall, in some embodiments, this resolidified metal(s) and/or alloy(s) 415 of a given integral encapsulated unit 500, may also contain (comprise) dispersed neutron absorber material(s) 435 within the resolidified metal(s) and/or alloy(s) 415. Note, FIG. 5A includes sectional line 5B-5B, whose cross-section is shown in FIG. 5B. FIG. 5A shows a central axis line 599.

FIG. 5A also demonstrates an optional embodiment where two or more distinct groups of HLW may be embedded within a given integral encapsulated unit (composite unit) 500, but separated from each other within that integral encapsulated unit 500 by a separator 521. In some embodiments, the two or more distinct groups of HLW could be for example two or more distinct SNF assemblies (or portions thereof) 412 that are each separated from each other in their shared integral encapsulated unit 500 by separator 521. This may be accomplished by placing a first of the waste groupings within the given die (mold) 413, then placing a separator 521 within that same die (mold) 413 and on top of the already placed first waste group, and then placing a next waste group upon that placed separator 521, and then so on in this fashion (if desired), with a separate (distinct) separator 521 separating each distinct waste group within that given die (mold) 413. In some embodiments, separator 521 may be metal and/or alloy(s) disk (disk) sheet of material, that may be borated steel in some embodiments and/or may have neutron absorbing and/or shielding functionality. In some embodiments, separator 521 may be perforated to permit flow of molten material 409 through and/or around an emplaced separator 521 within a given die (mold) 413.

FIG. 5B is a transverse width cross-sectional diagram taken through sectional line 5B-5B of FIG. 5A. FIG. 5B is a transverse width cross-sectional diagram taken through a middle portion (with respect to a length) of a given integral encapsulated unit 500 that was output from diecasting gravity feed molding system 400 and/or from method 800 (see FIG. 8A and FIG. 8B for method 800). In some embodiments, FIG. 5B shows at least substantially (mostly) all of volume 433 within an exterior surface 501 of integral encapsulated unit 500 is of the resolidified metal(s) and/or alloy(s) 415, aside from where modified SNF assembly (or portion thereof) 512 occupies that volume 433. This FIG. 5B cross-section shows the integral encapsulated unit 500 and the relationship between the resolidified alloy (metal) 415, which surrounds the modified SNF assembly (or portion thereof) 512. In some embodiments, the resolidified alloy (metal) 415 forms a solid metal protective “cocoon” around that modified SNF assembly (or portion thereof) 512. Also shown in FIG. 5B, may be a minimum thickness 503 of integral encapsulated unit 500 from exterior surface 501 until an exterior structure of modified SNF assembly (or portion thereof) 512 located within that given integral encapsulated unit 500. In some embodiments, thickness 503 of integral encapsulated unit 500 may be at least one (1.5) inches, plus or minus one-half (0.5) inch.

FIG. 5C is a partial perspective (isometric) view of a given integral encapsulated unit 500 that was output from diecasting gravity injection molding system 400 and/or from method 800 (see FIG. 8A and FIG. 8B for method 800). Recall, integral encapsulated unit 500 may internally hold at least one modified SNF assembly (or portion thereof) 512 (see e.g., FIG. 4A, FIG. 5A, and FIG. 5B). FIG. 5C shows portions of exterior surface 501 of integral encapsulated unit 500. FIG. 5C shows exterior surface 501 may have a smooth, polished, and/or machined finish in some embodiments; however, exterior surface 501 may have other surface geometry depending upon the exterior surface quality of the die (mold) 413. In some embodiments, integral encapsulated unit 500 may be handled easily by (robotic) handler 427. In some embodiments, integral encapsulated unit 500 may be handled easily by existing material handling machinery developed and used for handling and transporting heavy solid cylindrical goods in industry today (such as, but not limited to, mobile traveling cranes, gantry cranes, and/or the like). In some embodiments, (robotic) handler 427, and/or preexisting material handling machinery may be configured to handle loads of 1,000 to 20,000 pounds. In some embodiments, (robotic) handler 427 may comprise preexisting material handling machinery that may be configured to handle loads of 1,000 to 20,000 pounds; and any such preexisting material handling machinery is incorporated by reference. In some embodiments, a given integral encapsulated unit 500 may weigh from 1,000 to 20,000 pounds. Material handling operations of integral encapsulated unit 500 may not require any additional experimentation or development, aside from including radiation shielding where desired and/or needed to protect personnel and/or equipment/machinery from radiation.

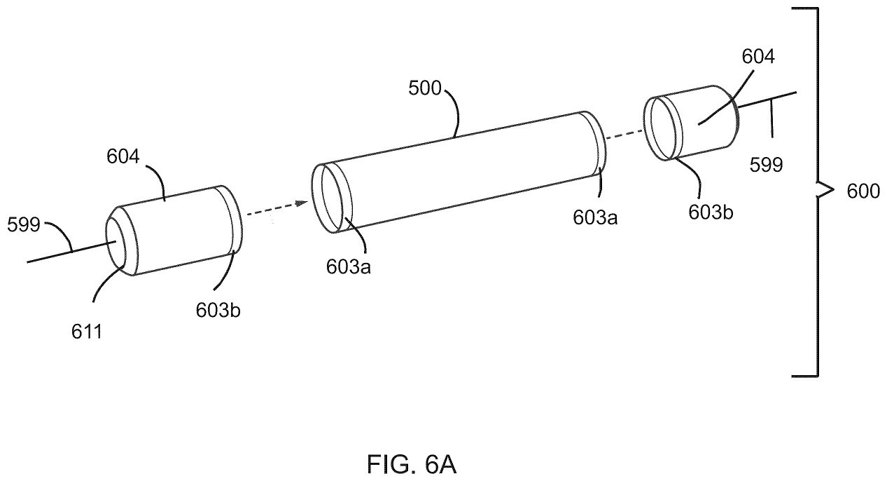

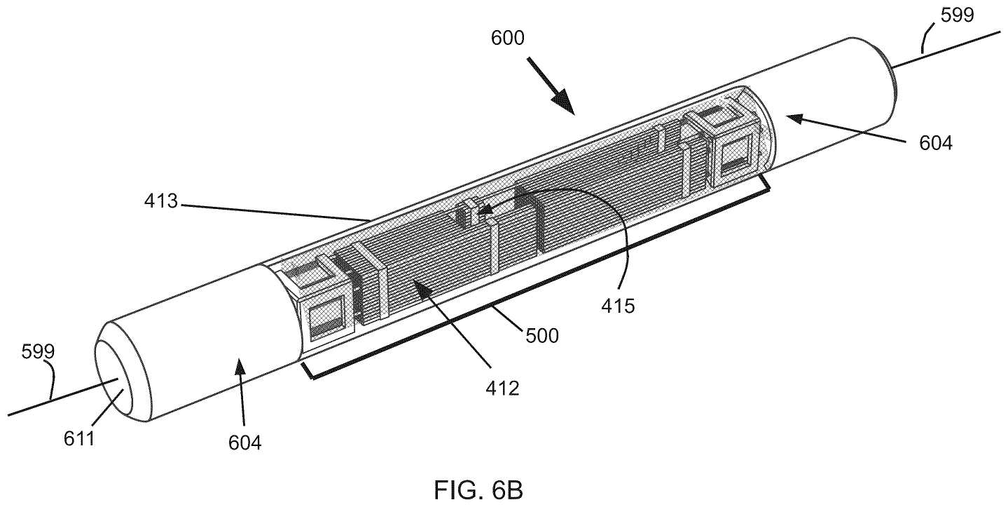

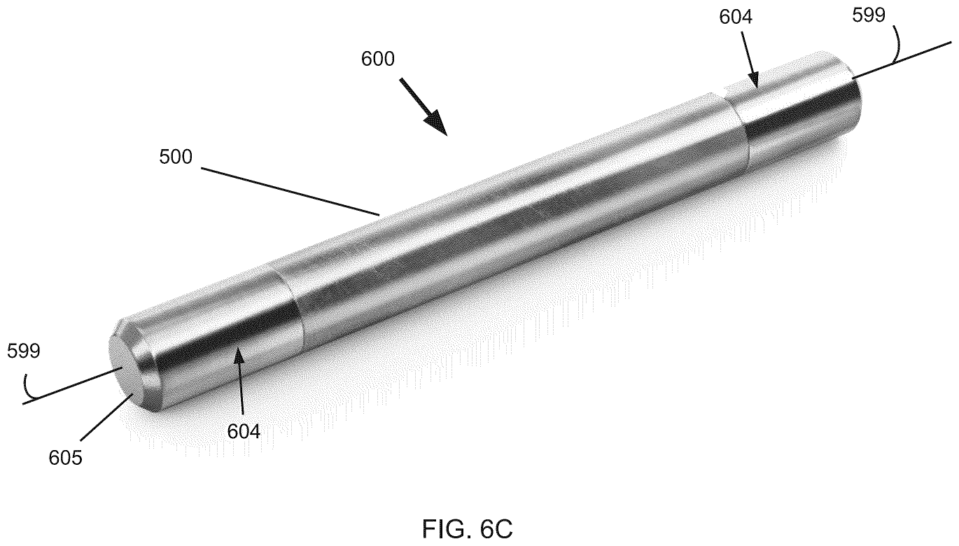

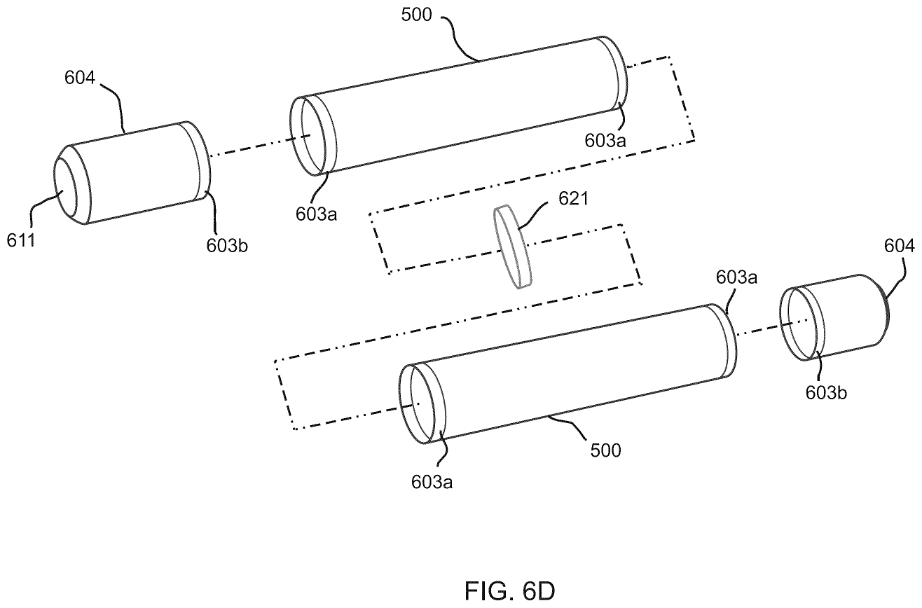

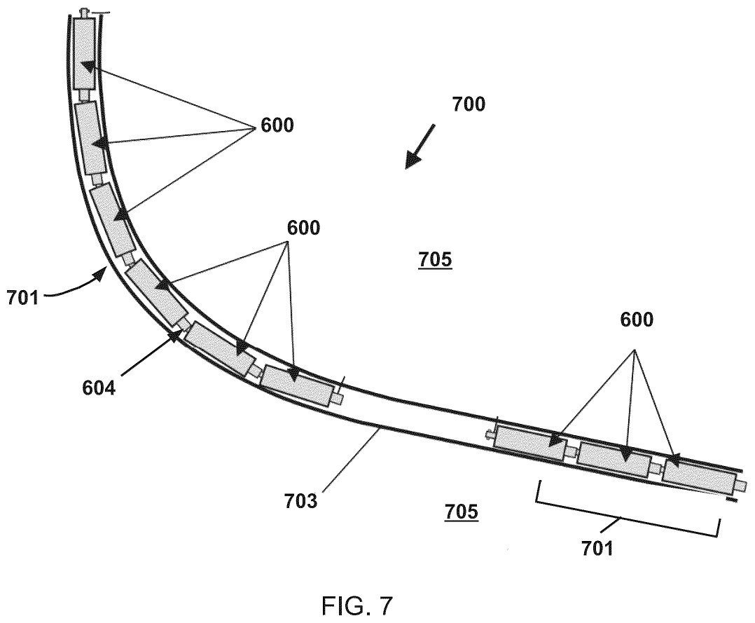

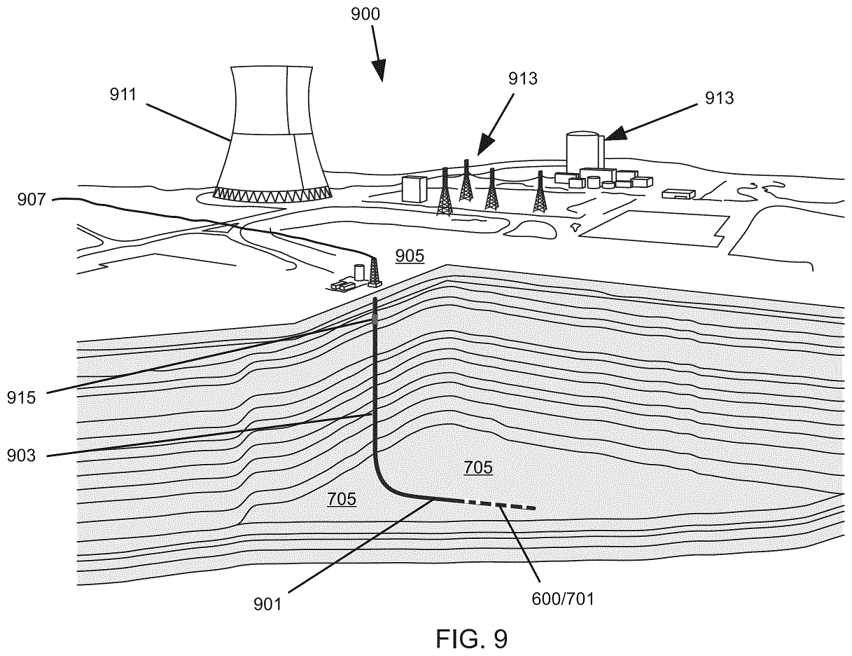

FIG. 6A depicts an exploded (dissembled) perspective view of a given disposal waste capsule 600 that is made from (formed from and/or converted from) a given integral encapsulated unit 500. In some embodiments, a given disposal waste capsule 600 may be configured for movement through and within: wellbore(s) 703, horizontal (lateral) wellbore(s) 901, vertical wellbore(s) 903, a portion thereof, combinations thereof, and/or the like (see e.g., FIG. 7 for wellbore 703 and see FIG. 9 for horizontal (lateral) wellbore 901 and for vertical wellbore 903). Continuing discussing FIG. 6A, in some embodiments, a given disposal waste capsule 600 may be configured for manipulation and/or handling by handler 427, drilling rig 907, crane, gantry crane, combinations thereof, and/or the like. (see e.g., FIG. 4A for handler 427 and see FIG. 9 for drilling rig 907). In some embodiments, to make (form and/or convert) a given disposal waste capsule 600 from a given integral encapsulated unit 500, a single coupling 604 is attached to each longitudinally opposing terminal end of integral encapsulated unit 500. In some embodiments, a given disposal waste capsule 600 may comprise: at least one integral encapsulated unit 500 and two couplings 604. In some embodiments, with respect to a given disposal waste capsule 600, the two couplings 604 are disposed opposite from each other, with the at least one integral encapsulated unit 500 being located between those two couplings 604. In some embodiments, disposal waste capsule 600 may be formed from a loaded die (mold) 413 in the integral encapsulated unit 500 configuration. In some embodiments, the two opposing open terminal ends of a given disposal waste capsule 600 may be formed by attaching one coupling 604 to each such terminal end of a given integral encapsulated unit 500. A variety of well-known and currently available mechanical means may be used to attach a coupling 604 to a given terminal end of a given integral encapsulated unit 500.

Continuing discussing FIG. 6A, in some embodiments, each opposing terminal end of integral encapsulated unit 500 may comprise an attachment-means 603a. Similarly, in some embodiments, each coupling 604 may comprise a complementary attachment-means 603b. In some embodiments, attachment-means 603a may be configured for attachment to complementary attachment-means 603b. In some embodiments, attachment-means 603a may be male threading; and complementary attachment-means 603b may be female threading (or vice-versa). In some embodiments, a physical interaction between attachment-means 603a and complementary attachment-means 603b may be selected from one or more of: a threaded connection, a welded connection, a press fit connection, a frictional connection, a riveted connection, a connection using one or more mechanical fasteners, a crimped connection, a connection using glue, a connection using an adhesive, a connection using an epoxy, a portion thereof, combinations thereof, and/or the like. In some embodiments, the connection between attachment-means 603a and complementary attachment-means 603b may be intended to be permanent or removable.

Continuing discussing FIG. 6A, in some embodiments, attachment-means 603a may be formed on the exterior opposing distal terminal ends of die (mold) 413 and/or on the exterior radial surface of the endcap(s) 411 by machining operations on the exterior surface of the distal terminal ends of die (mold) 413 and/or upon the exterior radial surface of the endcap(s) 411. In some embodiments, attachment-means 603a may be formed on the exterior opposing distal terminal ends of die (mold) 413 (and/or on the radial surfaces of the endcap(s) 411) according to at least one of: before die (mold) 413 is placed into support(s) 417; while die (mold) 413 is in support(s) 417; after integral encapsulated unit 500 has been removed from support(s) 417; before disposal waste capsule 600 is attached to another (different) disposal waste capsule 600; before integral encapsulated unit 500 (and/or disposal waste capsule 600) is placed within a wellbore; combinations thereof; and/or the like. Thus, in some embodiments, attachment-means 603a may be present in FIG. 4A, FIG. 5A, FIG. 5B, FIG. 5C, FIG. 6B, FIG. 6C, FIG. 7, and/or FIG. 9.

In some embodiments, a given coupling 604 may have a coupling function, that permits one given coupling 604 to removably attach to another (different/other) coupling 604. In this way, two or more (different) disposal waste capsules 600, arranged end-to-end, lengthwise, may be removably attached to each other to form a string 701 (see e.g., FIG. 7 for string 701). In some embodiments, the coupling function of a given coupling 604 may be provided by attachment-means 605 (see e.g., FIG. 6C for attachment-means 605). With respect to a given coupling 604, attachment-means 605 may be disposed opposite from complementary attachment-means 603b. In FIG. 6A the attachment-means 605 may be temporarily covered over by removable protective cap 611. In some embodiments, removable protective cap 611 may be removably attached to and/or configured to removably cover over attachment-means 605. In some embodiments, removable protective cap 611 may be configured to protected attachment-means 605 until attachment-means 605 are ready to be used, in which case, then removable protective cap 611 may be removed. In some embodiments, attachment-means 605 may enable formations of string 701. In some embodiments, attachment-means 605 may form threaded connections with other attachment-means 605 of other couplings 604.

FIG. 6B shows a perspective view of a given disposal waste capsule 600 in an intended assembled configuration, with a portion of it's integral encapsulated unit 500 section shown as transparent (or cutaway). The cutaway (or transparent) section of FIG. 6B shows that an exterior longitudinal surface section of integral encapsulated unit 500 may be the die (mold) 413, with the modified SNF assembly (or portion thereof) 512 located within that die (mold) 413, and further with the resolidified alloy(s) material(s) 415 also being located within that die (mold) 413 (and permeating any former void spaces 301 within that modified SNF assembly [or portion thereof] 512).

Because of length limitations and handling ease, in some embodiments, waste disposal capsule 600 may be comprised of and/or configured to house only one (1) integral encapsulated unit 500 containing a single modified SNF assembly 512 (and that contains the alloy(s) material 415 that surrounds that modified SNF assembly 512 within that integral encapsulated unit 500). A given SNF assembly, such as, but not limited to SNF 412, has a fixed (finite) length that is often selected from a range of from twelve (12) feet (ft) in length to fourteen (14) ft in length; which thus, provides an estimate of a fully configured waste disposal capsule 600 to have a fixed (finite) total length selected from fifteen (15) ft to twenty (20) ft, when the entire SNF assembly 412 (instead of a portion thereof) is used within the die (mold) 413 during the gravity fed operations.

FIG. 6C shows a perspective view of a given disposal waste capsule 600 in an intended assembled configuration. FIG. 6C shows the external appearance of a completed (assembled) disposal waste capsule 600 according to at least one embodiment. In some embodiments, each coupling 604 may contain exterior geometry and/or structure (e.g., attachment-means 605) that is configured to permit two different disposal waste capsules 600 to be (removably) connected to each other, in an end-to-end fashion such as is shown in FIG. 7, to yield a “string” of two or more (removably) connected waste disposal capsules 600. Note such exterior geometry and/or structure (e.g., attachment-means 605) that permits such strings 701 is well known in the oil field development industries, wherein such technology is incorporated by reference as if fully set forth herein. In some embodiments, two or more disposal waste capsules 600 may be connected linearly by their abutting different couplings 604 together (using two different abutting attachment-means 605), which may allow a string 701 of as many as twenty (20) filled disposal waste capsules 600 to be connected together (in the end-to-end fashion) to allow the disposal waste capsules 600 to be sequestered rapidly as a single unit by a drill rig 907 capable of several hundred thousand pounds of lift capacity (such as, but not limited to, an oil field drill rig).

FIG. 6D depicts an exploded (dissembled) perspective view of a given disposal waste capsule 600 that is made from (formed from and/or converted from) at least two different integral encapsulated units 500. In some embodiments, waste disposal capsule 600 may be comprised of and/or configured to house two (2) integral encapsulated units 500 or fewer. In some embodiments, waste disposal capsule 600 may be comprised of and/or configured to house at least two (2) integral encapsulated units 500. In some embodiments, when two (2) or more integral encapsulated units 500 may form a given waste disposal capsule 600, those integral encapsulated units 500 may be arranged end-to-end in that given waste disposal capsule 600, such that the integral encapsulated units 500 and the waste disposal capsule 600 are (at least mostly [substantially]) concentric about a common central axis 599 and/or such that the lengths of the integral encapsulated units 500 and the waste disposal capsule 600 are all at least substantially (mostly) parallel with each other. In some embodiments, when two (2) or more integral encapsulated units 500 may form a given waste disposal capsule 600, nearest terminal ends of those integral encapsulated units 500 may be physically separated from each other by at least one plate (divider [separator]) 621. In some embodiments, between each sequential installed integral encapsulated unit 500 may be placed (disposed) at least one (1) neutron absorber plate 621. In some embodiments, plate 621 may be at least a substantially (mostly) cylindrical disc (disk) (or wafer). In some embodiments, plate 621 may be configured for neutron absorption. In some embodiments, a given separator 621 may be configured to attach one integral encapsulated unit 500 to a different integral encapsulated unit 500, in an end-to-end configuration.

FIG. 7 shows a cross-section through a section (region and/or portion) of a system 700 for disposal of waste within deeply located wellbore(s) 703. FIG. 7 shows an illustration of at least two (end-to-end) adjacent physically linked disposal waste capsules 600, which in such a configuration may form a string 701 of waste capsules 600, located inside of a given wellbore 703. Note, in some embodiments, the system 700 section (region and/or portion) shown in FIG. 7 may be a section (region and/or portion) of waste disposal repository system 900 shown more fully in FIG. 9. Continuing discussing FIG. 7, in some embodiments, at least a portion of that wellbore 703 may be located within at least one deeply located geologic formation (rock) 705. In some embodiments, any two waste capsules 600 that may be adjacently aligned end-to-end (e.g., with one terminal end of one waste capsule 600 next to one terminal end of a different waste capsule 600) may be mechanically joined (linked) together via mechanical interactions of their two closest capsule connector devices 604 (couplings 604) from each of the two different waste capsules 600. Thus, two or more waste capsules 600 may be mechanically linked together to form a string 701 of waste capsules 600. In some embodiments, such a string 701 of waste capsules 600 may be loaded, landed, inserted, and/or emplaced within a given wellbore 703 as a single unit, wherein that given wellbore 703 may extend into at least one deeply located geological formation (rock) 705. In some embodiments, via mechanically interacting capsule connector devices 604 (couplings 604), at least two non-linked, but end-to-end adjacent waste capsules 600, may be (removably) coupled (linked and/or attached) together (e.g., to form a given string 701 of waste capsules 600 or to become part of an existing string 701 of waste capsules 600). In some embodiments, at least two non-linked, but end-to-end adjacent waste capsules 600, may be coupled (linked and/or attached) together, within or outside of a given wellbore 703, to form a given string 701 of waste capsules 600 or to become part of an existing string 701 of waste capsules 600. In some embodiments, at least two linked waste capsules 600 within a given string 701 of waste capsules 600, may be readily decoupled. In some embodiments, at least two linked waste capsules 600 within a given string 701 of waste capsules 600, may be decoupled, within or outside of a given wellbore 703.

Continuing discussing FIG. 7, in some embodiments, wellbore 703 may be lined with casing(s) and/or section(s) of pipe, such as, but not limited to, steel piping, with or without concrete and/or cement located exteriorly to the piping and inside of the native rock (e.g., formation 705). In some embodiments, wellbore 703 may comprise at least substantially (mostly) vertical sections, horizontal sections (lateral sections), transitional sections (that join a vertical section to a horizontal [lateral] section), a portion thereof, combinations thereof, and/or the like. In some embodiments, the at least substantially (mostly) vertical sections, horizontal sections (lateral sections), transitional sections, a portion thereof, combinations thereof, and/or the like, of a given wellbore 703 may be operatively (and physically) connected to each other. In some embodiments, the at least substantially (mostly) vertical sections, horizontal sections (lateral sections), transitional sections, a portion thereof, combinations thereof, and/or the like, of a given wellbore 703 may be integral to each other. See also, FIG. 9.

In some embodiments, handling waste capsule(s) 600 and/or string(s) 701 of waste capsule(s) 600, within wellbore(s) 703, may be accomplished using drill rigs (such as, but not limited to, drill rig 907), downhole tools, tooling, machines, devices, apparatus, systems, methods, processes, and/or techniques of the oil field industry that are in use today and well understood. Such preexisting downhole tools, tooling, machines, devices, apparatus, systems, methods, processes, and/or techniques of the oil field industry are incorporated by reference herein as if fully set forth herein.

Also note, the waste capsules 600 in FIG. 7 need not be (removably) connected to each other for forming string(s) 701. In some embodiments, waste capsules 600 within a given wellbore 703 need not be (removably) connected to each other in the string(s) 701 configuration.

FIG. 8A and FIG. 8B are flow diagrams showing at least some steps in a method 800. In some embodiments, method 800 may be a method for one or more of the following: making dies (molds) 413; processing SNF assemblies (or portions thereof); processing SNF assemblies (or portions thereof) for long-term disposal; processing SNF assemblies (or portions thereof) to be entirely encapsulated within a metallic casting; processing SNF assemblies (or portions thereof) to be entirely encapsulated within a metallic casting that remains within its die (mold) 413 for forming the casting; processing SNF assemblies (or portions thereof) to be entirely encapsulated within a metallic integral encapsulated unit 500; converting (making) integral encapsulated unit 500 into waste capsule(s) 600; forming waste capsules 600 into string(s) 701; inserting waste capsule(s) 600 into wellbore(s) system(s) 700 and/or 900; inserting string(s) 701 into wellbore(s) system(s) 700 and/or 900; building wellbore(s) system(s) 700 and/or 900; a portion thereof; combinations thereof; and/or like. In some embodiments, method 800 may comprise at least one of the following steps: step 801, step 803, step 805, step 807, step 809, step 811, step 813, step 814, step 815, step 816, step 817, step 819, step 821, step 823, step 825, step 826, step 827, step 828, step 829, step 830, step 831, step 832, step 833, 834, 835, a portion thereof, combinations thereof, and/or the like. In some embodiments, at least one of these steps of method 800 may be optional, skipped, omitted, executed out of numeral order with respect to a step's reference numeral, a portion thereof, combinations thereof, and/or the like.

Continuing discussing FIG. 8A, in some embodiments, step 801 may be a step of selecting, collecting, and/or gathering SNF assemblies (or portions thereof) for use in method 800. In some embodiments, the SNF assemblies or portions thereof that may be processed and/or acted upon by method 800 may be: SNF assembly 412, nuclear fuel assembly 106, group (bundle) of SNF assemblies 105, SNF assembly 101, SNF assembly 103, modified SNF assembly 512, SNF assembly 205, base 307, spent nuclear fuel assembly, fuel rod, fuel pellet, control rod, a portion thereof, combinations thereof, and/or the like. In some embodiments, these SNF assemblies may be found in temporary storage in (surface) cooling ponds and/or in surface (or near surface) storage in dry cask containers, which may be shown as structures 913 in FIG. 9. In some embodiments, step 801 may be a step of locating, identifying, and/or selecting the SNF assemblies (or portions thereof) from multiple power plant 911 sites (see FIG. 9 for nuclear power plant 911), cooling pond's locations, dry cask (intended temporary storage) containers locations, portions thereof, combinations thereof, and/or the like. In some embodiments, any such located and/or identified SNF assemblies (or portions thereof) may be selected for use in method 800. In some embodiments, execution of step 801 may be done onsite at a given nuclear power plant 911 (with cooling ponds) in a specialized area of the “site” (grounds) of that given nuclear power plant 911. In some embodiments, “site” may be defined in U.S. nonprovisional patent application Ser. No. 18/108,001, filed on Feb. 9, 2023, by the same inventor as the present patent application; wherein the disclosure of U.S. nonprovisional patent application Ser. No. 18/108,001 is incorporated herein by reference in its entirety as if fully set forth herein. In some embodiments, the collected SNF assemblies (or portions thereof) may be transported offsite from the temporary storage locations (e.g., cooling ponds and/or dry cask containers) to remote and/or different site(s) for further operations of method 800 (such as, but not limited to, sites of system 700 and/or 900). In some embodiments, this type of multi-plant/multi-location operation, step 801 may be a means of accumulating and commingling various quantities of the SNF assemblies (or portions thereof) for processing at one or more centrally located site(s), according to further steps of method 800. In some embodiments, this approach may increase efficiencies and lower operational costs, and personnel needs for disposal of SNF assemblies (or portions thereof). In some embodiments, at least partial execution of step 801 (e.g., collection of at least one SNF assembly [or portion thereof]) may progress method 800 to step 803.

Continuing discussing FIG. 8A, in some embodiments, step 803 may be a step of determining, calculating, measuring, finding, and/or the like, the free (void) volume 301 of a given SNF assembly (or portion thereof) (that is intended to be operated upon by method 800). This computation and/or determination may be important in order to accurately determine a volume of melted metal(s), alloy(s), and/or (optional) neutron absorbent that may be used during a molten diecasting gravity fed process to both entirely fill the void space 301 of that given SNF assembly (or portion thereof) and that will entirely cover over an exterior of the given SNF assembly (or portion thereof) by a minimum thickness 503 (that minimizes criticality). This internal intricate void space 301, of a typical SNF assembly (or portion thereof), may be easily and readily determined by a number of well-known techniques, all of which are incorporated by reference. For example, and without limiting the scope of the present invention, this internal intricate void space 301, of a typical SNF assembly (or portion thereof), may be easily and readily determined from digital 3D modeling software used to model a given SNF assembly (or portion thereof). For example, and without limiting the scope of the present invention, this internal intricate void space 301, of a typical SNF assembly (or portion thereof), may be easily computed empirically by a liquid displacement process on a given finished SNF assembly (or portion thereof). In some embodiments, execution of step 803 may progress method 800 to step 805, step 807, and/or step 813.

Continuing discussing FIG. 8A, in some embodiments, step 805 may be a step of determining and/or selecting the metal(s) and/or the alloy(s) that will be used in the gravity fed diecast molding process to produce a given casting from a given die (mold) 413 with a SNF assembly or portion thereof located within that casting (within that integral encapsulated [composite] unit 500). In some embodiments, this metal(s) and/or the alloy(s) may be at least one copper alloy. In some embodiments, this metal(s) and/or the alloy(s) may be at least one: copper and aluminum alloy (Cu—Al alloy(s)), copper and nickel alloy (Cu—Ni alloy(s)), a portion thereof, combinations thereof, and/or the like. Copper-aluminum alloys offer high strength and excellent corrosion resistance. Copper-aluminum alloys are suitable for the types of operations discussed herein in this patent application for forming the castings because of their comparable light weight and corrosion-resistant properties while still being sufficiently strong (e.g., as compared to other alloys, such as heavy and corrosion susceptible steel). In addition, copper-nickel alloys are also suitable and usable because of their outstanding corrosion resistance in the deep geological disposal formation 705 environments and geological conditions. The composition of this determined and/or selected metal(s) and/or the alloy(s) 409 may also be accomplished empirically and/or also by optimal use of artificial intelligence (AI) models, in some embodiments, based on existing alloy composition data or other synthetic data to provide optimal temperature response during the gravity diecasting pouring operations, fluidity for injection, and/or overall cost lowering of operations. Such parameters and/or details are well-known in the industrial diecasting industry and may be AI modeled to provide sufficient accuracy and repeatability of operations for method 800 and/or for step 805. In some embodiments, execution of step 805 may progress method 800 to step 807 and/or to step 811.

Continuing discussing FIG. 8A, in some embodiments, step 807 may be a step of a volume determination of the selected and/or determined metal(s) and/or alloy(s) 409 from step 805 that may be used to form the given casting within die (mold) 413. In some embodiments, as inputs, this step 807 may utilize the exterior dimensions of the given selected SNF assembly (or portion thereof), its determined free void space 301; an internal volume 433 of die (mold) 413; a density of the selected and/or determined metal(s) and/or alloy(s) 409 from step 805 (e.g., when molten); portions thereof; combinations thereof; and/or the like. In some embodiments, this determination of melt volume of step 807 may be based, at least in part, on adding the free volume 301 determined in step 803 above to the additional volume outside (exterior) of the given SNF assembly (or portion thereof) body and the inner walls (interior surfaces) of the die (mold) 413. In some embodiments, a maximum or upper limit for this volume of step 807 may be the free internal total volume 433 of die (mold) 413. In some embodiments, execution of step 807 may progress method 800 to step 809, step 805, and/or to step 811.

Continuing discussing FIG. 8A, in some embodiments, step 809 may be a step of performing a fissile criticality analysis (FCA) with respect to at least one of: SNF assembly (or portion thereof) size and/or type (that is intended for emplacement within a given die [mold] 413, casting, and/or integral encapsulated unit 500); die (mold) 413 design; casting design; integral encapsulated unit 500 design; loaded waste capsule 600 design; wellbore(s) system(s) 700 and/or 900 design; a portion thereof; combinations thereof; and/or the like; wherein design may be with respect to size (dimensions), volume, shape, geometry, materials of construction, and/or the like. In some embodiments, as a safety precaution, a fissile criticality analysis (FCA) may be desired, required, and/or implemented, prior to making (building and/or constructing) a given die (mold) 413, casting, integral encapsulated unit 500, loaded waste capsule 600, wellbore(s) system(s) 700 and/or 900, a portion thereof, combinations thereof, and/or the like; with respect to the SNF assemblies (or portions thereof) sizes and/or types to be used in method 800, castings, integral encapsulated units 500, loaded waste capsules 600, wellbore(s) system(s) 700 and/or 900, a portion thereof, combinations thereof, and/or the like. In some embodiments, a fissile criticality analysis (FCA) may be performed on at least one of: the contemplated SNF assembly (or portion thereof) size and/or type; die (mold) 413 design; casting design; integral encapsulated unit 500 design; loaded waste capsule 600 design; wellbore(s) system(s) 700 and/or 900 design; a portion thereof; combinations thereof; and/or the like; and/or on the equipment that may handle the SNF assemblies (or portion thereof), integral encapsulated units 500, and/or the waste capsules 600 and/or that may handle the nuclear (radioactive) waste, to determine metrics such as, but not limited to: waste composition; waste type; waste density; waste weight; waste volume; waste size (dimensions); waste shape (geometry); casting composition; integral encapsulated unit 500 composition; (loaded) waste capsule 600 composition; casting density; integral encapsulated unit 500 density; (loaded) waste capsule 600 density; casting weight; integral encapsulated unit 500 weight; (loaded) waste capsule 600 weight; casting volume; integral encapsulated unit 500 volume; (loaded) waste capsule 600 volume; casting size; integral encapsulated unit 500 size (dimensions); (loaded) waste capsule 600 size (dimensions); casting shape; integral encapsulated unit 500 shape (geometry); (loaded) waste capsule 600 shape (geometry); casting materials of construction; integral encapsulated unit 500 materials of construction; (loaded) waste capsule 600 materials of construction; casting thickness; integral encapsulated unit 500 thickness; (loaded) waste capsule 600 thickness; quantity of SNF assemblies (or portions thereof) per casting; quantity of integral encapsulated units 500 per a given waste capsule 600; formation (rock) properties of the formation (rock) 705 that immediately surrounds a given or planned deeply located geological repository 700; and/or geometry of the disposal system 700 and/or 900 and its contents such that the nuclear (radioactive) waste material always remains subcritical. In some embodiments, this FCA analysis may provide (yield) upper limits on the weight per unit of material, typically called “gram-limits,” which may be the maximum quantity of fissile material in a given integral encapsulated unit 500 (and/or in a given casting) and/or in a given waste capsule 600. In some embodiments, the required gram limits may be used in all or some of the subsequent waste disposal processes. In addition, the criticality analysis (FCA) may utilize factors such as, physical volumes of waste, material burnup times, time out of the reactor, and other well-known safety metrics to define the final configuration of the waste package (waste capsule). The execution of FCA is well known in the industry and such FCA industry teachings are incorporated by reference as if fully set forth herein. Fissile Critical Analysis (FCA) may be performed by various presently available computer programs, codes, algorithms, models, scripts, and/or the like. Some of these may be as follows: SCALE (Standardized Computer Analysis for Licensing Evaluation); MCNP (Monte Carlo N-Particle Transport Code); MONK (Monte Carlo N-Particle Kinetics Code); AMPX (Advanced Multi-group Cross-section Processor); and PARTISN. These are available to researchers and many federal and private agencies alike. In some embodiments, execution of step 809 may progress method 800 to step 807, step 811, and/or step 813.

In some embodiments, a fission criticality analysis (FCA) on the nuclear waste form may be performed to assess the potential for a dangerous self-sustaining nuclear chain reaction within the waste package (e.g., whether that may be a given casting, integral encapsulated unit 500, a given waste capsule 600, and/or a string 701). In some embodiments, this FCA analysis may be crucially important to ensure the safe handling, transportation, and/or storage of nuclear waste. Past criticality incidents have occurred in the U.S., Japan, and Russia because of inadequate criticality analysis.

In some embodiments, general steps involved in conducting a criticality analysis may be: define the system boundaries; identify the fissile materials; determine the neutron multiplication factors; assess neutron moderation; consider neutron absorption; perform criticality calculations, using computational tools and established mathematical models. And finally, in some embodiments, meet all applicable and/or relevant regulatory requirements.

Note, prior art neutron absorbing utilization has involved using neutron absorbing inserts within steel capsules that contain SNF assemblies. In the prior art, neutron-absorbing steel inserts or rods were placed strategically around the SNF assemblies, but never within the internal structures of the SNF assemblies, such as, never within the internal void spaces 301 of the SNF assemblies. These prior art neutron absorbing inserts were usually made of boron carbide, which has a high neutron absorption cross-section, making it an effective neutron absorber. In the present patent application, in some embodiments, because of the high temperature of the molten gravity fed process using molten composition 409, the molten composition 409 when it contains neutron absorbent materials, places and forces these neutron absorbent materials into the internal matrix structure internal void spaces 301 of the SNF assembly (or portion thereof) which the prior art never contemplated nor ever implemented.

Continuing discussing FIG. 8A, in some embodiments, step 809 may also be a step of determining an important operating parameter which may be the cooling time where integral encapsulated unit 500 may be removed from support(s) 417 after the gravity fed process has completed (see also step 826 for when method 800 executes this cooling). In some embodiments, this cooling time for a diecasting molten gravity fed process may be a minimum time required before a given produced integral encapsulated unit 500 may be ready to be removed from support(s) 417. Cooling time may vary depending on several factors, such as, but not limited: gravity fed operating temperatures (any pressure above local atmospheric pressure may be from the high temperatures and not from an external high pressure means); die (mold) 413 size and complexity; SNF assembly (or portion thereof) size and complexity; the type and the volume of molten (melted) materials being used (e.g., the metal(s) and/or the alloy(s)); integral encapsulated unit 500 size and complexity; the cooling method(s) being employed; the cooling medium(s) being employed; a portion thereof; combinations thereof; and/or the like. During the gravity die-casting system 400 illustrated in FIG. 4A, molten material 409 may be gravity introduced (fed and/or poured) into the die (mold) 413 under gravity flow and at high enough temperatures to keep 409 liquid (molten and/or melted) during the active gravity feeding process. After the gravity feeding, the cooling phase begins, during which the liquid (molten and/or melted) material(s) 409 resolidifies taking the shape of the die (mold) 413 internal surfaces to produce a solid casting within die (mold) 413 (wherein the casting includes the SNF assembly [or portion thereof]). The cooling time typically refers to the duration required for the casting to reach a temperature where that casting may safely be removed along with its still attached die (mold) 413 as an integral encapsulated unit (composite unit) 500 without unacceptable deformation, i.e., the casting and certainly the integral encapsulated unit 500 may have cooled sufficiently to be self-supporting without its shape changing. In some embodiments, the cooling time can range from a minute to several minutes, depending on several factors. In some embodiments, at least some of the factors that may influence the cooling time include (comprise): casting size and thickness; metal(s) and/or alloy(s) type(s) and/or composition(s); cooling method(s); injection operating temperatures and pressures; die (mold) 413 size and complexity; SNF assembly (or portion thereof) size and complexity; the type and the volume of molten (melted) materials being used (e.g., the metal(s) and/or the alloy(s)); casting size and complexity; integral encapsulated unit 500 size and complexity; the cooling method(s) being employed; the cooling medium(s) being employed; a portion thereof; combinations thereof; and/or the like. With respect to, casting size and thickness: larger and thicker castings and/or integral encapsulated units 500 generally take longer to cool due to the increased amount of heat that needs to be dissipated (i.e., heat transfer is often proportional to the mass that needs cooling). With respect to, metal(s) and/or alloy(s) type(s) and/or composition(s): different metals and/or alloys have varying cooling rates. Some metals, such as aluminum, cool relatively quickly, while others, like steel, may require longer cooling times. With respect to, the cooling method: the cooling method used can also affect the cooling time. Cooling can be accomplished through natural radiation, conduction, and/or convection, and/or cooling may use additional cooling mechanisms such as, but not limited to, water (or other liquids and/or fluid) and/or air (or other gas) sprays, and/or other cooling means that are well used and well understood in the industrial diecasting injection molding processes. Pre-existing castings cooling methods are incorporated by reference. In some embodiments, an initial cooling time may be determined, calculated, selected, and/or approximated prior to gravity diecasting operations during the initial process of modeling the system operations, such as, in step 809 of method 800, prior to method 800 executing the cooling step 826. And then, the cooling time may change during operation as experience is gained on the behavior of the total gravity die-cast injection system. This optimization process may allow for more efficient operations as thousands of SNF assemblies are processed according to method 800. In some embodiments, execution of step 809 may progress method 800 to step 811, step 807, and/or to step 813.

Continuing discussing FIG. 8A, in some embodiments, step 811 may be a step of melting the melt materials 409 that are intended to be gravity poured into the closed die (mold) 413 (with the SNF assembly or portion thereof located within that die 413) during step 825. In some embodiments, step 811 may be accomplished with an established melt furnace 408. In some embodiments, the liquid (molten and/or melted) materials 409 may comprise the at least one selected and/or determined metal(s), alloy(s), and/or the neutron absorbing members (e.g., boron carbide [B₄C]), a portion thereof, combinations thereof, and/or the like. In some embodiments, execution of step 811 may progress method 800 to step 814, step 816, and/or to step 815.

Continuing discussing FIG. 8A, in some embodiments, step 814 may be a step of measuring, collecting, transferring, and/or the like the (determined) volume of melt materials 409 from step 811, and making such collected volume of melt material 409 ready for gravity feeding (in step 825). In some embodiments, this collected volume of melt materials 409 of this step 814, may be stored in melt reservoir 408. In some embodiments, execution of step 814 may progress method 800 to step 817 and/or to step 816.

Continuing discussing FIG. 8A, in some embodiments, step 815 may be a step of selecting and/or determining which, if any, of neutron absorbers (such as, but not limited to, boron carbide [B₄C]) are to be included into the molten materials 409 and/or into the closed and loaded die 413 during step 825. In some embodiments, the selection and/or the determination of the neutron absorbers may be determined by the FCA of step 809 and/or FCA may be carried out in step 815. In some embodiments, execution of step 815 (and/or of step 809) may also determine a desired amount of such neutron absorbers for inclusion, if any. In some embodiments, execution of step 815 may progress method 800 to step 816.

Continuing discussing FIG. 8A, in some embodiments, step 816 may be a step of measurably and/or controllably adding the selected and/or determined neutron absorber (e.g., from step 815 and/or from step 809) to the molten materials 409 during the gravity feed process. In some embodiments, execution of step 816 may progress method 800 to step 821, to step 823 and/or to step 825.

Continuing discussing FIG. 8A, in some embodiments, step 817 may be an optional step of preheating the SNF assembly (or portion thereof) and/or preheating the mold 413 itself, before that given SNF assembly (or portion thereof) is loaded (inserted) into the mold 413 and receives the molten material 409. Preheating the mold 413 and/or the SNF assembly (or portion thereof) before gravity feeding molten alloy material 409 into the mold 413 in step 425 may be desired for several reasons and may provide various benefits, such as, but not limited to: reducing thermal shock, improving material flow, reducing porosity and defects, combinations thereof, and/or the like. Thermal shock may occur when two or more masses of very different temperatures come into physical contact with each other (such as, a temperature difference between a molten alloy and typical room temperature). Thermal shock may be undesired as it may cause or contribute to die (mold) 413 and/or the given SNF assembly (or portion thereof) developing cracks, losing structural integrity, becoming brittle, combinations thereof; as well as, undesired excessive and hot outgassing and/or splashing. Preheating minimizes and/or reduces premature cooling of molten material 409 when molten material 409 enters into die (mold) 413; which in turn keeps the viscosity and/or flowability of molten material 409 at desired levels; and as such preheating may improve material flow of molten material 409 and/or may encourage better and/or more complete penetration into all of the void spaces 301 by the molten material 409. Preheating may help to minimize and/or reduce undesired gas entrapment within die (mold) 413 and/or within the void spaces 301 of the given SNF assembly (or portion thereof). Preheating may promote a more uniform and controlled re-solidification process, leading to higher-quality castings with fewer internal defects. Preheating may help to minimize and/or reduce porosity (both in terms of reducing a quantity of pores and in reducing a size of pores). In some embodiments, for copper alloy die casting operations, the preheating temperature of the SNF assembly (or portion thereof) and/or of the die (mold) 413 may be selected from a range of 150 degrees Celsius (° C.) to 300° C. (302 degrees Fahrenheit [ ° F.] to 572° F.). Preheating temperature(s) from this range may promote the benefits mentioned above while maintaining the integrity and effectiveness of the operations. In other embodiments, other preheating temperatures may be used. In some embodiments, step 817 may be accomplished with industrial heaters that are well known in the industry and that are incorporated by reference. In some embodiments, after execution of step 817 may progress method 800 to step 823. Note, if step 817 was omitted or skipped, then step 814 may progress directly to step 823.

When molten copper is used as the gravity fed molten fluid 409 in a diecast operation on spent nuclear fuel (SNF) assemblies, eutectic mixtures could form between the copper melt and the zircaloy of the SNF assembly's tubes that hold the spent uranium material; and if so, could lead to several operational problems. Even though the operating time of the gravity fed process may be short, e.g., in minutes and not hours in some embodiments, there may still be a possibility of eutectic mixtures being formed between the zircaloy tubes of the SNF assembly and the selected copper melt. The eutectic point between copper and zirconium (a primary component of zircaloy) occurs at a temperature around 830 degrees Celsius (° C.), which is lower than the individual melting points of copper (1,085° C.) and zirconium (1,855° C.), respectively.

During the diecast process, the interaction at the interfaces between the molten copper and zircaloy tubes can cause eutectic reactions, resulting in the formation of a eutectic mixture with a lowered melting point. Furthermore, the formation of eutectic mixtures may result in undesirable chemical interactions, such as corrosion and alloying, further degrading the material properties of both the copper and zircaloy. These issues may require stringent control of process temperatures, careful selection of materials, and possibly the application of diffusion barrier coatings to prevent direct contact between the copper melt and zircaloy tubes, ensuring the stability and safety of the diecast operation in encapsulating spent nuclear fuel (SNF) assemblies.

In this patent application, potential problems arising from eutectic mixtures formed between the copper melt fluid and zircaloy tubes in die cast operations on spent nuclear fuel (SNF) assemblies may be resolved through several practical approaches.

To at least partially coat, cover, and/or or protect surfaces of interior components of spent nuclear fuel (SNF) assemblies to prevent the formation of eutectics on the SNF zircaloy tubes, several methods may be utilized. These methods may involve coating, spraying, painting, dipping, a portion thereof, combinations thereof, and/or the like processes, utilizing materials that can withstand the harsh environment inside the SNF assemblies. What follows are some potential approaches coating or the like: (1) ceramic coatings; (2) metallic coatings; (3) polymer coatings; (4) oxide coatings; (5) composite coatings; (6) surface treatments; (7) chemical coatings; a portion thereof; combinations thereof; and/or the like.

Ceramic coatings provide high-temperature resistance and excellent chemical stability. These coatings can be applied through: thermal spraying, chemical vapor deposition (CVD), a portion thereof, combinations thereof, and/or the like. Thermal Spraying may involve melting ceramic powders and spraying them onto the surface of the zircaloy tubes using a high-velocity gas stream. Chemical vapor deposition (CVD) may involve reacting volatile ceramic compounds with the surface of the tubes to form a thin, protective ceramic layer.

Applying a metallic coating can provide a barrier to eutectic formation and improve the oxidation resistance of zircaloy tubes. Applying a metallic coating may be done via electroplating, physical vapor deposition (PVD), a portion thereof, combinations thereof, and/or the like. Electroplating may use an electric current to deposit a layer of metal (e.g., nickel, chromium, and/or the like) onto the surface of the zircaloy tubes. Physical vapor deposition (PVD) may deposit metal from a metal vapor onto the tubes in a vacuum chamber, forming a thin and/or uniform layer of such deposited metal onto the exterior surfaces of the zircaloy SNF tubes.

High-temperature resistant polymers coatings may be applied onto the exterior surfaces of the zircaloy SNF tubes. This may be done by spray coating, by dipping, a portion thereof, combinations thereof, and/or the like. Spray coating may apply polymer-based solutions or suspensions via spraying to form a protective layer after drying and curing onto the exterior surfaces of the zircaloy SNF tubes. Dipping may (at least partially) submerge the exterior surfaces of the zircaloy SNF tubes in a polymer solution, then removing and allowing the coating to cure.

Creating and/or forming an oxide layer on the surface of zircaloy tubes can protect against eutectic formation. This may be done by anodizing, sol-gel coating, a portion thereof, combinations thereof, and/or the like. Anodizing may entail an electrochemical process that increases a natural oxide layer on the surface of the zircaloy tubes, enhancing their resistance to corrosion and chemical attack. Sol-Gel Coating may involve dipping the zircaloy SNF tubes in a sol-gel solution, then heat-treating to form a dense, protective oxide layer onto the exteriors of the zircaloy SNF tubes.

Combining different materials to create composite coatings onto the exteriors of the zircaloy SNF tubes may offer enhanced protective properties. This may be done in a layered coatings approach, a nano-composite coatings approach, a portion thereof, combinations thereof, and/or the like. A layered coatings approach may apply alternating layers of different materials, such as, but not limited to, ceramic and metallic materials to take advantage of the properties of both. A nano-composite coatings approach may utilize nanoparticles within a coating matrix to improve the coating's overall performance.

Surface treatments can modify the properties of the exteriors of the zircaloy SNF tubes to prevent or minimize eutectic formation. This may be done by layer cladding, plasma spraying, a portion thereof, combinations thereof, and/or the like. With laser cladding, a laser is used to melt a protective material onto the exterior surface of the zircaloy SNF tubes, creating a metallurgically bonded exterior (outer) protective layer. Plasma spraying may similar to traditional thermal spraying, but uses a plasma torch to melt and propel the coating material onto the exterior surfaces of the zircaloy SNF tubes, creating a exterior (outer) protective layer.

Chemical coatings use chemical treatments to form protective layers onto the exterior surfaces of the zircaloy SNF tubes. This may be done by siliconizing, aluminizing, a portion thereof, combinations thereof, and/or the like. Siliconizing may involve a diffusion of silicon into the exterior surfaces of the zircaloy SNF tubes to form a silicon-rich protective layer. Aluminizing may be a process of diffusing aluminum into the exterior surfaces of the zircaloy SNF tubes to form an aluminum-rich protective layer.

Each of these methods may have its own advantages and limitations, and the choice of coating or protection method may depend, at least in part, on specific operational conditions, including temperature, radiation levels, and the chemical environment within the SNF assemblies. In some embodiments, choice and/or selection of one or more anti-eutectic treatments, mixtures coating(s) and/or protection method(s), may be handled in the step 809 fissile criticality analysis (FCA).

In some embodiments, method 800 may comprise a step of executing one or more anti-eutectic treatments, mixtures coating(s), and/or protection method(s), as noted above. In some embodiments, execution of one or more anti-eutectic treatments, mixtures coating(s), and/or protection method(s) may be done to the selected SNF assembly (or portion thereof) prior to execution of step 823. In some embodiments, execution of one or more anti-eutectic treatments, mixtures coating(s), and/or protection method(s) may be done in step 817. In some embodiments, if preheating the SNF assembly (or portion thereof) may be carried out, execution of one or more anti-eutectic treatments, mixtures coating(s), and/or protection method(s) to the SNF assembly may occur before, after, or concurrently with preheating the SNF assembly (or portion thereof).

Additionally, selecting copper alloys that do not form eutectic mixtures with zirconium, such as copper-nickel, copper-aluminum, copper-silicon, or copper-beryllium alloys, may mitigate this issue; and one or more of these alloys may be selected as the melt material 409 in some embodiments. These alloys have lower melting points and are less reactive with zirconium, reducing the risk of eutectic reactions.

Furthermore, maintaining strict temperature control during the die cast process (e.g., step 825) may ensure that the operational temperatures remain within safe limits, preventing any unintended reactions.

Through these combined strategies, the integrity of the zircaloy SNF tubes may be preserved, ensuring the safe encapsulation of radioactive materials in the SNF assemblies as taught in this patent application.

Continuing discussing FIG. 8A, in some embodiments, step 823 may be a step of inserting (loading) the collected and/or selected SNF assembly (or portion thereof) (e.g., from the step 801) into an open die (mold) 413, prior to the gravity feeding operations commencing within that then closed die (mold) 413. In some embodiments, step 823 may be accomplished by use of handler 427, an established handler, and/or the like. In some embodiments, after step 823 has completed, die (mold) 413 may then be closed (with the SNF assembly [or portion thereof] now located within that now closed die [mold] 413). In some embodiments, execution of step 823 may progress method 800 to step 825. Step 825 is shown in FIG. 8B.

Continuing discussing FIG. 8A, in some embodiments, step 821 may be a step of injecting a purge (inert) gas into die (mold) 413 that has a given SNF assembly (or portion thereof) located within that given die (mold) 413 and before the actual gravity feeding of the molten materials 409 into that given die (mold) 413 begins (i.e., before step 825). In some embodiments, gas cylinder(s) (gas source) 420 and/or gas line 421 may enable and/or support step 821. In some embodiments, the inert gas may be used in the initial stage of the loading process of the die (mold) 413. Inert gases are commonly used in diecasting operations to prevent (or minimize) surface oxidation and/or to improve the casting quality. At least one primary purpose of using inert gases within the die (mold) may be to create a protective atmosphere within the die (mold), during and/or right before the casting process. Typically, an inert gas such as, but not limited to, nitrogen and/or argon is introduced into the diecasting machine's (apparatus) die (mold) cavity prior to the gravity feeding of the molten metal(s) and/or alloy(s). In some embodiments, this inert gas may help in several ways, such as, but not limited to: (1) oxidation prevention (mitigation); (2); heat removal (3) porosity reduction; (4) surface finish enhancement; portions thereof; combinations thereof; and/or the like. With respect to oxidation prevention (mitigation), inert gases may create (form) a barrier between the molten material 409 and the surrounding air, minimizing or preventing oxidation of the alloy(s) material 415. Oxidation can degrade the quality of the completed casting and affect its mechanical properties. With respect to heat removal, inert gases aid in the quicker cooling and re-solidification of the molten metal 409 into its solid alloy(s) material 415 form, reducing cycle times and improving productivity. The added inert gas may help in extracting heat from the casting (and/or from die [mold] 413 and/or from integral encapsulated unit 500), promoting re-solidification, and/or maintaining dimensional accuracy. With respect to porosity reduction, the use of inert gases can help reduce the formation of gas porosity within the castings. By displacing air (and/or other gases) from the die (mold) cavity 413, inert gases minimize the likelihood of gas entrapment in the molten metal 409 (and in the resolidified alloy(s) material 415), resulting in improved structural integrity of the resulting castings. With respect to surface finish enhancement, inert gases may help improve the surface finish of the casting by reducing the formation of oxide films. A specific choice of inert gas and its application may vary depending on particulars of given the die casting process, the type of metal(s) (alloy(s)) being cast, and other well-known factors in the relevant art of metal/alloy diecasting. In some embodiments, the inert gas may be selected from nitrogen, argon, combinations thereof, and/or the like. However, the general objective is to create a controlled environment within the die-casting machine, including the die (mold) 413, to enhance the quality and/or to reduce defects of the castings. However, in some embodiments, some or all of the beneficial features of the use of inert gases in the die (mold) 413, may not be necessary in some embodiments of the present invention, since the end product, i.e., the castings and/or the integral encapsulated units 500, may not be consumer nor industrial items of a specific required look, feel, and/or quality, but rather items that are destined for deep underground burial encapsulated in a deep horizontal wellbore (and/or human-made cavern). In some embodiments, use of the inert gas into die (mold) 413 may be done before, during, and/or after the gravity feeding process (operation). In some embodiments, execution of step 821 may progress method 800 to after step 823 and/or right before step 825. In some embodiments, step 821 may be optional, skipped, or omitted. Note, if step 821 was omitted or skipped, then step 816 may progress directly to step 823 and/or to step 825.

Discussing FIG. 8B, in some embodiments, step 825 may be a step of gravity feeding (introducing and/or pouring) the melted (molten) material 409 into loaded and closed die (mold) 413 that has the SNF assembly (or a portion thereof) located within the closed die (mold) 413. In some embodiments, execution of step 825 may utilize: gravity, local atmospheric pressure, flowline (inlet line) 410, feed port 406, a portion thereof, combinations thereof, and/or the like. In some embodiments, in practice, the gravity feeding process may be at least substantially (mostly) to entirely driven by the gravity head of the molten alloy fluid 409 (e.g., reservoir 408 being vertically located above mold 413). Thus, gravity feeding occurs at both high temperature but at essentially zero added pressure (i.e., just local atmospheric pressure), with any pressure above local atmospheric pressure generating entirely from the pressure head provided by the elevated position of the molten materials 409 in reservoir 408. In some embodiments, upon completion of step 825 a given casting (with the inserted SNF assembly [or portion thereof] located within that produced casting) may have been generated (outputted). In some embodiments, upon completion of step 825 a given integral encapsulated unit 500 (with the inserted SNF assembly [or portion thereof] located within the produced casting, and with the that casting still located within its die [mold] 413) may have been generated (outputted). In some embodiments, execution of step 825 may progress method 800 to step 826.

Continuing discussing FIG. 8A, in some embodiments, step 813 may be a step of building a given die (mold) 413 and/or or using an already built die (mold) 413 (if an already built die (mold) 413 may be suitable per the FCA of step 809). In some embodiments, a given die (mold) 413 may be designed, engineered, sized, dimensioned, shaped, and/or the like, so that a given SNF assembly (or portion thereof) fits entirely within that given die (mold) 413 and such that the resulting casting may have a minimum wall thickness 503. In some embodiments, a die (mold) 413 once built and once used to form a given casting, may not be physically separated from its casting; i.e., once the casting is formed (and re-solidified) that die (mold) 413 and its casting behave as a single integral unit, i.e., as integral encapsulated unit (composite unit) 500. In some embodiments, a die (mold) 413 once built may be configured to be removably supported by support(s) 417; i.e., that die (mold) 413 whether empty, filled, loaded, and/or housing a casting may be removed from its support(s) 417. Recall, the size, shape, dimensions, exterior surface geometry, weight, and/or the like of a given SNF assembly (or portion thereof) are either preexisting and well-known or may be known prior to building a given die (mold) 413. A given die (mold) 413 is designed and/or engineered so that the given SNF assembly (or portion thereof) fits entirely within that given die (mold) 413. In some embodiments, given die (mold) 413 may be designed, engineered, sized, dimensioned, shaped, and/or the like, from results of the step 809 fissile criticality analysis (FCA). In some embodiments, execution of step 813 may progress method 800 to step 819.

Continuing discussing FIG. 8A, in some embodiments, step 819 may be an optional step of adding a boron carbide (B₄C) sleeve 414 inside of the mold 413 (for neutron absorption and/or shielding). In some embodiments, step 819 may progress method 800 to step 823. In some embodiments where step 819 may be skipped or omitted, step 813 may instead progress directly to step 823.

Continuing discussing FIG. 8B, in some embodiments, step 826 may be a step of cooling the newly formed casting and/or integral encapsulated unit 500 sufficiently so that integral encapsulated unit 500 may be removed from its support(s) 417 for further processing according to method 800 (such as, but not limited to, converting into a waste capsule 600).

Once the casting and/or the integral encapsulated unit 500 has sufficiently cooled, at least an exterior of that casting will be a solid 3D shape that is self-supporting (with no appreciable liquid flow), i.e., that 3D shape will not change (deform) when integral encapsulated unit 500 is removed and/or moved about. In some embodiments, sufficient minimum cooling may take only a few minutes to less than an hour. In some embodiments, cooling may be aided by use of a cooling bath (e.g., cooling bath 429). In some embodiments, once the casting and/or integral encapsulated unit 500 has cooled sufficiently (i.e., the at least the exterior of that casting is a solid 3D shape that is self-supporting), the integral encapsulated unit 500 may be removed and/or moved about. In some embodiments, integral encapsulated unit 500 removal from the die cast apparatus, such as, but not limited to, support(s) 417 may be accomplished by use of a handler (such as, but not limited to, handler 427), by use of an established robotic handler, and/or the like. In some embodiments, the handler (such as, but not limited to, handler 427), the established robotic handler, and/or the like may move integral encapsulated unit 500 around, such as, but not limited to, in or out of support(s) 417 and/or cooling bath 429. In some embodiments, integral encapsulated unit 500 may be removed from die apparatus (e.g., support(s) 417) and into a cooling bath (such as, but not limited to, cooling bath 429). In some embodiments, step 826 may be a step of cooling a casting and/or an integral encapsulated unit 500 and/or of removing integral encapsulated unit 500 from its die casting apparatus (such as, but not limited to, support(s) 417). In some embodiments, execution of step 826 may progress method 800 to step 828, to step 829, and/or to step 827.

Continuing discussing FIG. 8B, in some embodiments, step 828 may be a step of preparing (converting) integral encapsulated units 500 into completed disposal waste capsules 600. In some embodiments, this step 828 may involve the addition of external elements such as, but not limited to, couplings 604 and/or other industry-wide acceptable additions to enable safe insertion and retrievability of the waste capsules 600 with respect to wellbores and/or to terrestrial surface transportation. See e.g., FIG. 6A, FIG. 6B, and/or FIG. 6C as well as their discussions. In some embodiments, execution of step 828 to produce at least one waste capsule 600 may then progress method 800 to step 829.

Continuing discussing FIG. 8B, in some embodiments, step 829 may be a step of inserting (landing) loaded waste capsules 600 (which may be in string 701 format/configuration) into at least one (1) horizontal (lateral) wellbore(s) 703 and/or 901, wherein that at least one (1) horizontal (lateral) wellbore(s) 703 and/or 901 is at least partially located within a deeply located geologic formation 705. See e.g., FIG. 7 and FIG. 9. In some embodiments, drilling rig 907 (or the like) may be used in executing step 829. In some embodiments, execution of step 829 may progress method 800 to step 831. In some embodiments, execution of step 829 cannot occur until execution of step 830.

Continuing discussing FIG. 8B, in some embodiments, step 830 may be a step of building and/or constructing at least one waste disposal system 900 (SuperLAT™ system 900) that uses deeply located horizontal wellbore(s) 901 that are located at least partially within the given deeply located geologic formation 705. See e.g., FIG. 9. In some embodiments, drilling rig 907 (or the like) may be used in executing step 830, in building and/or constructing at least one waste disposal system 900 (SuperLAT™ system 900). In some embodiments it should be noted that execution of step 830 and/or of building the SuperLAT™ wellbore may occur before, after, or concurrently with any step of method 800, except that the execution of step 830 and/or of building the SuperLAT™ wellbore must occur before execution of step 829, step 831, and step 832. In some embodiments, execution of step 830 may progress method 800 to step 829.

Continuing discussing FIG. 8B, in some embodiments, step 831 may be a step of sealing (closing) a given waste disposal system 900 (SuperLAT™ system 900). In some embodiments, in executing step 831 at least one plug 915 may be emplaced within a wellbore 703 and/or 903 of the given waste disposal system 900 (SuperLAT system 900). In some embodiments, plug 915 may be made at least mostly (substantially) from concrete, cement, rock (that is the same or similar to the rock of deeply located geologic formation 705), portions thereof, combinations thereof, and/or the like. In some embodiments, execution of step 831 may progress method 800 to step 832.

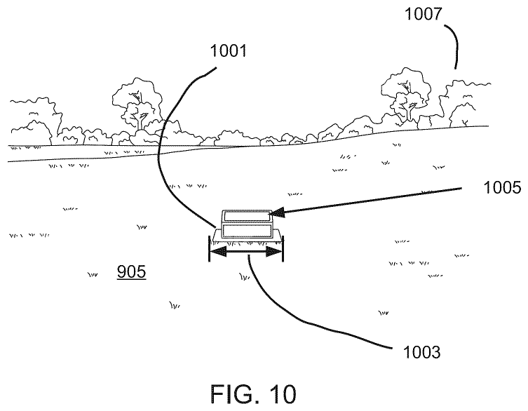

Continuing discussing FIG. 8B, in some embodiments, step 832 may be a step of marking the terrestrial surface 905 that is located at least mostly (substantially) vertically above a given (sealed) waste disposal system 900 (SuperLAT™ system 900) with one or more surface plaque(s) 1001, such as, shown and discussed in FIG. 10. In some embodiments, execution of step 832 may optional, skipped, and/or omitted.

Continuing discussing FIG. 8B, in some embodiments, step 827 may be a step of continuing to execute method 800 until a given waste disposal system 900 (SuperLAT™ system 900) may be deemed sufficiently full of HLW; until there is insufficient HLW available to execute step 801; until no empty dies (molds) 413 are available; and/or some other constraint is reached (such as, but not limited to, a funding shortfall). In some embodiments, per step 827, integral encapsulated units 500 and waste capsules 600 may continue to be made;

and such made integral encapsulated units 500 and waste capsules 600 may be emplaced within waste disposal systems 900 (SuperLAT™ systems 900). In some embodiments, step 827 may be a looping and/or an iterative step with respect to the gravity fed die cast operations. In some embodiments, step 827 may be a step of continuing the gravity fed die cast operations by sequentially performing desired or necessary, or recommended preparatory steps to collect, treat, and position the SNF assemblies within the die cast molds 413, such as, but not limited, to continuing to build new (additional, different, and/or other) dies (molds) 413 if no already made and empty dies (molds) 413 are currently available. In some embodiments, execution of step 827 may progress method 800 to step 813.

FIG. 8C shows some alternative steps to an alternative embodiment of method 800 as shown and discussed above per FIG. 8A and FIG. 8B. In some embodiments, in an alternative embodiment of method 800 as shown in FIG. 8C, step 817 (of FIG. 8A) may instead progress to step 834 of FIG. 8C. In some embodiments, step 834 may be a step of initially only partially filling volume 433 of die (mold) 413 to limited fill volume 409a (fill line 409a) with molten material(s) 409, which is less than volume 433, and doing so before SNF assembly (or portion thereof) 412 is inserted into that same die (mold) 413. In some embodiments, step 834 may be carried out while a top endcap 411 is not attached to die (mold) 413; and/or when a removable vent hood 436 may be removably attached to a top (upper) portion of die (mold) 413 (to capture, retain, filter, and/or treat off gassing, vapors, smoke, airborne particulate matter, volatile organic compounds (VOCs), volatile inorganic compounds, splashing, combinations thereof, and/or the like). In some embodiments, execution of step 834 may progress this embodiment of method 800 to step 835.

Continuing discussing FIG. 8C, in some embodiments, step 835 may be a step of fulling inserting (loading) the SNF assembly (or portion thereof) 412 into the die (mold) 413 that has the partial fill of molten material(s) 409 from the step 434. In some embodiments, execution of step 834 may progress this embodiment of method 800 to step 825, i.e., of fully filling the volume 433 of die (mold) 413 with molten material(s) 409, such that the entirety of the previously inserted SNF assembly (or portion thereof) 412 is fully and entirely covered over by the molten material(s) 409.

Continuing discussing FIG. 8C, in some embodiments, this alternative embodiment of method 800 may further comprise a step 833. In some embodiments, step 833 may be a step of activating and/or using vent hood 436, such that vent hood 436 may be active, operational, and/or running during execution of step 834, step 835, step 825, and/or step 826.

Continuing discussing FIG. 8C, in some embodiments, this alternative embodiment of method 800, step 821 may entail injecting (providing) one or more purge gasses into volume 433 of die (mold) 413 while step 835 is being executed.

FIG. 9 may depict a waste disposal repository system 900 in which waste capsules 600 (with integral encapsulated units 500) are sequestered in horizontal wellbore(s) 901, wherein the horizontal wellbore(s) 901 are located within deeply located geological formation(s) 705 (wherein a waste disposal repository system 900 that uses such horizontal wellbore(s) 901 that are located within deeply located geological formation(s) 705 may be referred to as a SuperLAT™ deep disposal system 900). FIG. 9 may depict a partial cutaway view of a system 900 for (long-term) disposing of nuclear, radioactive, hazardous, and/or dangerous waste, such as, but not limited to, integral encapsulated units 500 (with radioactive waste therein, such as, but not limited to, SNF assemblies 106/512 [or portions thereof]), within the waste capsules 600; wherein such loaded waste capsule(s) 600 may be emplaced within horizontal (lateral) wellbore(s) 901; and wherein at least some section(s) (portion(s) and/or region(s)) of the horizontal (lateral) wellbore(s) 901 may be located within at least one deeply located geologic formation (rock) 705. In some embodiments, each horizontal (lateral) wellbore 901 may be operatively connected to at least one vertical wellbore 903. In some embodiments, lengths of a pair of operatively connected horizontal (lateral) wellbore 901 section and vertical wellbore 903 section may be at least substantially (mostly) orthogonal (perpendicular) to each other (e.g., lateral wellbore 901 segments may be five [5] degrees or

less off from being fully ninety degrees orthogonal with its connected vertical wellbore 903). In some embodiments, the vertical wellbore 903 (that is operatively connected to a section of horizontal [lateral] wellbore 901) may run from that section of horizontal (lateral) wellbore 901 (vertically) to a terrestrial (Earth) surface 905. In some embodiments, terrestrial (Earth) surface 905 may be an above ground local terrestrial surface of the Earth, wherein a given vertical wellbore 903 may originate at and descend (vertically) downwards into at least one deeply located geologic formation (rock) 705, which that wellbore may then change directions into the horizontal (lateral) direction to form at least one horizontal (lateral) wellbore 901 located within that at least one deeply located geologic formation (rock) 705. In some embodiments, “vertical” in the context of vertical wellbore 903, may mean that a given vertical wellbore 903 has a length that runs in a direction that is at least substantially (mostly) parallel with a local gravitational vector (local to that given vertical wellbore 903). In some embodiments, at a given well head site, using a given drilling rig 907, from terrestrial (Earth) surface 905, first a given vertical wellbore 903 may be formed and drilled to at least a depth of and into the at least one deeply located geologic formation (rock) 705; and then, using a given drilling rig 907, that wellbore may then change directions into the horizontal (lateral) direction to form at least one horizontal (lateral) wellbore 901 located within that at least one deeply located geologic formation (rock) 705.

Continuing discussing FIG. 9, in some embodiments, drilling rig(s) 907, from terrestrial surface 905, may be used to form wellbore(s) 901, 903, and/or 703. In some embodiments, drilling rig(s) 907 using downhole tools and techniques, from terrestrial surface 905, may be used to land, emplace, load, insert, place, and/or the like waste capsule(s) 600 (with integral encapsulated units 500 therein) and/or string(s) 701 of waste capsules 600 (with integral encapsulated units 500 within the waste capsules 600) within wellbore(s) 901, 903, and/or 703. In some embodiments, drilling rig(s) 907 using downhole tools and techniques, from surface 905, may be used to retrieve waste capsule(s) 600 (with integral encapsulated units 500 within) and/or to retrieve string(s) 701 of waste capsules 600 (with integral encapsulated units 500 within) from within wellbore(s) 901, 903, and/or 703. In some embodiments, drilling rig 907 may be at least substantially similar to a drilling rig used to form and/or case wellbores in oil and/or gas fields. In some embodiments, forming wellbore(s) 901, 903, and/or 703, as well as handling waste capsule(s) 600 and/or string(s) 701 of waste capsule(s) 600, within wellbore(s) 901, 903, and/or 703, may be accomplished using drilling rigs, downhole tools, tooling, machines, devices, apparatus, systems, methods, processes, and/or techniques of the oil field industry that are in use today and well understood. Such preexisting downhole drilling rigs, tools, tooling, machines, devices, apparatus, systems, methods, processes, and/or techniques of the oil field industry are incorporated by reference herein as if fully set forth herein.

Continuing discussing FIG. 9, in some embodiments, deeply located geologic formation (rock) 705 may be located at least 5,000 feet (ft) below the terrestrial surface 905, plus or minus 100 feet (ft). In some embodiments, deeply located geologic formation (rock) 705 may be located at least 10,000 feet (ft) below the terrestrial surface 905, plus or minus 100 feet (ft). In some embodiments, deeply located geologic formation (rock) 705 may have a vertical thickness between fifty (50) feet (plus or minus ten feet) and 3,000 feet (plus or minus fifty feet). In some embodiments, deeply located geologic formation(s) (rock(s)) 705 may be of geological formations selected from: tight shales, deeply bedded salt formations, deep bed-rock granite formations, a portion thereof, combinations thereof, and/or the like. These types of geological formations usually (typically and/or often) all have very limited permeability and very low intrinsic water saturations, which contribute to be suitable geologic formations for deeply located geologic formation(s) (rock(s)) 705 that may accommodate long-term storage (disposal) of dangerous wastes therein with risking harm to the exterior ecosphere.

Continuing discussing FIG. 9, in some embodiments, located local to, adjacent to, and/or proximate to a given vertical wellbore 903 wellhead, on terrestrial (Earth) surface 905, may be at least one nuclear power generation reactor plant 911. In some embodiments, located onsite to a given vertical wellbore 903 wellhead, on terrestrial (Earth) surface 905, may be at least one nuclear power generation reactor plant 911. In some embodiments, operation of nuclear power generation reactor plant 911 may yield electrical power, typically for grid scale distribution and may also yield SNF that requires safe, efficient, and cost-effective long-term disposal, such as, but not limited to, disposal within a given waste repository system 900. In some embodiments, located, local to, adjacent to, and/or proximate to a given vertical wellbore 903 wellhead, on terrestrial (Earth) surface 905, may be at least one infrastructure building or structure 913. In some embodiments, located onsite to a given vertical wellbore 903 wellhead, on terrestrial (Earth) surface 905, may be at least one infrastructure building or structure 913. In some embodiments, infrastructure building or structure 913 may comprise one or more of: SNF cooling pools, SNF cooling ponds, SNF temporary storage casks, control rooms, operations rooms, warehouses, maintenance and engineering workshops, offices, and/or other building(s) and/or structures typical to have at a nuclear power generation reactor plant 911 site. In this context of surface 905 structure(s), objects, and/or building(s) 913 of a particular nuclear power generation reactor plant 911 site, SNF cooling pond(s)/pool(s) site, SNF temporary storage site, and/or system 900 site, “local,” “onsite,” “adjacent,” and/or “proximate” may be five (5) miles or less. Note, “site” may be as that term is used and/or defined in U.S. non-provisional utility patent application, patent application Ser. No. 18/108,001, filed Feb. 9, 2023, by the same inventor as the present patent application (Henry Crichlow).

Continuing discussing FIG. 9, in some embodiments, after a given horizontal (lateral) wellbore 901 has been at least partially to fully filled with waste capsules 600 (containing integral encapsulated units 500), that given repository system 900 may be sealed (closed off) by placing at least one plug 915 within a section of vertical wellbore 903, that operatively connects to that at least partially filled horizontal (lateral) wellbore. In some embodiments, plug 915 may be at least partially made from concrete, steel, and/or extracted rock 705 material. In some embodiments, an emplaced plug 915, within a given wellbore 903, may close off that wellbore system, from liquid (water) and/or mechanical/particulate intrusion and/or migration issues.

In some embodiments, a given nuclear, radioactive, hazardous, and/or dangerous waste repository system 900 (SuperLAT™ system 900) may comprise at least one of (one or more of): at least one horizontal (lateral) wellbore 901 located (entirely) within at least one deeply located geologic formation (rock) 705, at least one vertical wellbore 903 that may operatively connect to that at least one horizontal (lateral) wellbore 901 and that may run from that at least one horizontal (lateral) wellbore 901 to terrestrial surface 905; at least one waste capsule 600 (with at least one integral encapsulated unit 500 located within that at least one waste capsule 600); at least one emplaced plug 915 located within that at least one vertical wellbore 903; at least one drilling rig 907; at least one nuclear power generation reactor plant 911 (operational, non-operational, and/or decommissioned); at least one infrastructure building or structure 913; combinations thereof; and/or the like.

While FIG. 9 shows one overall site, it should be noted that various embodiments of the present invention may interact with and/or utilize two or more of such sites as shown in FIG. 9. Further, in some embodiments, those two or more sites, some such sites may have the nuclear power generation plant 911 and/or the structure(s) 913 but without the disposal wellbore system; or some such sites may have the disposal wellbore system but without the nuclear power generation plant 911 and/or without the structure(s) 913; or such sites may be as substantially (mostly) shown in FIG. 9.

FIG. 10 illustrates an example of a type of relatively small surface plaque 1001, generally made of concrete (or other masonry product or long lasting, durable, and generally difficult to move by hand product), having nominal dimensions 1003 of about two (2) feet (ft) square, +/−one-half (½) ft, with a brass (or other durable and/or long lasting material) inscription plate 1005, that may provide terrestrial surface 905 indication that a deep nuclear waste repository 700 is built and located 10,000 feet underground, or more, using a SuperLAT™ horizontal wellbore system (such as shown in FIG. 7 and/or in FIG. 9).

In some embodiments, the surface plaque 1001 and/or the inscription plate 1005 may include at least one (passive) RFID tag, QR code, barcode, and/or the like, that upon proper interrogation (reading) may yield information about that site.

In the late 1960s a series of commercial atomic tests were conducted in the Rocky Mountains region of the United States (U.S.), specifically under Project Plowshare, which explored peaceful uses of nuclear explosives. Each test involved detonating nuclear devices at specific depths to fracture rock and release trapped gas. Detonation depths ranged from 4,240 feet deep to 8,426 feet deep below terrestrial surface 905. The atomic yields ranged from 29 kilotons to 99 kilotons. Today, in 2024 these sites include historical markers that provide information about those operations that are substantially similar to the concrete and brass embodiment of FIG. 10. Those markers serve both as an educational resource and as a reminder of the experiment conducted there below. The remediation efforts for the atomic sites focused on ensuring that any potential contamination from the underground nuclear explosion was contained and that the surface 905 environment was restored to a safe condition. Today, the sites are marked and monitored, but have all largely returned to their natural state within the Rocky Mountain region. There are no significant restrictions on access, and the site is considered safe for visitors, without restriction, with informational signage indicating its historical significance.

A similar type of plaque or marker 1001 located among trees 1007 and its field, is shown in FIG. 10 where up to 1,000,000 pounds (lbs) of HLW may be buried in nuclear waste capsules 600 in SuperLAT™ horizontal wellbores 901 (such as shown in FIG. 7 and/or in FIG. 9).

Note, various embodiments of the present invention may be characterized as methods, devices, apparatus, articles of manufacture, systems, portions thereof, and/or the like.

For example, and without limiting the scope of the present invention, device, apparatus, and/or article of manufacture embodiments of the present invention may comprise at least one integral encapsulated unit 500. In some embodiments, a given integral encapsulated unit 500 may comprise three items: (1) at least one die (mold) 413, (2) at least one spent nuclear fuel assembly or portion thereof (and/or other HLW) that is retained within that at least one die (mold) 413, and (3) an amount of former molten composition 409 that has resolidified into alloy(s) material 415, wherein the amount of the alloy(s) material 415 both entirely and completely covers over an exterior of the at least one spent nuclear fuel assembly or portion thereof (and/or other HLW) and also penetrates into the internal void spaces 301 of the at least one spent nuclear fuel assembly or portion thereof; i.e., both the amount of the alloy(s) material 415 and the at least one spent nuclear fuel assembly or portion thereof (and/or other HLW) are retained within the at least one die (mold) 413. And those three items assembled together form a given integral encapsulated unit 500. In some embodiments, a given integral encapsulated unit 500 may comprise: a diecast mold 413; at least one spent nuclear fuel assembly or portion thereof, wherein the at least one spent nuclear fuel assembly or portion thereof is located within that diecast mold 413; and an amount of a composition 415 that has resolidified located within the diecast mold 413, wherein the amount of the composition 415 both entirely and completely covers an exterior of the at least one spent nuclear fuel assembly or portion thereof and also penetrates into internal void spaces 301 of the at least one spent nuclear fuel assembly or portion thereof. In some embodiments, a given diecast mold 413, the at least one spent nuclear fuel assembly or portion thereof, and the amount of the composition 415, when in the integral encapsulated unit 500 assembly (form), are all solidly and at least substantially (mostly) positionally fixed with respect to each other such that the at least one integral encapsulated unit 500 behaves as a single integral metallic solid rigid object and may be moved around as a single solid rigid object. In some embodiments, integral encapsulated unit 500 may be manufactured from a gravity fed diecasting molding process. In some embodiments, the molten composition 409 (and its resolidified form 415) may comprise at least one alloy of copper and optionally, at least one neutron absorber, such as, but not limited to, boron carbide (B₄C). See e.g., FIG. 8A and FIG. 8B for method 800, and see also FIG. 4A to FIG. 5C.

For example, and without limiting the scope of the present invention, system embodiments of the present invention may comprise a system for processing spent nuclear fuel assemblies or portions thereof, wherein the system may comprise at least one integral encapsulated unit 500. In some embodiments, this system may further comprise at least one of: at least one waste capsule 600; at least one string 701 of two or more waste capsules 600; at least one horizontal wellbore 703 and/or 901 that is located at least partially within a deeply located geologic formation 705; gravity fed components (apparatus) (in addition to die [mold] 413); melt furnace and/or melt reservoir 408; amounts of molten composition 409, flowline (inlet line) 410; feed port 406; neutron absorber sleeve 414; gas source 420; gas line 421; handler 427; cooling bath 429; controller 419; outlet port 418; mold support(s) 417; vertical wellbore 903; drilling rig 907; plug 915; surface plaque 1001; a portion thereof; combinations thereof; and/or the like. In some embodiments, the at least one removable diecast mold 413 may have been used in forming the at least one integral encapsulated unit 500 from a diecast gravity injection molding process (e.g., method 800), wherein the at least one removable diecast mold 413 may be configured to house the at least one spent nuclear fuel assembly or portion thereof. In some embodiments, at least one waste capsule 600 (that the system may comprise) may be made (converted and/or formed) from at least one integral encapsulated unit 500. In some embodiments, the at least one waste capsule 600 may be configured to house the removable mold 413 (and its contents, such as, but not limited to, a spent nuclear fuel (SNF) assembly or portion thereof and the amount of the alloy(s) composition 415). In some embodiments, the at least one horizontal wellbore 901 (703) may be configured to hold the at least one integral encapsulated unit 500 (and/or at least one waste capsule 600) therein, wherein the at least one horizontal wellbore 901 (703) may operationally connect to at least one vertical wellbore 903 that runs to a terrestrial surface 905.

For example, and without limiting the scope of the present invention, method embodiments of the present invention may comprise method 800 for processing spent nuclear fuel assemblies or portions thereof for long-term disposal; and/or one or more steps from method 800. In some embodiments, the at least one spent nuclear fuel assembly or portion thereof that is referred to in method 800 and/or in this patent application may be a spent nuclear fuel assembly or portion thereof that was manufactured in: the United States of America (U.S.), Canada, Russia, Sweden, Finland, or other country. In some embodiments, method 800 may comprise a step (a), a step (b), and a step (c).

In some embodiments, the step (a) may be the same or at least substantially (mostly) the same as step 823. In some embodiments, the step (a) may comprise placing/inserting at least one spent nuclear fuel (SNF) assembly or portion thereof, selected from the spent nuclear fuel assemblies or portions thereof (e.g., step 801), into a removable diecast mold 413 and closing the diecast mold 413 with the at least one spent nuclear fuel assembly or portion thereof located entirely within that diecast mold 413. In some embodiments, the diecast mold 413 may be configured to entirely and completely enclose the at least one spent nuclear fuel assembly or portion thereof when the diecast mold 403 may be closed. Note, in some embodiments, the method 800 does not utilize a mold release agent on interior surfaces of the diecast mold 413 (because the casting once formed is intended to remain within its diecast mold 413 and diecast mold 413 is intended not to be opened). See e.g., FIG. 4A and FIG. 8A.

In some embodiments, the step (b) may be the same or at least substantially (mostly) the same as step 825. In some embodiments, the step (b) may comprise gravity feeding (introducing and/or pouring) into the diecast mold 413, that is closed and that houses the at least one spent nuclear fuel assembly or portion thereof, an amount of a (molten) composition 409, wherein during the step (b) (e.g., during pouring) the amount of the composition 409 may be at least substantially (mostly) molten and/or flowable. In some embodiments, upon sufficient cooling after the gravity feeding step (b) has finished, a casting (ingot) is formed within the diecast mold 413. In some embodiments, the casting may comprise the amount of the composition 409, but wherein the amount of the composition 409 in the casting is no longer molten and flowable (i.e., that amount of the composition 409 is now resolidified composition 415); and wherein, that casting further comprises the at least one spent nuclear fuel assembly or portion thereof. In some embodiments, the sufficient cooling may be when a temperature of at an exterior of the former molten composition 415 within the diecast mold 413 has lowered enough after the step (b) gravity feeding has stopped for the exterior of the former molten composition 415 to have resolidified (and/or for integral encapsulated unit 500 and/or the casting to be self-supporting with respect to its shape not changing). In some embodiments, integral encapsulated unit 500 may comprise: (1) the amount of the former molten composition 415 that was gravity feed into the diecast mold 413 and that has resolidified; (2) the at least one spent nuclear fuel assembly or portion thereof (that is entirely located within diecast mold 413); and (3) that removable diecast mold 413 (that houses the amount of the former molten composition 415 and the at least one spent nuclear fuel assembly or portion thereof). In some embodiments, the integral encapsulated unit 500 may comprise the diecast mold 413 and may further comprise the casting that is located within the diecast mold 413.

In some embodiments, after the step (a), diecast mold 413 may be closed with a top endcap 411 and that closure may be intended to be permanent. In some embodiments, after the step (a) and/or the step (b), the diecast mold 413 is not opened. In some embodiments, after the step (b), the casting is not separated from the diecast mold 413.

In some embodiments, the step (c) may be the same or at least substantially (mostly) the same as step 826. In some embodiments, the step (c) may comprise removing integral encapsulated unit 500 from (then in use) support(s) 417. In some embodiments, the support(s) 417 may be structural members that are configured for (physically) supporting the diecast mold 413 in at least the step (a) and/or in the step (b). In some embodiments, the support(s) 417 may be further configured for (physically) supporting the integral encapsulated unit 500 before it (i.e., the integral encapsulated unit 500) is removed from the support(s) 417. In some embodiments, with respect to the step (c), a removal means may be selected from using at least one handler 427 and/or a preexisting handler. In some embodiments, the step (c) removal may utilize at least one handler 427 (and/or a preexisting handler) that is configured to remove the integral encapsulated unit 500 from the support(s) 417.

In some embodiments, the step (b) gravity feeding step may be accomplished by physically and operationally linking reservoir 408 to the diecast mold 413 (e.g., via flowline 410, feed port 406, piping, conduits, ports, spruces, a portion thereof, combinations thereof, and/or the like). In some embodiments, reservoir 408 is configured to hold at least some of the molten composition 409. In some embodiments, reservoir 408 is located vertically above the diecast mold 413 and is configured to facilitate the amount of the molten composition 409 flowing from reservoir 408 and into the diecast mold 413 by gravity. In some embodiments, the reservoir 408 may be heated (e.g., by heater 425 to generate and/or maintain the at least some of the molten composition 409 in a molten (melted and/or liquid) configuration (state). See e.g., FIG. 4A and FIG. 8B.

In some embodiments, during the step (b) gravity feeding step, the molten composition 409 that is poured (gravity fed) into the diecast mold 413 both entirely covers over exteriors of the at least one spent nuclear fuel assembly or portion thereof that is located within the diecast mold 413 and also penetrates into internal void spaces 301 of the at least one spent nuclear fuel assembly or portion thereof.

In some embodiments, the molten composition 409 (and thus the composition 415) may comprise at least one alloy of copper. In some embodiments, the molten composition 409 (and thus the composition 415) may further comprise at least one neutron absorber (e.g., neutron absorber material 435). In some embodiments, the at least one neutron absorber is configured to absorb neutron emissions from the at least one spent nuclear fuel assembly or portion thereof. In some embodiments, the at least one neutron absorber may be boron carbide (B₄C).

In some embodiments, prior to or during the step (b) gravity feeding, the method 800 may further comprise having at least one neutron absorber (e.g., sleeve 414 and/or neutron absorber material 435) be located in the diecast mold 413, wherein the at least one neutron absorber is configured to absorb neutron emissions from the at least one spent nuclear fuel assembly or portion thereof.

In some embodiments, with respect to a given integral encapsulated unit 500, the at least one spent nuclear fuel assembly or portion thereof may be entirely and completely disposed within an exterior of that integral encapsulated unit 500 after the step (b) gravity feeding has stopped (or finished) such that between the exterior of the integral encapsulated unit 500 and an exterior of the at least one spent nuclear fuel assembly or portion thereof (within that integral encapsulated unit 500) is a minimum thickness 503 of the composition 415 that has resolidified. See e.g., FIG. 5B and FIG. 5A.

In some embodiments, the method 800 (after executing the step (c)) may further comprise a step of modifying (converting) at least one integral encapsulated unit 500 to form at least one waste capsule 600. In some embodiments, such modifying (converting) may be done, at least in part, by attaching one coupling 604 to each terminal end of the at least one integral encapsulated unit 500 (e.g., a given integral encapsulated unit 500 may then get two opposing couplings 604). See e.g., FIG. 6A, FIG. 6B, FIG. 6C, and step 828 of FIG. 8B.

In some embodiments, neutron absorbing members may be configured to absorb neutron emissions from the at least one integral encapsulated unit 500. In some embodiments, the neutron absorbing members may comprise a sleeve 414 already interiorly placed inside the mold 413. In some embodiments, the sleeve 414 may be hollow (cylindrical) and may be configured to fit between the mold 413 wall and the solidified melt 415 occupying the full interior length of the mold 413. In some embodiments, the endcaps 411 (that close otherwise opposing openings of mold 413) may be configured to be placed and attached at opposing terminal ends of mold 413 to at least substantially (mostly) seal off access to volume 433 of mold 413 (e.g., feed port 406 may still provide some limited access to volume 433 of mold 413). In some embodiments, the sleeve 414 and/or the endcaps 411, may be at least partially made from borated steel. In some embodiments, before and/or during the step (a) (and before the step (b)), the method may comprise a step of placing a neutron absorbing sleeve 414 within the diecast mold 413 (that will surround the length sides of the SNF assembly or portion thereof). In some embodiments the neutron absorbing sleeve 414, may be at least partially made from borated steel. See e.g., FIG. 4A and/or step 819.

In some embodiments, the method 800 (after executing the step (c)) may further comprise a step of inserting the at least one waste capsule 600 into a horizontal wellbore 901 that is located at least partially within a deeply located geologic formation 705 (see e.g., step 829). In some embodiments, the horizontal wellbore 901 may (operationally) connect to a vertical wellbore 903 that runs to a terrestrial surface 905. See e.g., FIG. 7, FIG. 8B, and FIG. 9.

In some embodiments, after the step (a) but prior to the step (b), the method 800 may further comprise a step of purging an internal volume 433 of inside of the diecast mold 413 that is closed with at least one purge gas (see e.g., step 821, gas source 420, gas line 421, and vent 418). In some embodiments, this purge process may be done to remove at least substantially (most) of oxygen (e.g., from atmospheric air) from the internal volume 433 inside of the diecast mold 413 that is closed (and loaded with a SNF assembly or portion thereof). In some embodiments, the at least one purge gas may be a gas that is generally considered to be substantially (mostly) inert, such as, but not limited to, nitrogen, argon, a portion thereof, combinations thereof, and/or the like.

In some embodiments, die (mold) 413 (and integral encapsulated unit 500) may be configured to entirely house (hold) any SNF assembly or portion thereof noted and/or discussed herein, such as, but not limited to, SNF assembly 106, group (bundle) of SNF assemblies 105, SNF assembly 101, SNF assembly 103, SNF assembly 412, modified SNF assembly 512, SNF assembly 205, base 307, spent nuclear fuel assembly, fuel rod, fuel pellet, control rod, portions thereof, combinations thereof, and/or the like.

Methods of forming metal alloy castings and/or integral encapsulated units that contain high-level nuclear waste (HLW), such as, but not limited to, spent nuclear fuel (SNF) assemblies, or portions thereof, from diecast gravity injection molding operations, these castings and/or integral encapsulated units, methods of disposing of these castings, integral encapsulated units, and/or disposal waste capsules into deeply located wellbores, and systems thereof have been described. The foregoing description of the various exemplary embodiments of the invention has been presented for the purposes of illustration and disclosure. It is not intended to be exhaustive or to limit the invention to the precise form disclosed. Many modifications and variations are possible in light of the above teaching without departing from the spirit of the invention.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A method for processing spent nuclear fuel assemblies or portions thereof for long-term disposal, wherein the method comprises steps of:
(a) placing at least one spent nuclear fuel assembly or portion thereof, selected from the spent nuclear fuel assemblies or portions thereof, into a diecast mold and closing the diecast mold around the at least one spent nuclear fuel assembly or portion thereof;
(b) gravity feeding into the diecast mold that is closed and that houses the at least one spent nuclear fuel assembly or portion thereof, an amount of a composition, wherein during the step (b) the amount of the composition is molten and flowable, wherein upon sufficient cooling after the gravity feeding has finished a casting is formed within the diecast mold, wherein the casting comprises the amount of the composition, but wherein the amount of the composition in the casting is no longer molten and flowable, and wherein the casting further comprises the at least one spent nuclear fuel assembly or portion thereof; and
(c) removing an integral encapsulated unit from supports, wherein the integral encapsulated unit comprises the diecast mold and comprises the casting that is located within the diecast mold;
wherein the supports are structural members that are configured for supporting the diecast mold in at least the step (a) and the step (b).

2. The method according to claim 1, wherein the at least one spent nuclear fuel assembly or portion thereof is a spent nuclear fuel assembly or portion thereof that was manufactured in: United States of America, Canada, Russia, Sweden, or Finland.

3. The method according to claim 1, wherein the diecast mold is configured to entirely and completely enclose the at least one spent nuclear fuel assembly or portion thereof when the diecast mold is closed.

4. The method according to claim 1, wherein the diecast mold is removable from the supports.

5. The method according to claim 1, wherein the diecast mold is at least mostly made from at least one metal or at least one alloy.

6. The method according to claim 5, wherein the at least one alloy is a steel.

7. The method according to claim 1, wherein the step (b) gravity feeding is accomplished by physically and operationally linking a reservoir to the diecast mold, wherein the reservoir is configured to hold at least some of the composition; wherein the reservoir is located vertically above the diecast mold and is configured to facilitate the at least some of the composition flowing from the reservoir and into the diecast mold by gravity.

8. The method according to claim 7, wherein the reservoir is heated to generate and/or maintain the at least some of the composition in a molten state.

9. The method according to claim 1, wherein during the step (b) gravity feeding, the amount of the composition that is gravity fed into the diecast mold both entirely covers exteriors of the at least one spent nuclear fuel assembly or portion thereof that is located within the diecast mold and also penetrates into internal void spaces of the at least one spent nuclear fuel assembly or portion thereof.

10. The method according to claim 1, wherein the sufficient cooling is when a temperature of at an exterior of the composition within the diecast mold has lowered enough after the step (b) gravity feeding has stopped for the exterior of the composition to have resolidified.

11. The method according to claim 1, wherein the composition comprises at least one alloy of copper.

12. The method according to claim 11, wherein the composition further comprises at least one neutron absorber, wherein the at least one neutron absorber is configured to absorb neutron emissions from the at least one spent nuclear fuel assembly or portion thereof.

13. The method according to claim 12, wherein the at least one neutron absorber is boron carbide (B₄C).

14. The method according to claim 1, wherein prior or during to the step (b) gravity feeding, the method further comprises having at least one neutron absorber located in the diecast mold, wherein the at least one neutron absorber is configured to absorb neutron emissions from the at least one spent nuclear fuel assembly or portion thereof.

15. The method according to claim 1, wherein with respect to the casting, the at least one spent nuclear fuel assembly or portion thereof is entirely and completely disposed within an exterior of the casting after the step (b) gravity feeding is stopped such that between the exterior of the casting and an exterior of the at least one spent nuclear fuel assembly or portion thereof is a minimum thickness of the composition that has resolidified.

16. The method according to claim 1, wherein the step (c) removal utilizes at least one handler that is configured to remove the integral encapsulated unit from the supports.

17. The method according to claim 1, wherein after the step (b), the diecast mold is not opened.

18. The method according to claim 1, wherein after the step (b), the casting is not separated from the diecast mold.

19. The method according to claim 1, wherein the method further comprises a step of converting at least one of the integral encapsulated unit into at least one waste capsule.

20. The method according to claim 19, wherein the converting is done by attaching one coupling to each terminal end of the at least one integral encapsulated unit.

21. The method according to claim 19, wherein the method further comprises a step of inserting the at least one waste capsule into a horizontal wellbore that is located at least partially within a deeply located geologic formation, wherein the horizontal wellbore connects to a vertical wellbore that runs to a terrestrial surface.

22. The method according to claim 1, prior to the step (a) the method further comprises a step of placing a neutron absorbing sleeve within the diecast mold.

23. The method according to claim 22, wherein the neutron absorbing sleeve, is at least partially made from borated steel.

24. The method according to claim 1, wherein after the step (a) but prior to the step (b), the method further comprises a step of purging an internal volume of inside of the diecast mold that is closed with at least one purge gas.

25. The method according to claim 1, wherein the method does not utilize a mold release agent on interior surfaces of the diecast mold.

26. A system for processing spent nuclear fuel assemblies or portions thereof, wherein the system comprises at least one integral encapsulated unit, wherein the at least one integral encapsulated unit comprises:
a diecast mold;
at least one spent nuclear fuel assembly or portion thereof, selected from the spent nuclear fuel assemblies or portions thereof, wherein the at least one spent nuclear fuel assembly or portion thereof is located within the diecast mold; and
an amount of a composition that has resolidified located within the diecast mold, wherein the amount of the composition both entirely and completely covers an exterior of the at least one spent nuclear fuel assembly or portion thereof and also penetrates into internal void spaces of the at least one spent nuclear fuel assembly or portion thereof;
wherein the diecast mold, the at least one spent nuclear fuel assembly or portion thereof, and the amount of the composition are all solidly and at least substantially positionally fixed with respect to each other such that the at least one integral encapsulated unit behaves as a single integral metallic object.

27. The system according to claim 26, wherein the system further comprises supports that are configured to support the diecast mold and/or the at least one integral encapsulated unit.

28. The system according to claim 27, wherein the diecast mold and/or the at least one integral encapsulated unit are removable from the supports.

29. The system according to claim 26, wherein the system further comprises at least one waste capsule, wherein the at least one waste capsule is made from the at least one integral encapsulated unit.

30. The system according to claim 26, wherein the system further comprises at least one horizontal wellbore that is located at least partially within a deeply located geologic formation, wherein the at least one horizontal wellbore is configured to hold the at least one integral encapsulated unit therein, wherein the at least one horizontal wellbore connects to at least one vertical wellbore that runs to a terrestrial surface.

31. An integral encapsulated unit that comprises:
a diecast mold;
at least one spent nuclear fuel assembly or portion thereof, wherein the at least one spent nuclear fuel assembly or portion thereof is located within the diecast mold; and
an amount of a composition that has resolidified located within the diecast mold, wherein the amount of the composition both entirely and completely covers an exterior of the at least one spent nuclear fuel assembly or portion thereof and also penetrates into internal void spaces of the at least one spent nuclear fuel assembly or portion thereof;
wherein the diecast mold, the at least one spent nuclear fuel assembly or portion thereof, and the amount of the composition are all solidly and at least substantially positionally fixed with respect to each other such that the at least one integral encapsulated unit behaves as a single integral metallic object.

32. The integral encapsulated unit according to claim 31, wherein the integral encapsulated unit is manufactured from a gravity fed diecasting molding process.

33. The integral encapsulated unit according to claim 31, wherein the composition comprises at least one alloy of copper.
